(19) United States
(12) Patent Application Publication
(10) Pub. No.: US 2009/0000497 A1
(43) Pub. Date: Jan. 1, 2009

(54) Liquid transfer member pressing force adjusting method and apparatus of rotary stencil printing plate liquid coating machine

(75) Inventors: Isao Umetsu, Tsukuba-shi (JP); Hiromitsu Numauchi, Tsukuba-shi (JP); Isao Komuro, Noda-shi (JP); Akehiro Kusaka, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION, Tokyo (JP)

(21) Appl. No.: 12/155,559

(22) Filed: Jun. 5, 2008

(30) Foreign Application Priority Data
Jun. 14, 2007 (JP) 2007-157298
Mar. 12, 2008 (JP) 2008-062339

(51) Int. Cl. B41L 13/00

(52) U.S. Cl. 101/120

(57) ABSTRACT

A rotary screen printing press includes a rotary screen cylinder which supports a screen printing forme and is supported rotatably; an impression cylinder which is provided to oppose the rotary screen cylinder, has a groove portion provided in an outer peripheral surface thereof, the groove portion accommodating a gripper device for holding a material to be printed, and is supported rotatably; and a squeegee which is located within the rotary screen cylinder and, during printing, contacts an inner peripheral surface of the screen printing forme, while being pressed against it, to transfer ink stored within the rotary screen cylinder to the material to be printed, which is held on the impression cylinder, via holes of the screen printing forme. The printing press has a squeegee throw-on and throw-off control device which, when the squeegee opposes the groove portion of the impression cylinder, brings the squeegee into contact with the inner peripheral surface of the screen printing forme, and controls the pressing force of the squeegee acting on the inner peripheral surface of the screen printing forme to be lower than its pressing force exerted during printing.

### BACKGROUND OF THE INVENTION

1. Field of the Invention

This invention relates to a liquid transfer member pressing force adjusting method and apparatus of a rotary stencil printing plate liquid coating machine such as a rotary screen printing press. In the descriptions to follow, examples, in which a rotary screen printing press is used as a rotary stencil printing plate liquid coating machine, and ink is used as a liquid which is coated on a material to be liquid coated, will be explained to facilitate understanding. It goes without saying, however, that the present invention is similarly applied to a liquid coating machine using a stencil printing plate put to other uses instead of the rotary screen printing press, the liquid coating machine using a rotary screen coater for coating varnish in place of ink.

2. Description of the Related Art

A conventional rotary screen printing press, for example, as shown in FIGS. 23(a) and 23(b), is well known.

This rotary screen printing press is furnished with a plate cylinder 101 bearing a rotary screen printing forme 100, and an impression cylinder 104 having two cylinder pits 103 in each of which a sheet gripper 102 is installed. The sheet gripper 102, when located at a closed position, is arranged not to protrude above the printing surface of the impression cylinder 104.

A squeegee 105 whose position can be adjusted is disposed within the plate cylinder 101 and, during printing work, is pressed against the inner surface of the rotary screen printing forme 100 by an operating mechanism including a bell crank 106, a control cam 107, and an operating cylinder 108 (see the state of FIG. 23(a)). When the squeegee 105 passes through the open area of the cylinder pit 103 of the impression cylinder 104, the squeegee 105 is lifted away from the rotary screen printing forme 100 (see the state of FIG. 23(b)).

During passage through the cylinder pit 103 of the impression cylinder 104, therefore, the rotary screen printing forme 100 is released from the pressure of the squeegee 105 located inside the rotary screen printing forme 100. This avoids a situation in which the rotary screen printing forme 100 is pushed into the cylinder pit 103 of the impression cylinder 104 under the pressure of the squeegee 105, and damaged thereby.

JP-A-08-230149 is an example of a document on the above-mentioned related art.

With the conventional rotary screen printing press described above, the squeegee 105 is designed to be retreated to a position, where the squeegee has been lifted away from the rotary screen printing forme 100, when the squeegee 105 comes to a position where it opposes the cylinder pit 103 of the impression cylinder 104.

On this occasion, a gap is formed between the rotary screen printing forme 100 and the squeegee 105, and ink leaks out through this gap toward a downstream side in the rotating direction of the rotary screen printing forme 100. As a result, the amount of ink remaining in front of the squeegee 105 becomes small and ink density is decreased at the start of printing.

If the amount of ink supplied is increased in order to prevent the decrease in the ink density at the start of printing, the amount of ink leaking out toward the downstream side increases. The increased leaking ink leaks out through the holes of a picture pattern portion of the rotary screen printing forme 100 under a centrifugal force during high speed rotation, adheres to outside portions of the holes, and sticks to the outside of the picture pattern portion during printing, thereby deteriorating printing quality.

The present invention has been accomplished in light of the above-described problems. It is an object of the invention to provide a liquid transfer member pressing force adjusting method and apparatus of a rotary stencil printing plate liquid coating machine, which can prevent a stencil printing plate from being pushed into a concavity of an impression cylinder and damaged thereby, and can also eliminate a liquid leaking out toward a downstream side in the rotating direction of the stencil printing plate to prevent deterioration of liquid coating quality.

### SUMMARY OF THE INVENTION

A first aspect of the present invention is a liquid transfer member pressing force adjusting method of a rotary stencil printing plate liquid coating machine including,

a stencil printing plate cylinder which supports a stencil printing plate and is supported rotatably,

an impression cylinder which is provided to oppose the stencil printing plate cylinder, has a concavity provided in an outer peripheral surface thereof, the concavity accommodating a device for holding a material to be liquid coated, and is supported rotatably, and

a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to the material to be liquid coated, which is held on the impression cylinder, via holes of the stencil printing plate,

wherein when the liquid transfer member opposes the concavity of the impression cylinder, the liquid transfer member is brought into contact with the inner peripheral surface of the stencil printing plate, and a pressing force of the liquid transfer member acting on the inner peripheral surface of the stencil printing plate is rendered lower than a pressing force of the liquid transfer member exerted during the liquid coating.

Adjustment of the pressing force of the liquid transfer member acting on the inner peripheral surface of the stencil printing plate may be made by adjusting a position of the liquid transfer member.

The adjustment of the position of the liquid transfer member may be made by a motor.

The pressing force of the liquid transfer member acting on the inner peripheral surface of the stencil printing plate when the liquid transfer member opposes the concavity of the impression cylinder may be obtained from a type of the stencil printing plate.

The pressing force of the liquid transfer member acting on the inner peripheral surface of the stencil printing plate when the liquid transfer member opposes the concavity of the impression cylinder may be obtained from a picture pattern area rate of a picture pattern applied by liquid coating to the material to be liquid coated.

The pressing force of the liquid transfer member acting on the inner peripheral surface of the stencil printing plate when the liquid transfer member opposes the concavity of the impression cylinder may be obtained from a type of the liquid used in the liquid coating.

The pressing force of the liquid transfer member acting on the inner peripheral surface of the stencil printing plate when the liquid transfer member opposes the concavity of the impression cylinder may be obtained from a type of the liquid transfer member.

A second aspect of the present invention is a liquid transfer member pressing force adjusting apparatus of a rotary stencil printing plate liquid coating machine including,

a stencil printing plate cylinder which supports a stencil printing plate and is supported rotatably,

an impression cylinder which is provided to oppose the stencil printing plate cylinder, has a concavity provided in an outer peripheral surface thereof, the concavity accommodating a device for holding a material to be liquid coated, and is supported rotatably, and

a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to the material to be liquid coated, which is held on the impression cylinder, via holes of the stencil printing plate,

the liquid transfer member pressing force adjusting apparatus comprising control means which, when the liquid transfer member opposes the concavity of the impression cylinder, brings the liquid transfer member into contact with the inner peripheral surface of the stencil printing plate, and controls a pressing force of the liquid transfer member acting on the inner peripheral surface of the stencil printing plate to be lower than a pressing force of the liquid transfer member exerted during the liquid coating.

The control means may make adjustment of the pressing force of the liquid transfer member acting on the inner peripheral surface of the stencil printing plate by adjusting a position of the liquid transfer member.

The control means may make the adjustment of the position of the liquid transfer member by a motor.

The control means may obtain the pressing force of the liquid transfer member, which acts on the inner peripheral surface of the stencil printing plate when the liquid transfer member opposes the concavity of the impression cylinder, from a type of the stencil printing plate.

The control means may obtain the pressing force of the liquid transfer member, which acts on the inner peripheral surface of the stencil printing plate when the liquid transfer member opposes the concavity of the impression cylinder, from a picture pattern area rate of a picture pattern applied by liquid coating to the material to be liquid coated.

The control means may obtain the pressing force of the liquid transfer member, which acts on the inner peripheral surface of the stencil printing plate when the liquid transfer member opposes the concavity of the impression cylinder, from a type of the liquid used in the liquid coating.

The control means may obtain the pressing force of the liquid transfer member, which acts on the inner peripheral surface of the stencil printing plate when the liquid transfer member opposes the concavity of the impression cylinder, from a type of the liquid transfer member.

According to the features of the present invention, even when the liquid transfer member is located at a position where it opposes the concavity of the impression cylinder, the liquid transfer member does not leave the stencil printing plate, and only its pressure exerted on the stencil printing plate is rendered lower than its pressure exerted during liquid coating. Thus, the stencil printing plate is prevented from being pushed into the concavity of the impression cylinder and damaged thereby, and there is no liquid leaking out toward the downstream side in the rotating direction of the stencil printing plate, so that deterioration of liquid coating quality can be prevented.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic configurational sectional view of a rotary screen printing unit in a rotary screen printing press showing Embodiment 1 of the present invention;

FIG. 2 is a right side view of the rotary screen printing unit in FIG. 1;

FIG. 3 is a left side view of the rotary screen printing unit in FIG. 1;

FIG. 4(a) is an operating state view;

FIG. 4(b) is an operating state view;

FIG. 5(a) is a control block diagram of a squeegee throw-on and throw-off control device;

FIG. 5(b) is a control block diagram of the squeegee throw-on and throw-off control device;

FIG. 5(c) is a control block diagram of the squeegee throw-on and throw-off control device;

FIG. 6(a) is a motion flow chart of the squeegee throw-on and throw-off control device;

FIG. 6(b) is a motion flow chart of the squeegee throw-on and throw-off control device;

FIG. 6(c) is a motion flow chart of the squeegee throw-on and throw-off control device;

FIG. 6(d) is a motion flow chart of the squeegee throw-on and throw-off control device;

FIG. 6(e) is a motion flow chart of the squeegee throw-on and throw-off control device;

FIG. 7(a) is a motion flow chart of the squeegee throw-on and throw-off control device;

FIG. 7(b) is a motion flow chart of the squeegee throw-on and throw-off control device;

FIG. 7(c) is a motion flow chart of the squeegee throw-on and throw-off control device;

FIG. 7(d) is a motion flow chart of the squeegee throw-on and throw-off control device;

FIG. 8(a) is a motion flow chart of the squeegee throw-on and throw-off control device;

FIG. 8(b) is a motion flow chart of the squeegee throw-on and throw-off control device;

FIG. 8(c) is a motion flow chart of the squeegee throw-on and throw-off control device;

FIG. 8(d) is a motion flow chart of the squeegee throw-on and throw-off control device;

FIG. 9(a) is a motion flow chart of the squeegee throw-on and throw-off control device;

FIG. 9(b) is a motion flow chart of the squeegee throw-on and throw-off control device;

FIG. 9(c) is a motion flow chart of the squeegee throw-on and throw-off control device;

FIG. 9(d) is a motion flow chart of the squeegee throw-on and throw-off control device;

FIG. 10(a) is a motion flow chart of the squeegee throw-on and throw-off control device;

FIG. 10(b) is a motion flow chart of the squeegee throw-on and throw-off control device;

FIG. 10(c) is a motion flow chart of the squeegee throw-on and throw-off control device;

FIG. 10(d) is a motion flow chart of the squeegee throw-on and throw-off control device;

FIG. 11(a) is a motion flow chart of the squeegee throw-on and throw-off control device;

FIG. 11(b) is a motion flow chart of the squeegee throw-on and throw-off control device;

FIG. 11(c) is a motion flow chart of the squeegee throw-on and throw-off control device;

FIG. 11(d) is a motion flow chart of the squeegee throw-on and throw-off control device;

FIG. 12(a) is a motion flow chart of the squeegee throw-on and throw-off control device;

FIG. 12(b) is a motion flow chart of the squeegee throw-on and throw-off control device;

FIG. 12(c) is a motion flow chart of the squeegee throw-on and throw-off control device;

FIG. 12(d) is a motion flow chart of the squeegee throw-on and throw-off control device;

FIG. 13 is a schematic configurational sectional view of a rotary screen printing unit in a rotary screen printing press showing Embodiment 2 of the present invention;

FIG. 14(a) is an explanation drawing of an ink supply system;

FIG. 14(b) is an explanation drawing of an ink supply pipe;

FIG. 15(a) is a control block diagram of a doctor roller throw-on and throw-off control device;

FIG. 15(b) is a control block diagram of the doctor roller throw-on and throw-off control device;

FIG. 15(c) is a control block diagram of the doctor roller throw-on and throw-off control device;

FIG. 16(a) is a motion flow chart of the doctor roller throw-on and throw-off control device;

FIG. 16(b) is a motion flow chart of the doctor roller throw-on and throw-off control device;

FIG. 16(c) is a motion flowchart of the doctor roller throw-on and throw-off control device;

FIG. 16(d) is a motion flowchart of the doctor roller throw-on and throw-off control device;

FIG. 16(e) is a motion flowchart of the doctor roller throw-on and throw-off control device;

FIG. 17(a) is a motion flow chart of the doctor roller throw-on and throw-off control device;

FIG. 17(b) is a motion flow chart of the doctor roller throw-on and throw-off control device;

FIG. 17(c) is a motion flow chart of the doctor roller throw-on and throw-off control device;

FIG. 17(d) is a motion flow chart of the doctor roller throw-on and throw-off control device;

FIG. 18(a) is a motion flowchart of the doctor roller throw-on and throw-off control device;

FIG. 18(b) is a motion flow chart of the doctor roller throw-on and throw-off control device;

FIG. 18(c) is a motion flowchart of the doctor roller throw-on and throw-off control device;

FIG. 19(a) is a motion flow chart of the doctor roller throw-on and throw-off control device;

FIG. 19(b) is a motion flowchart of the doctor roller throw-on and throw-off control device;

FIG. 19(c) is a motion flow chart of the doctor roller throw-on and throw-off control device;

FIG. 20(a) is a motion flow chart of the doctor roller throw-on and throw-off control device;

FIG. 20(b) is a motion flowchart of the doctor roller throw-on and throw-off control device;

FIG. 20(c) is a motion flow chart of the doctor roller throw-on and throw-off control device;

FIG. 21(a) is a motion flow chart of the doctor roller throw-on and throw-off control device;

FIG. 21(b) is a motion flow chart of the doctor roller throw-on and throw-off control device;

FIG. 21(c) is a motion flow chart of the doctor roller throw-on and throw-off control device;

FIG. 22(a) is a motion flowchart of the doctor roller throw-on and throw-off control device;

FIG. 22(b) is a motion flow chart of the doctor roller throw-on and throw-off control device;

FIG. 22(c) is a motion flowchart of the doctor roller throw-on and throw-off control device;

FIG. 23(a) is a schematic view of a conventional rotary screen printing press; and

FIG. 23(b) is a schematic view of the rotary screen printing press showing a different operating state.

### DETAILED DESCRIPTION OF THE INVENTION

The liquid transfer member pressing force adjusting method and apparatus of a rotary stencil printing plate liquid coating machine according to the present invention will be described in detail by embodiments of the invention by reference to the accompanying drawings.

### Embodiment 1

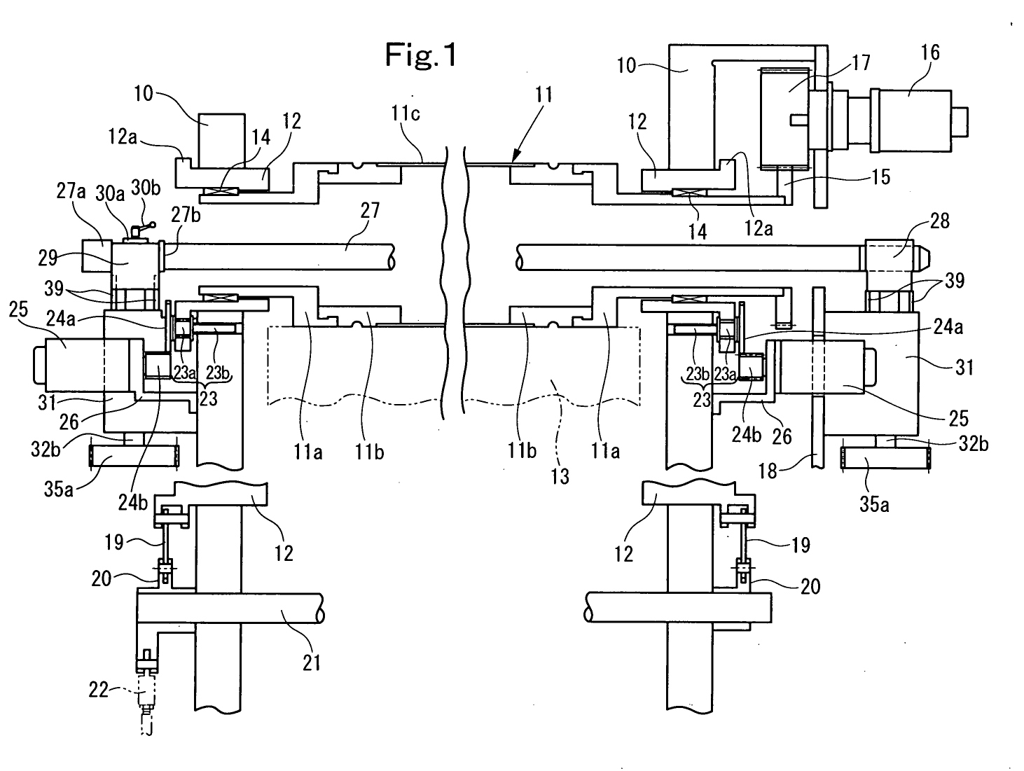

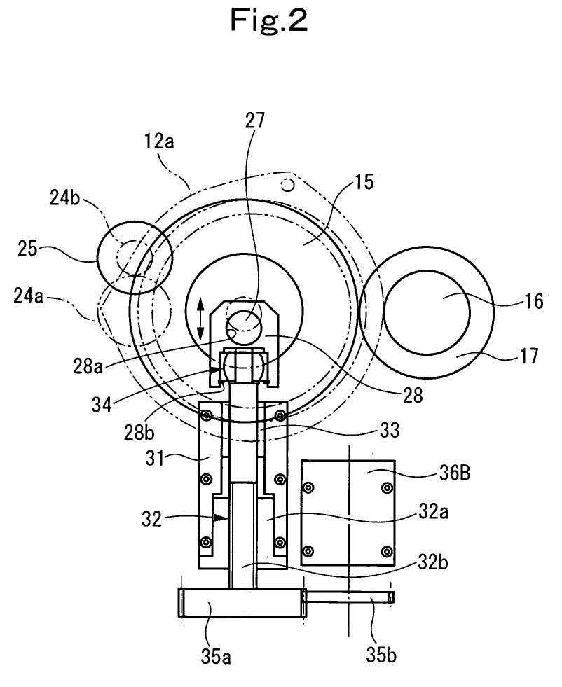

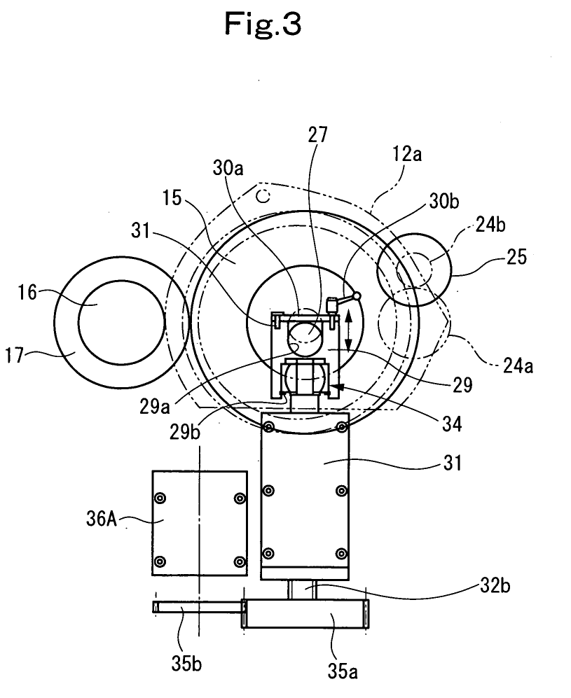

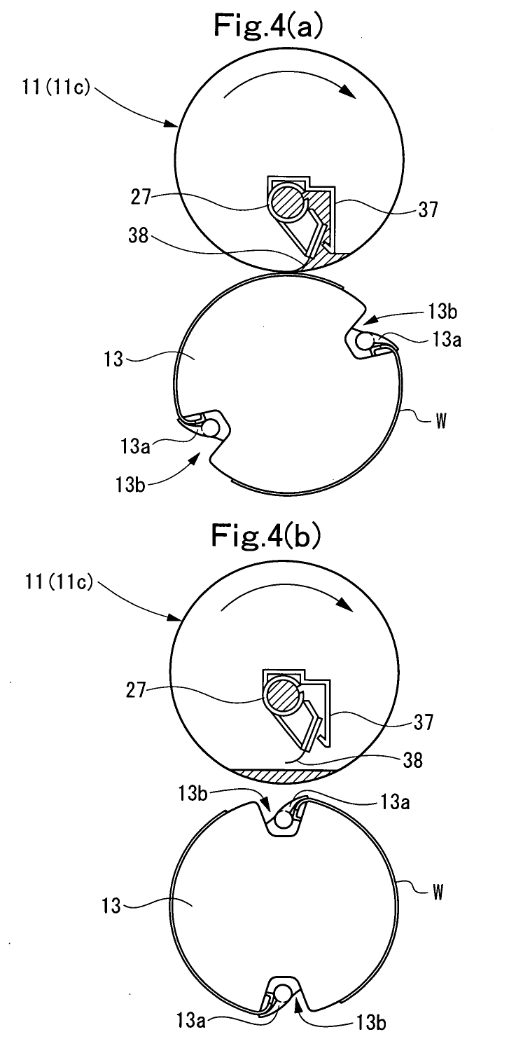

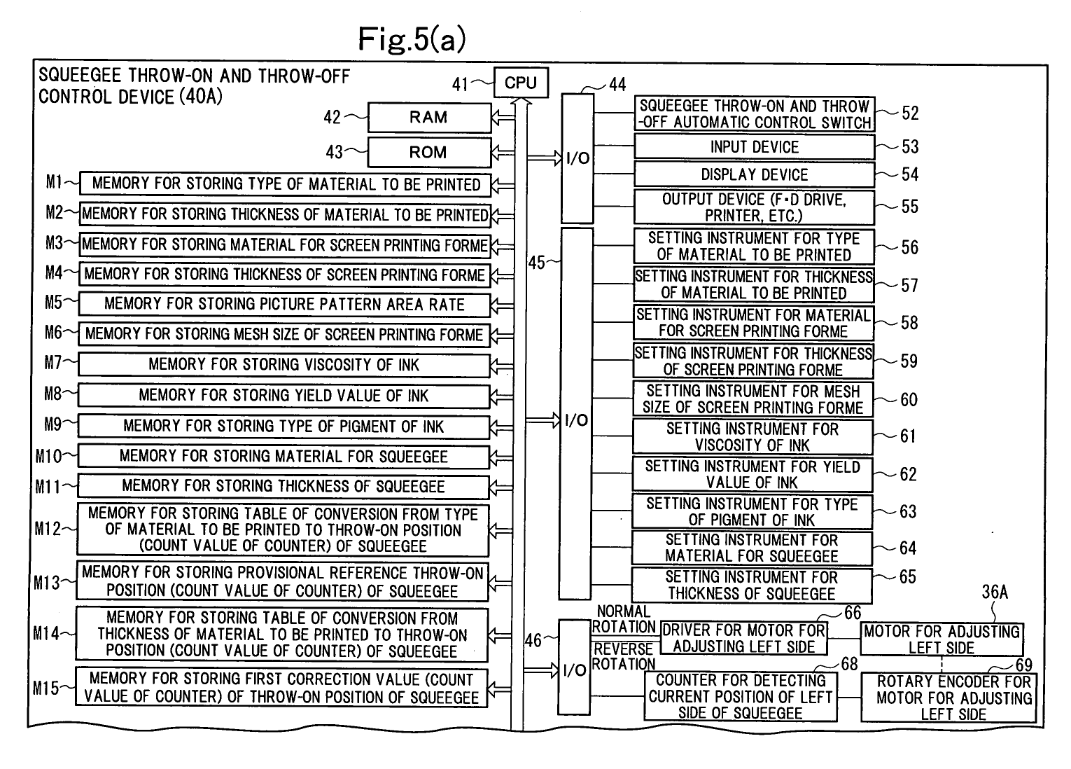

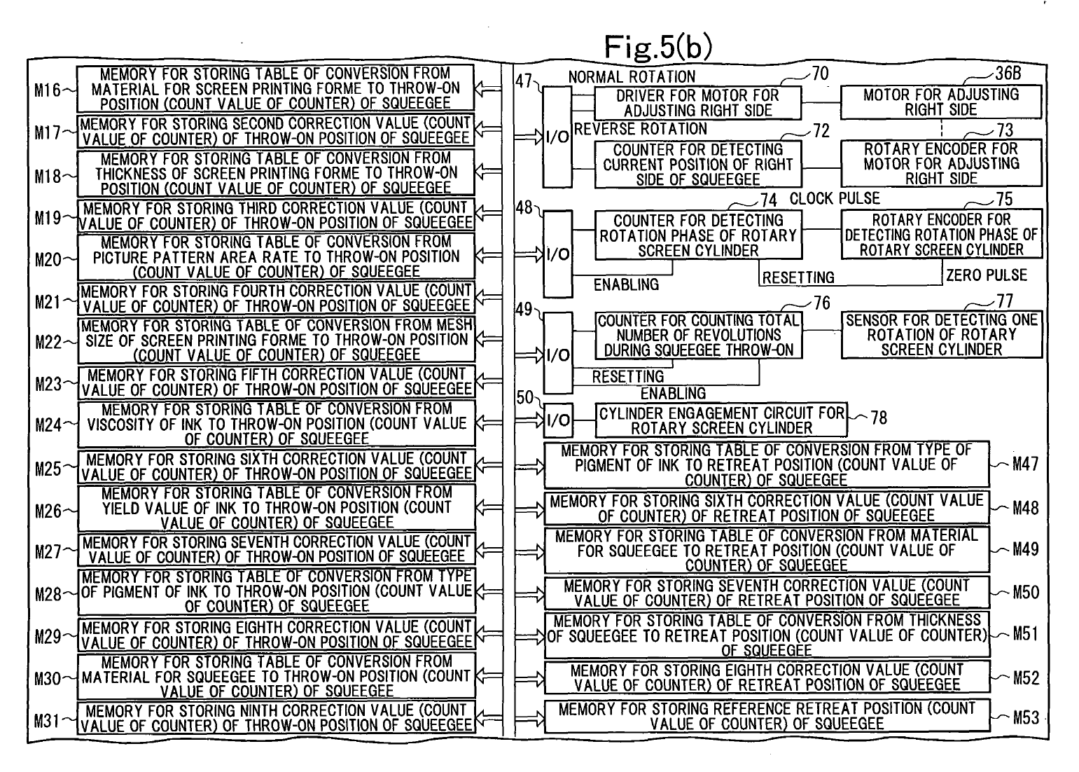

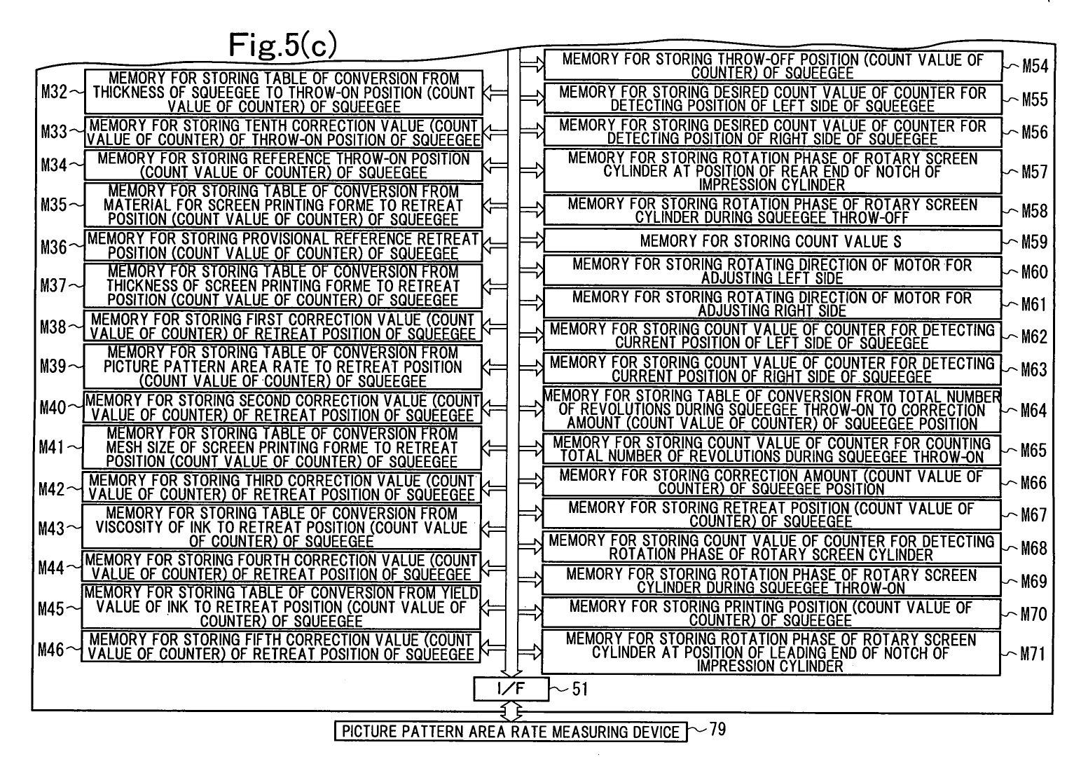

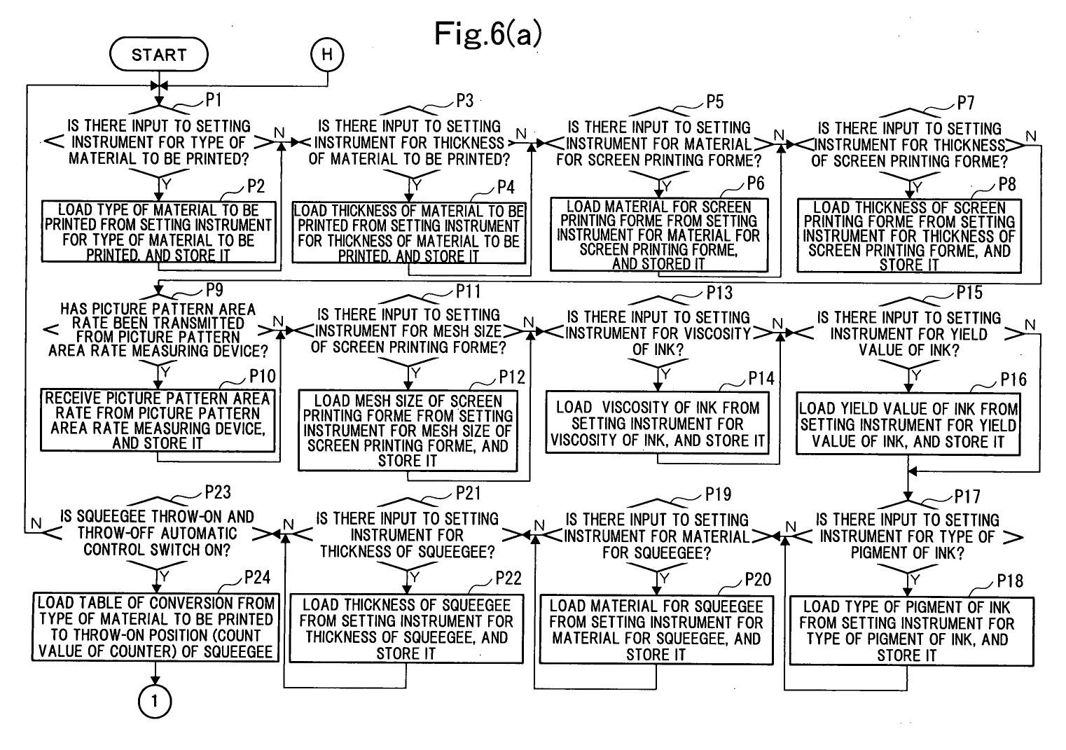

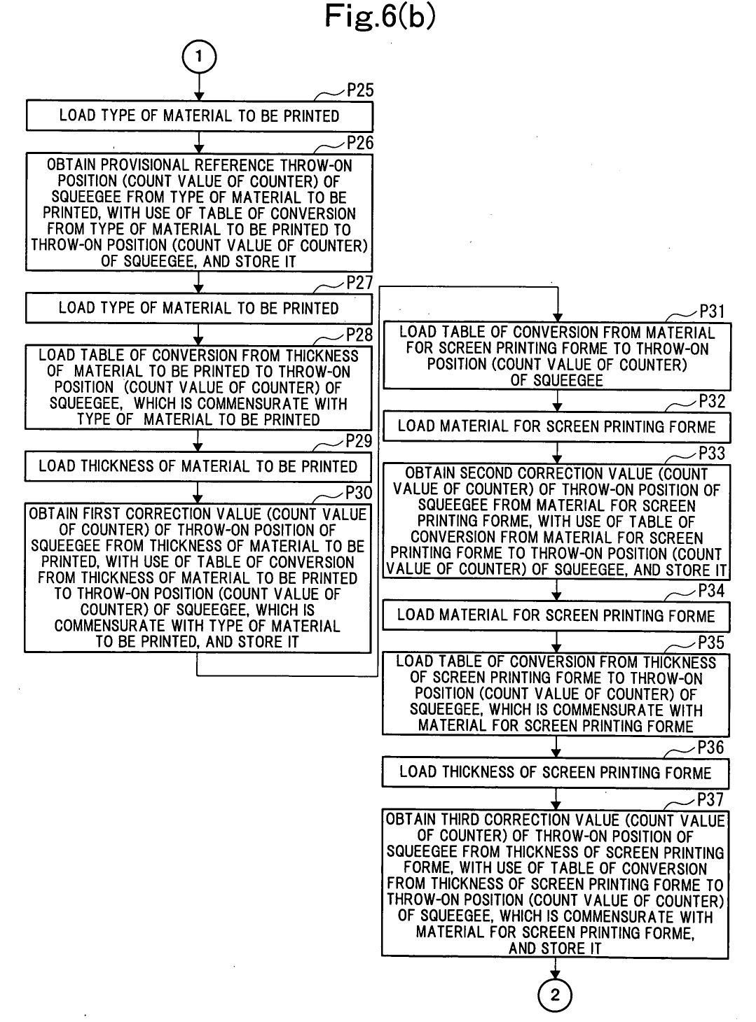

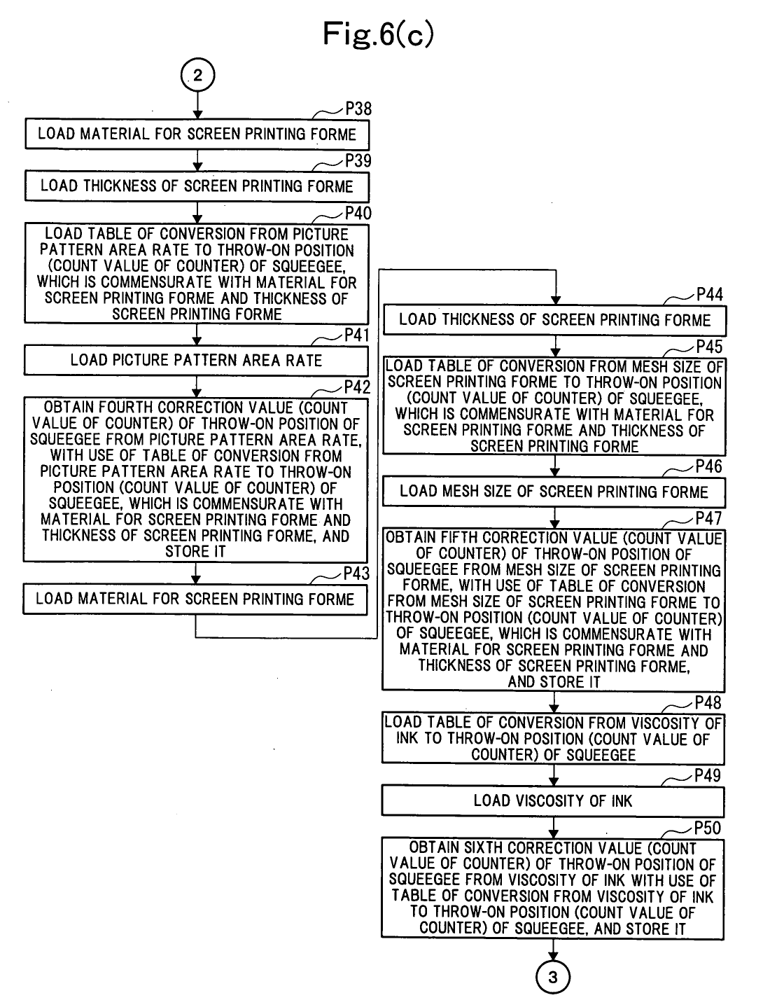

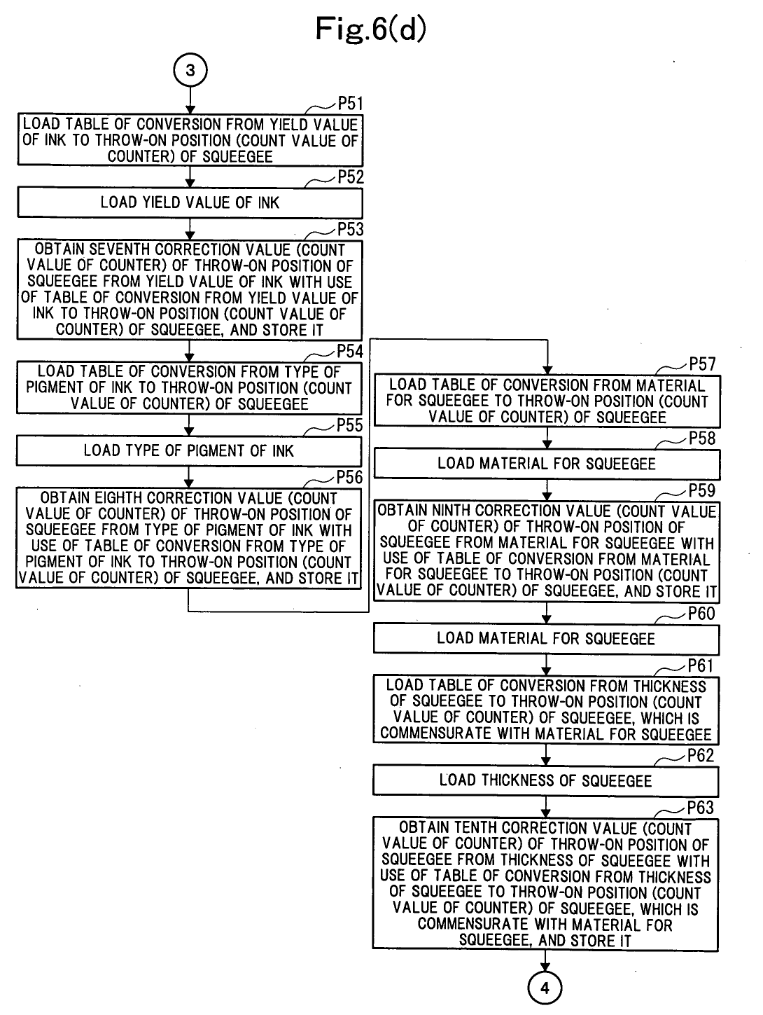

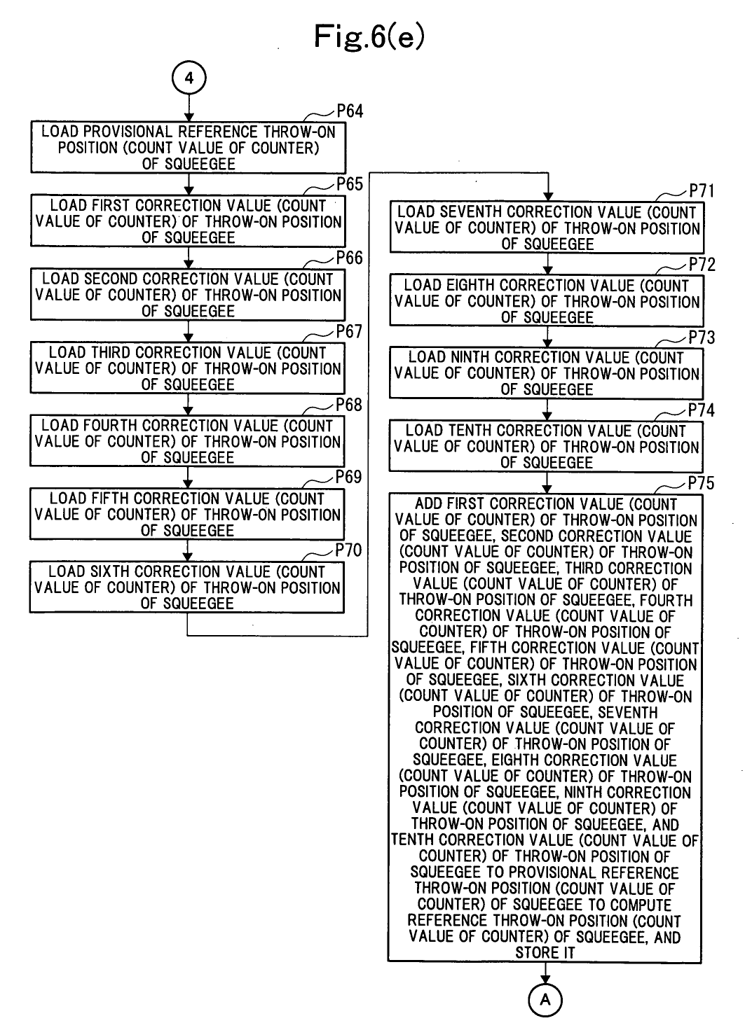

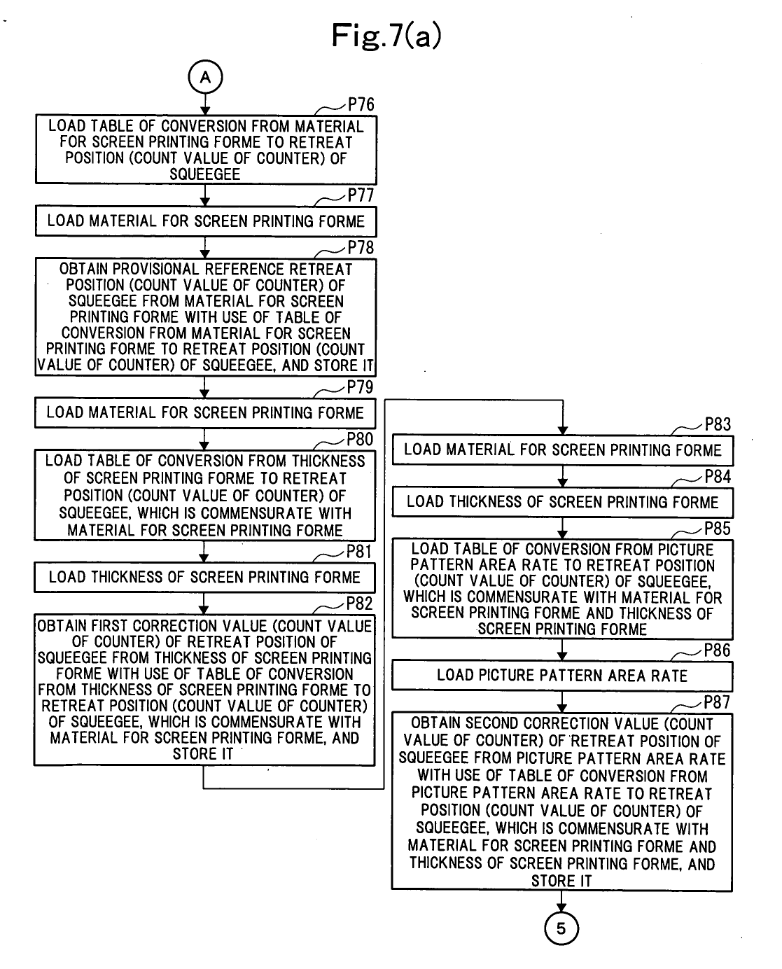

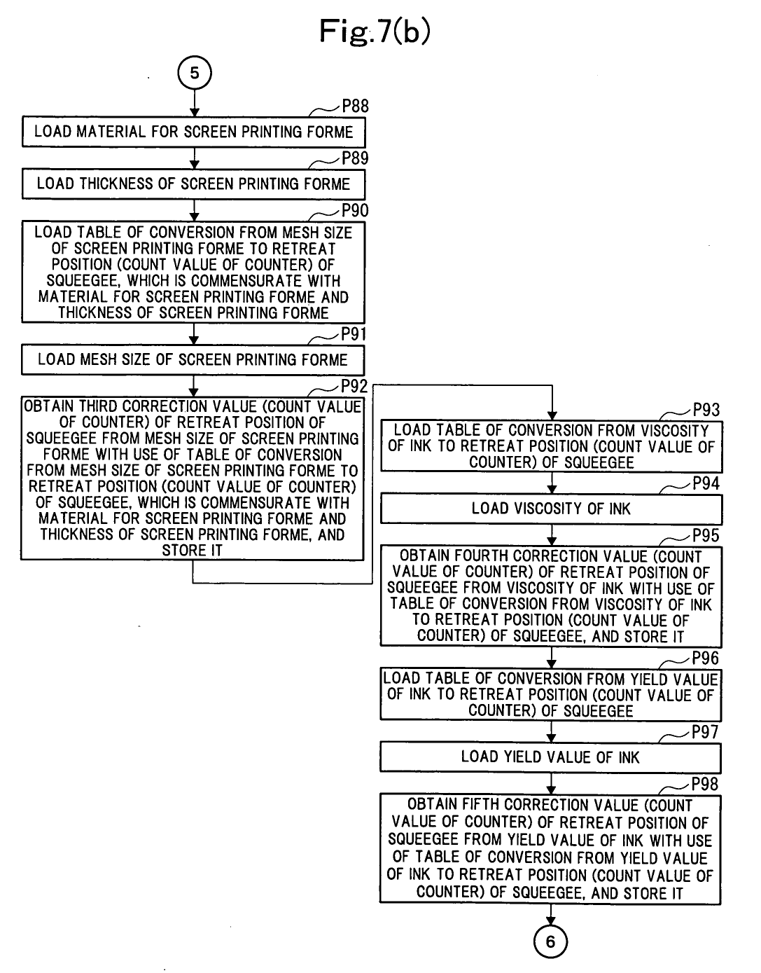

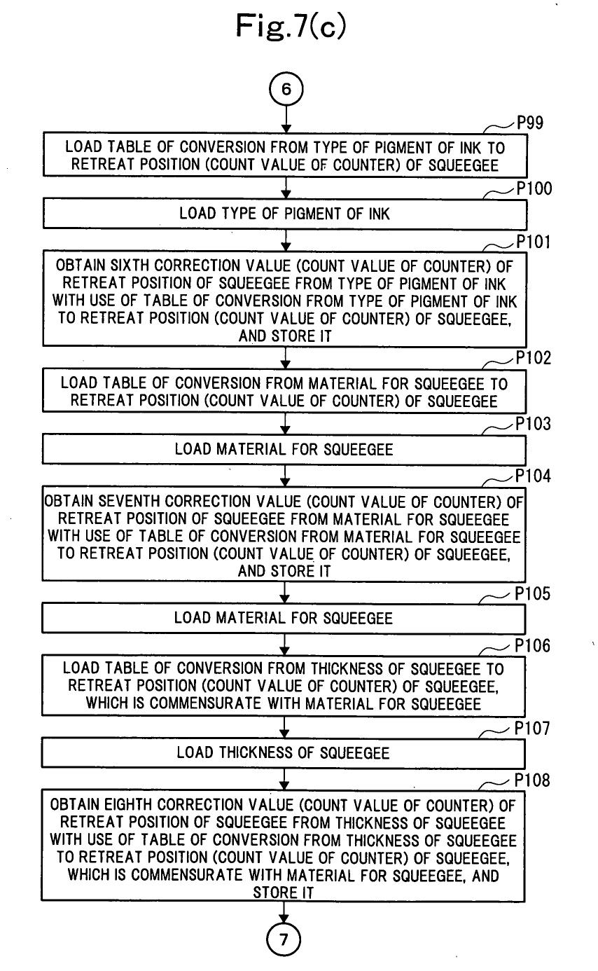

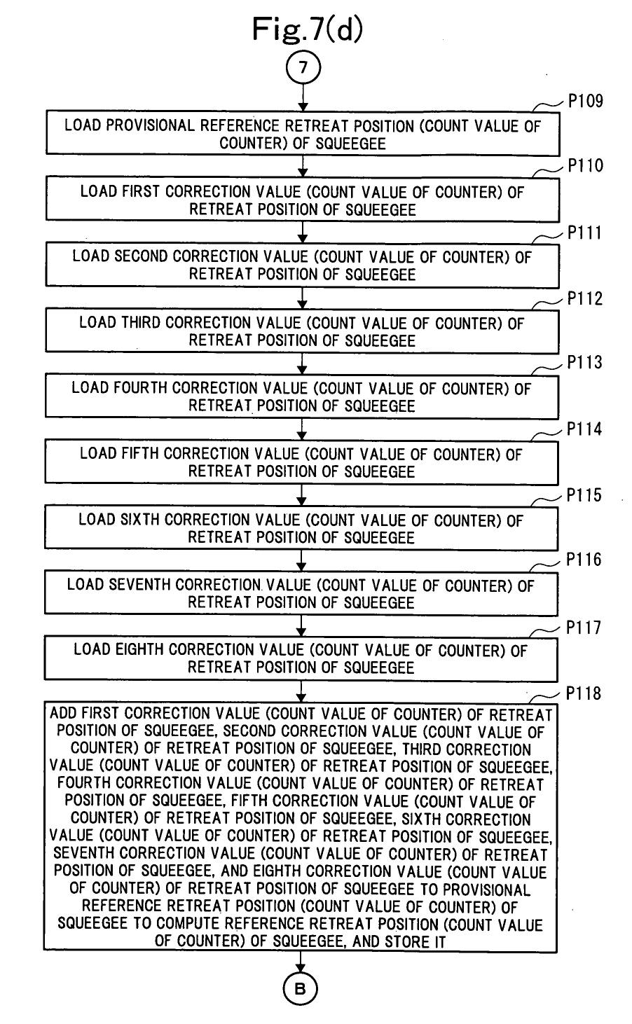

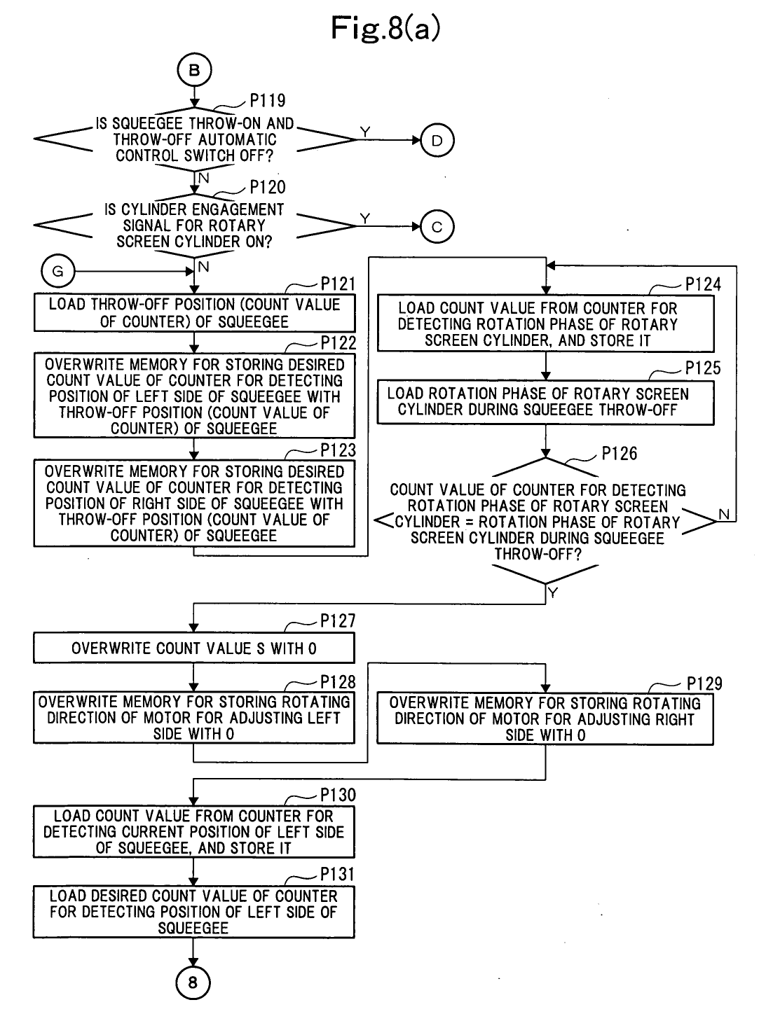

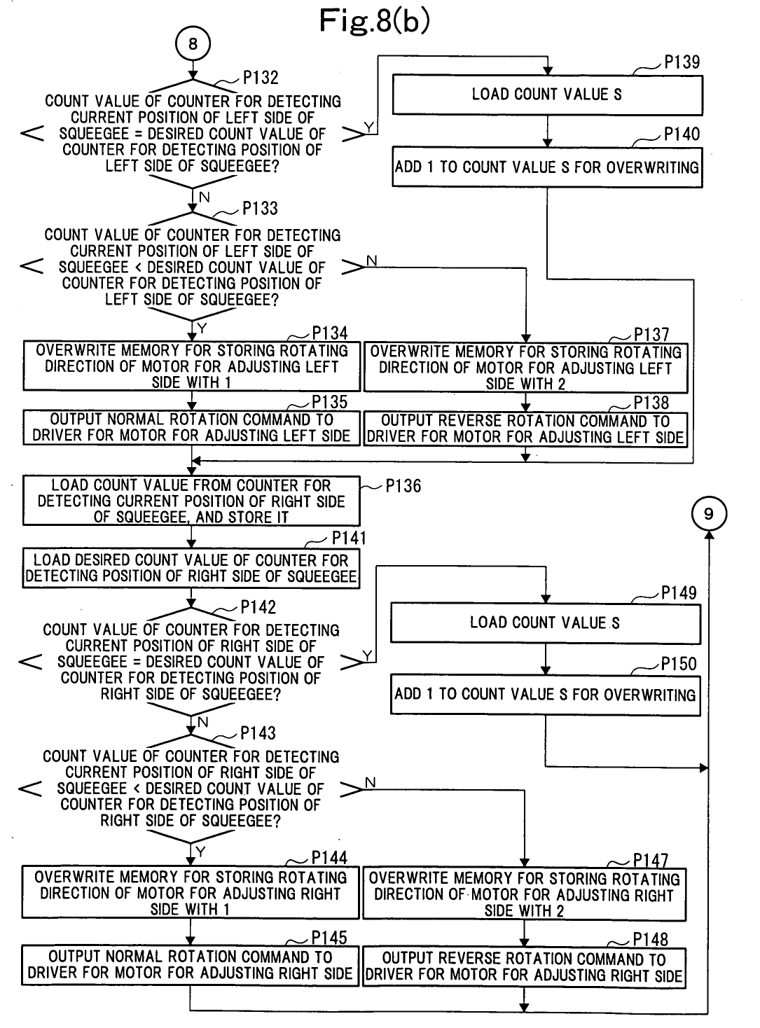

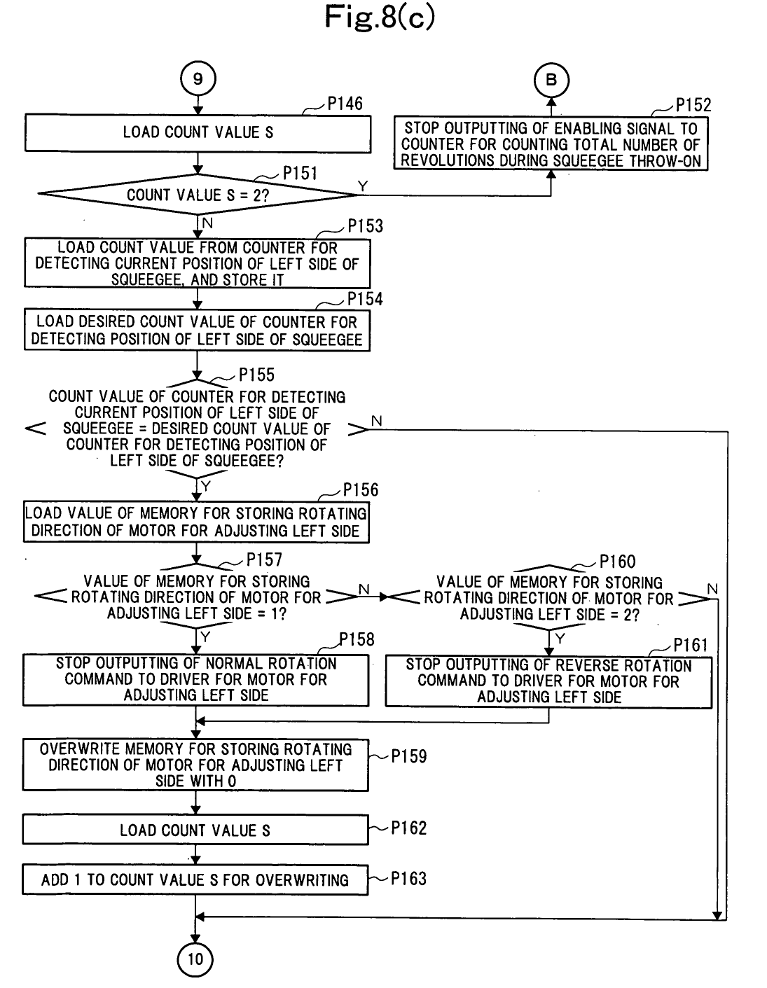

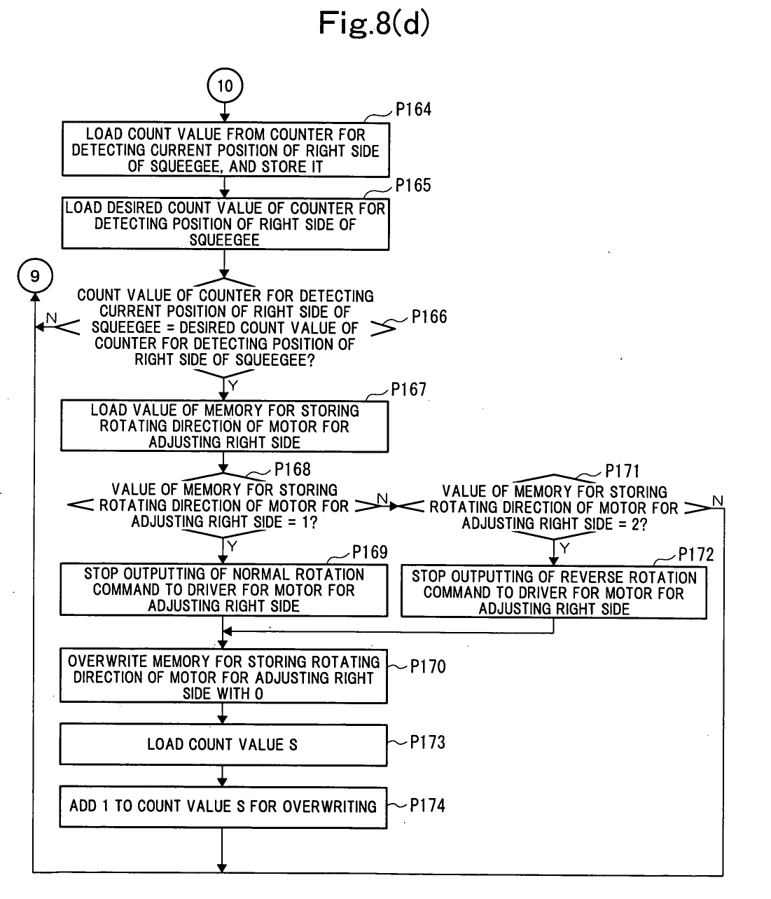

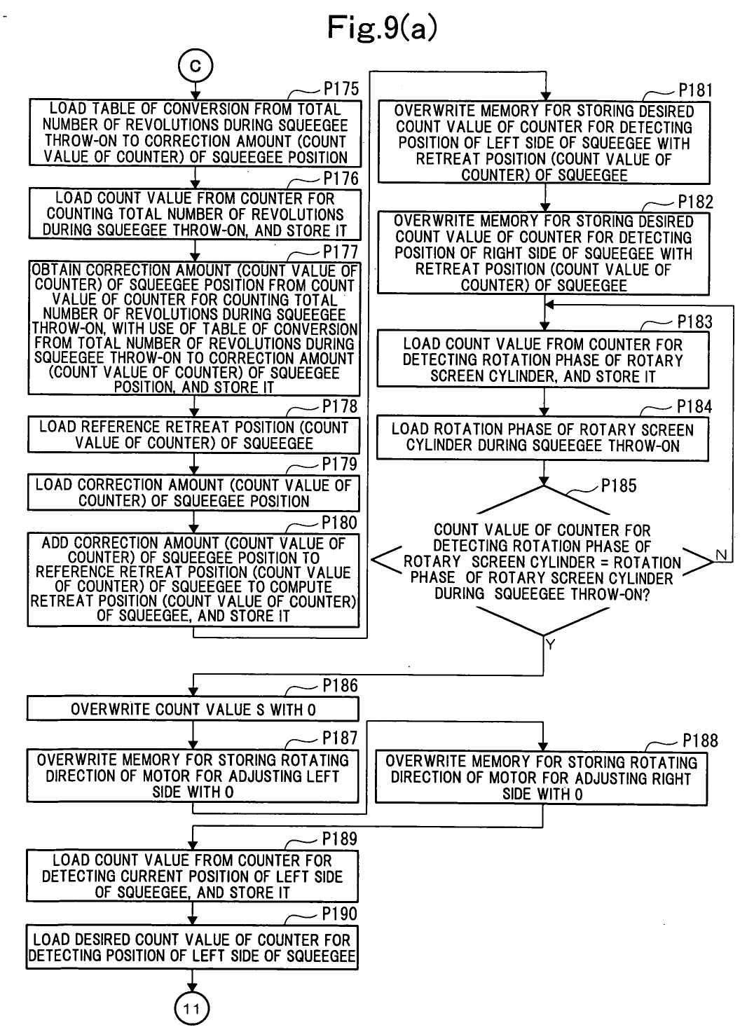

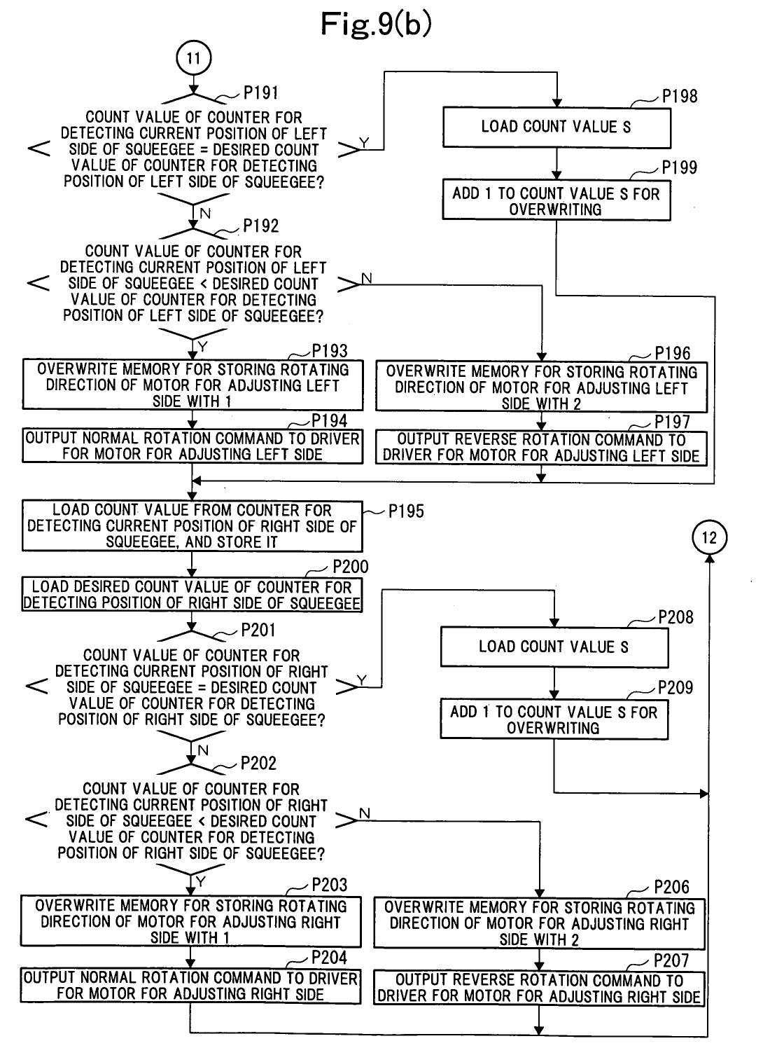

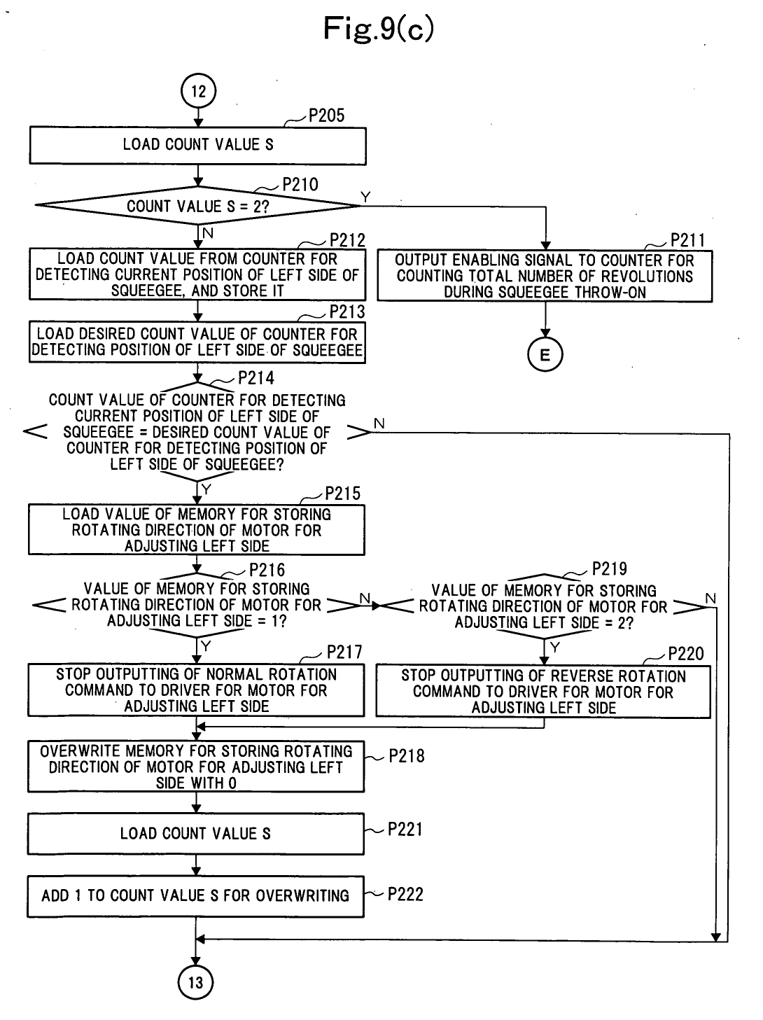

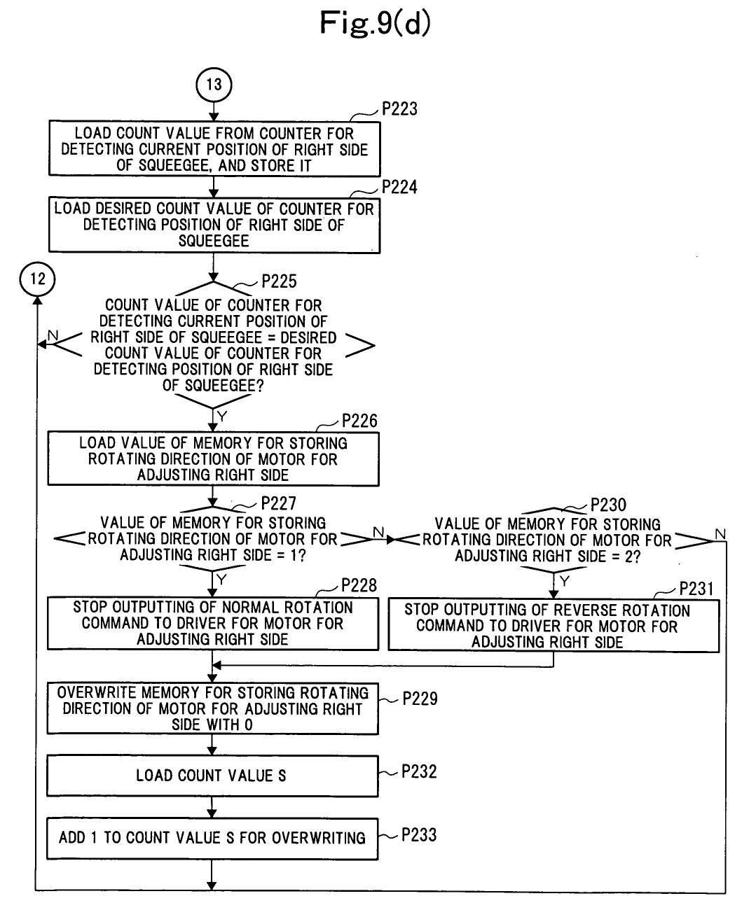

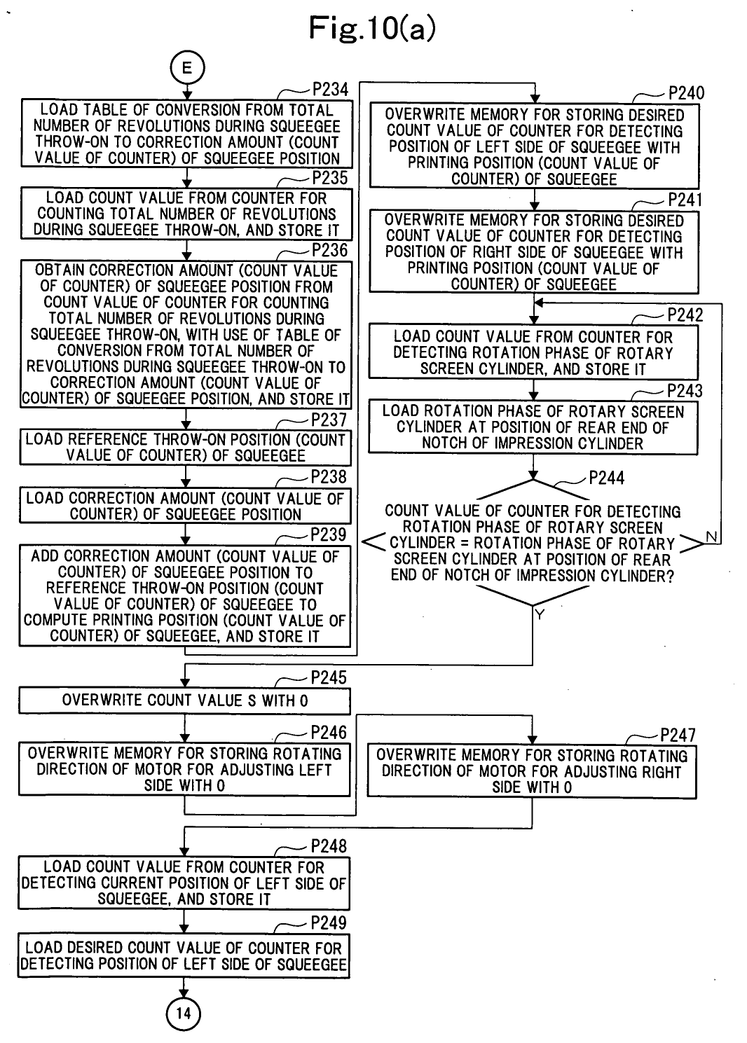

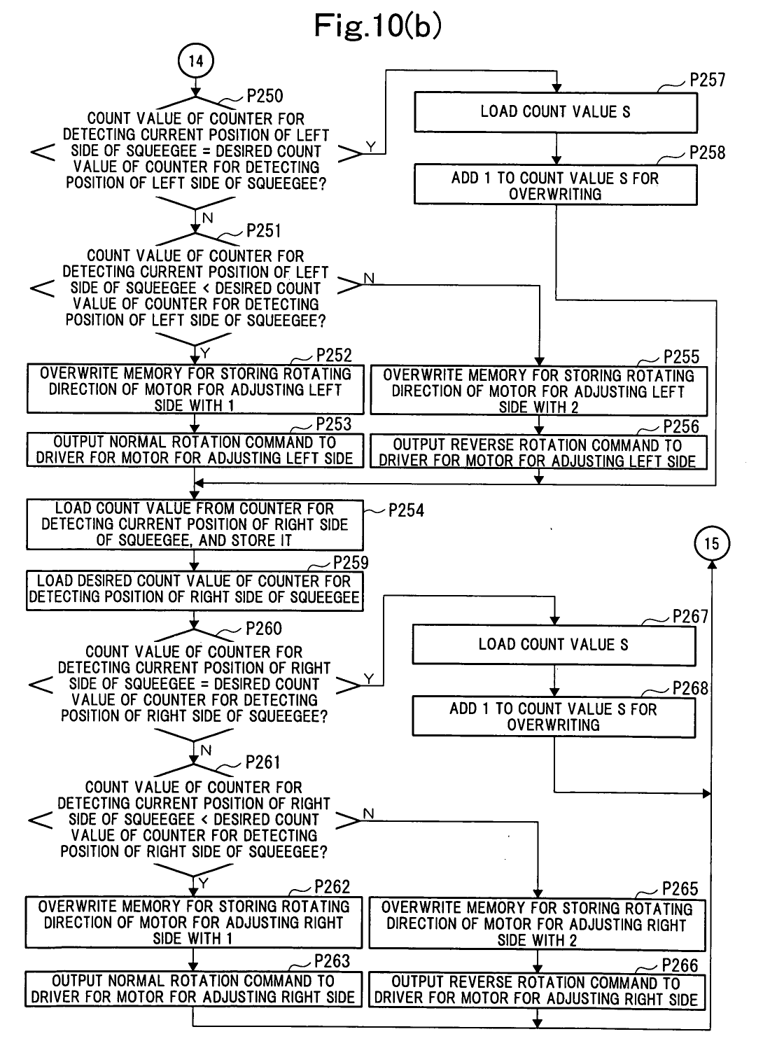

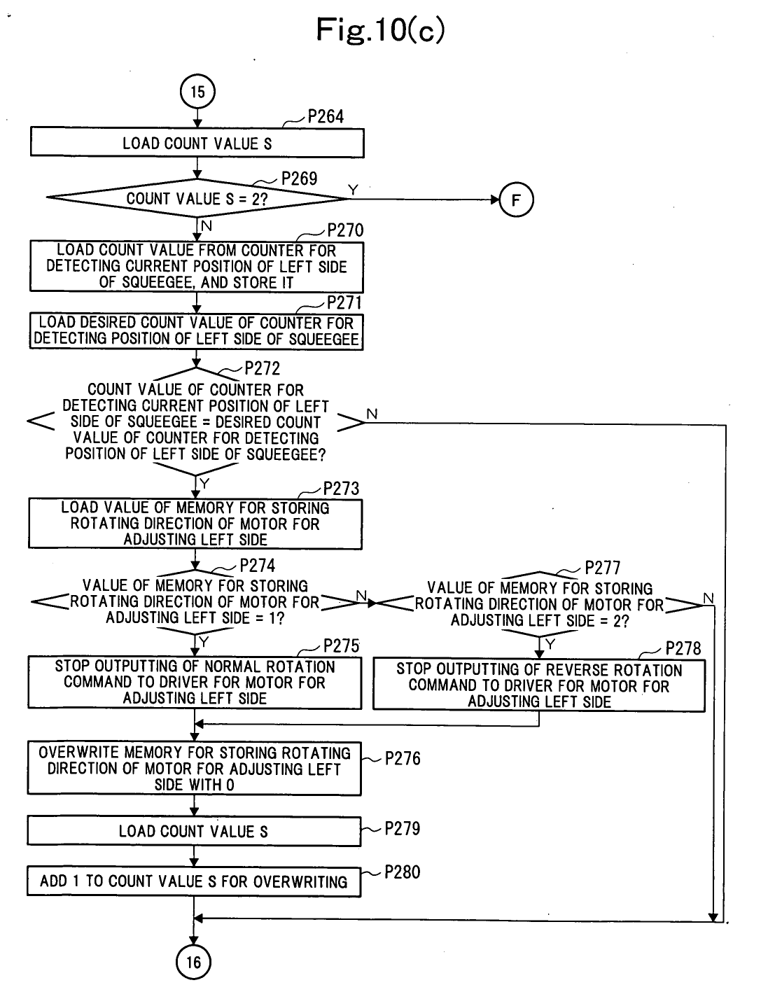

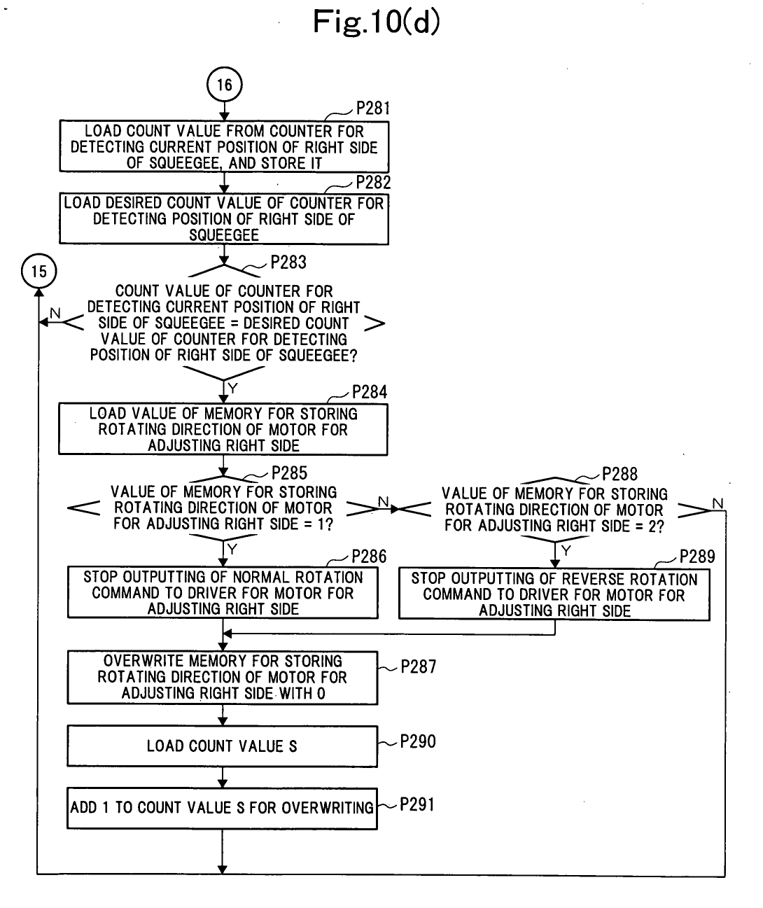

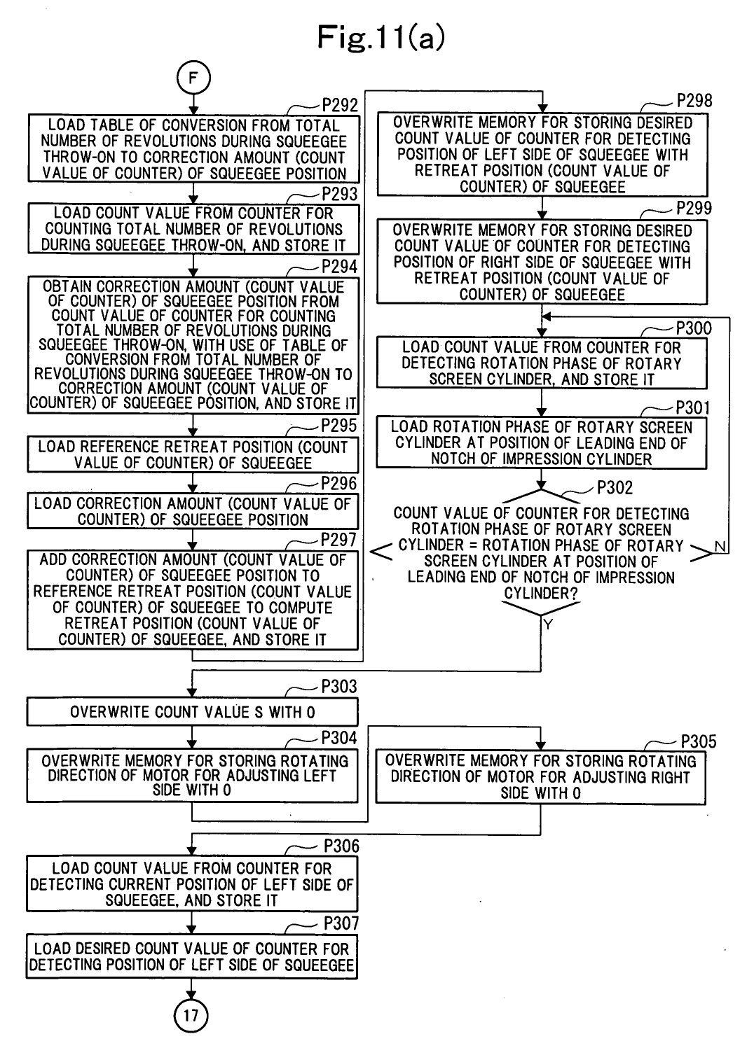

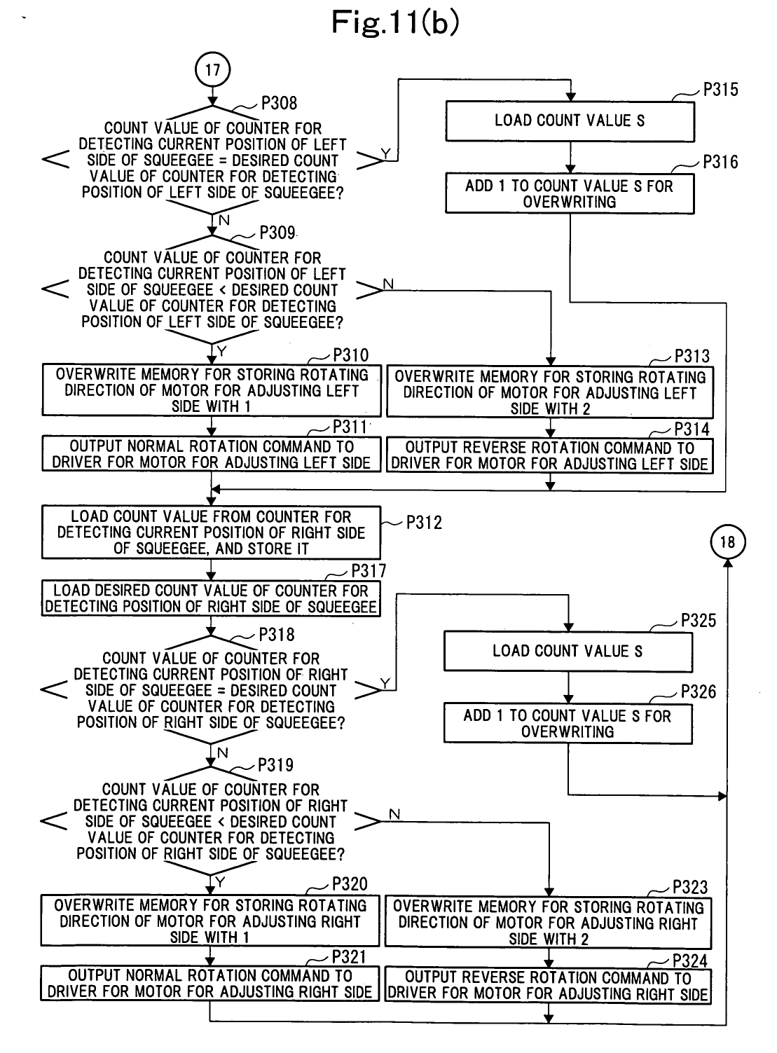

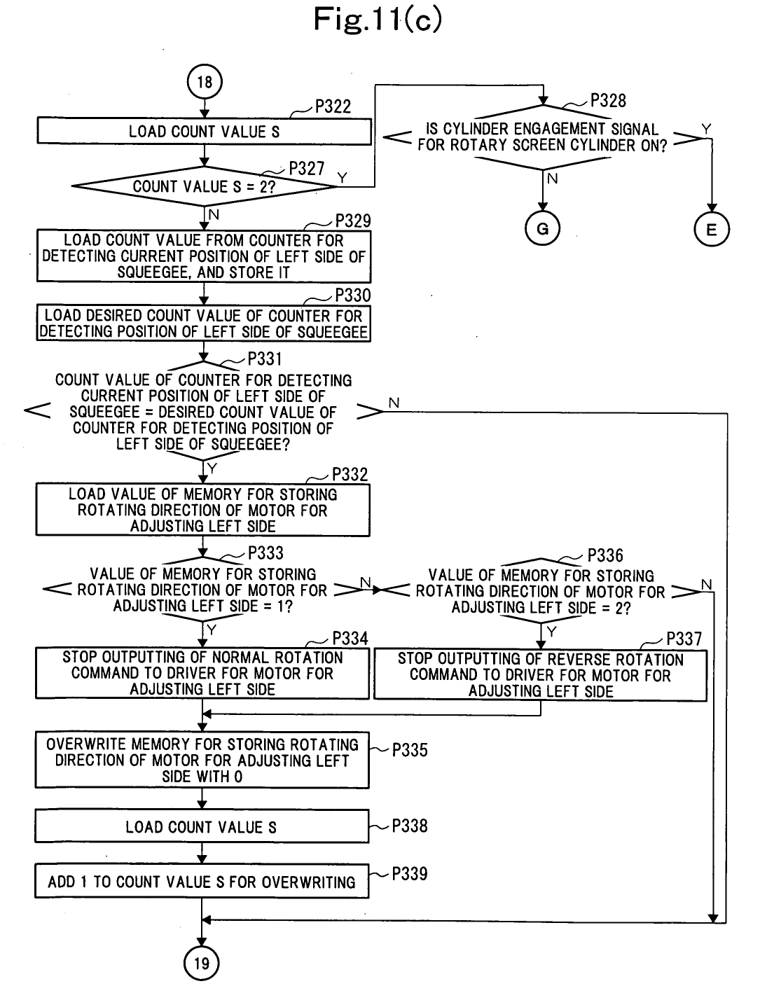

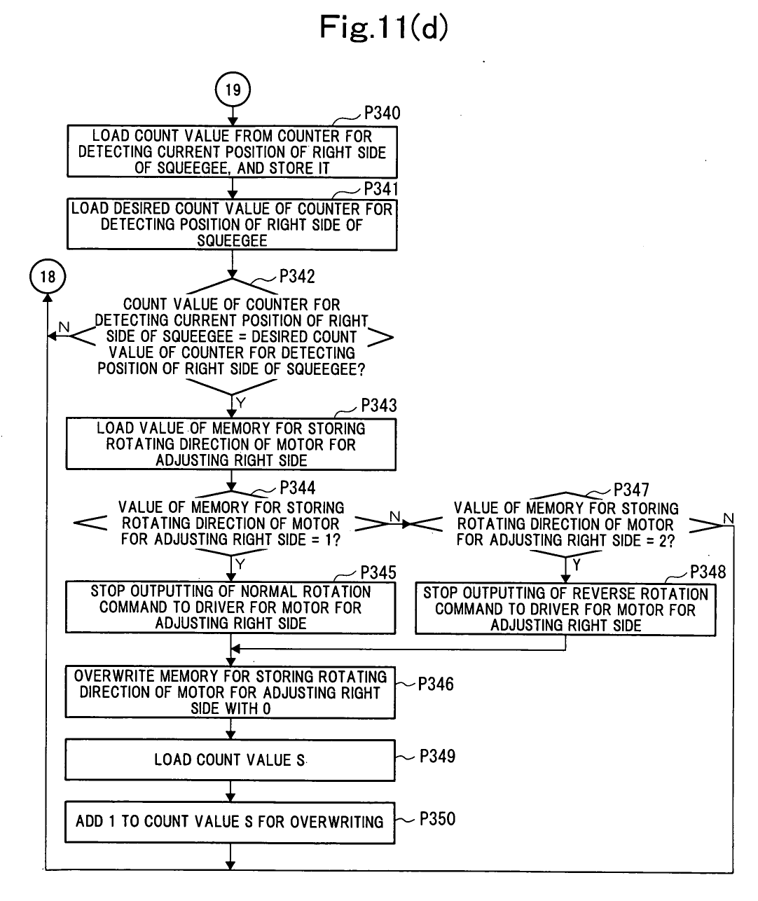

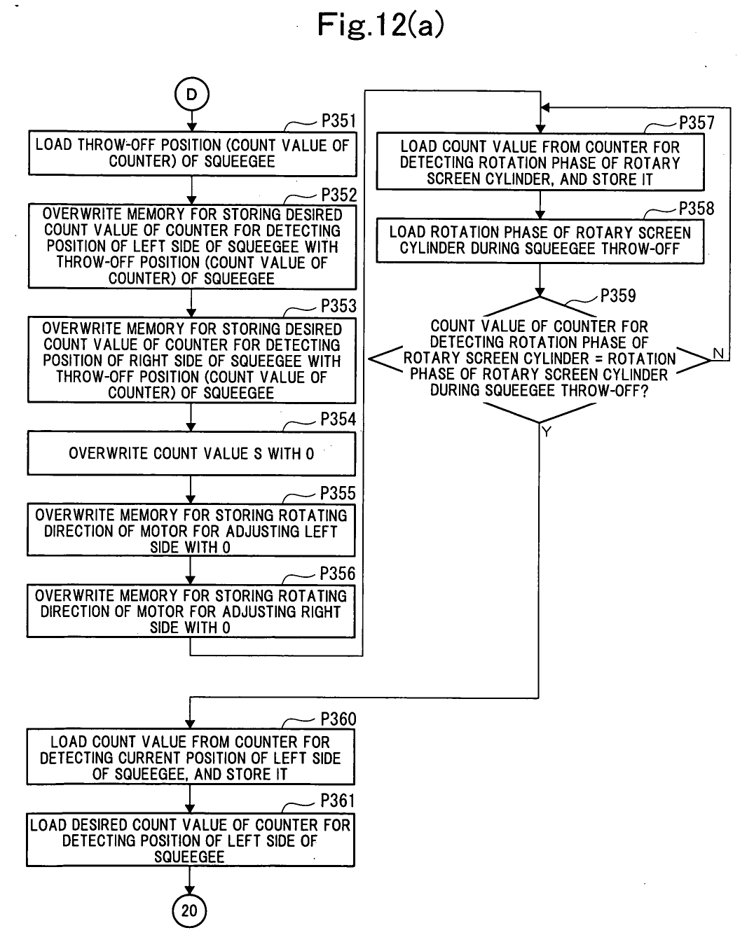

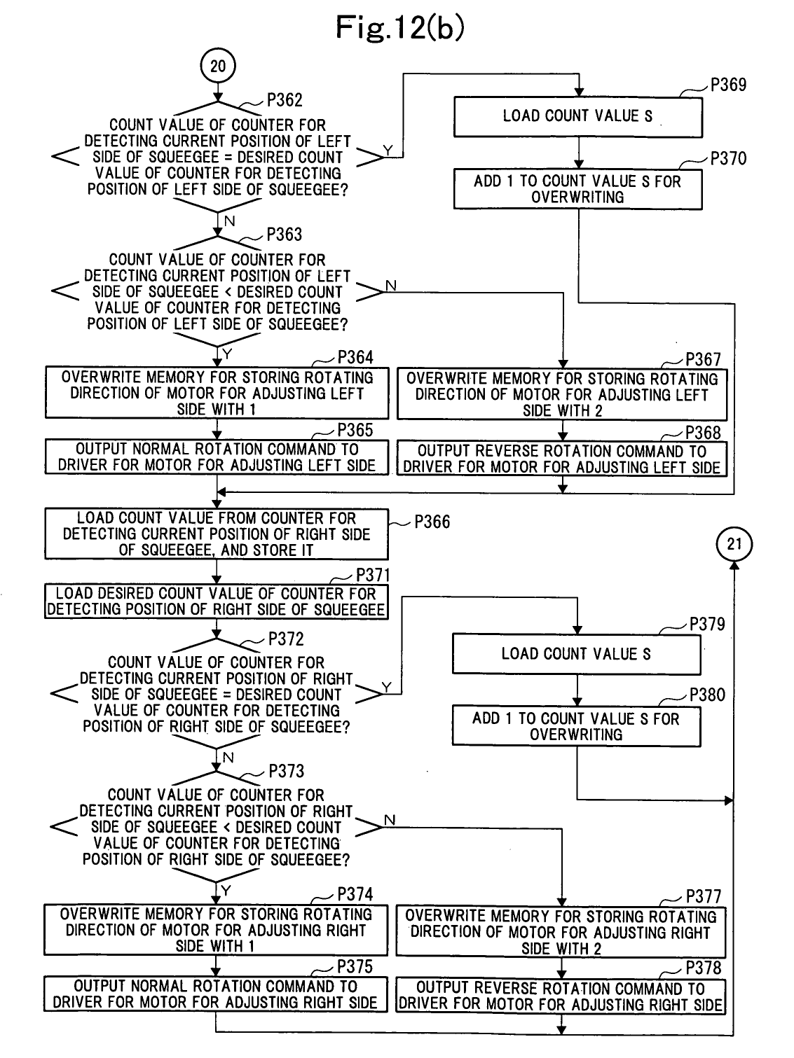

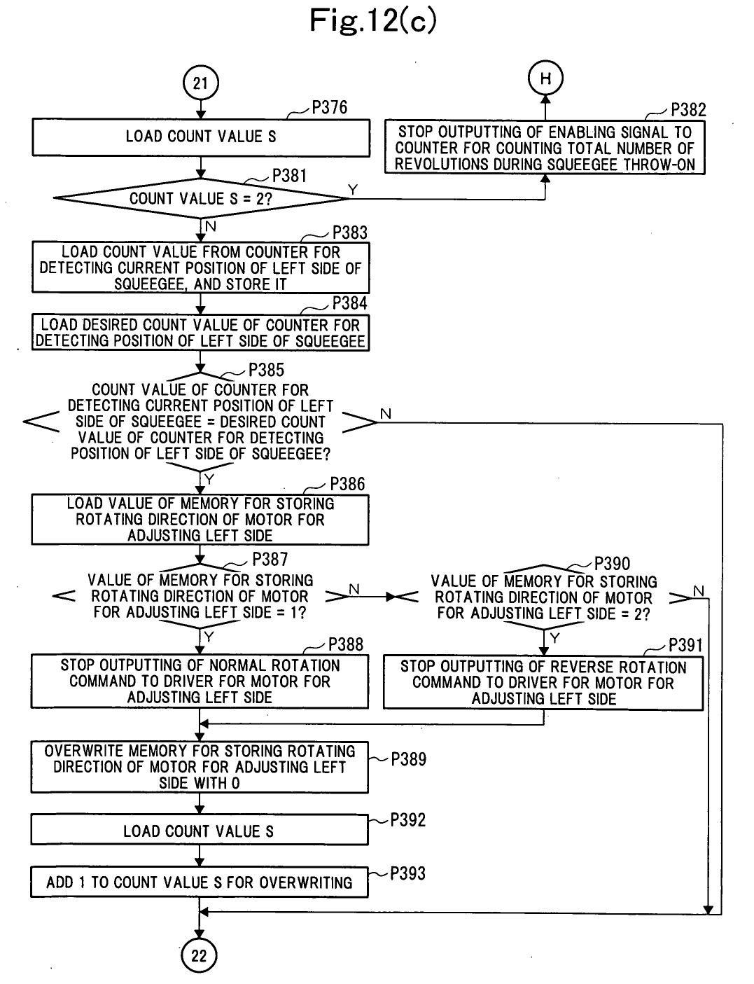

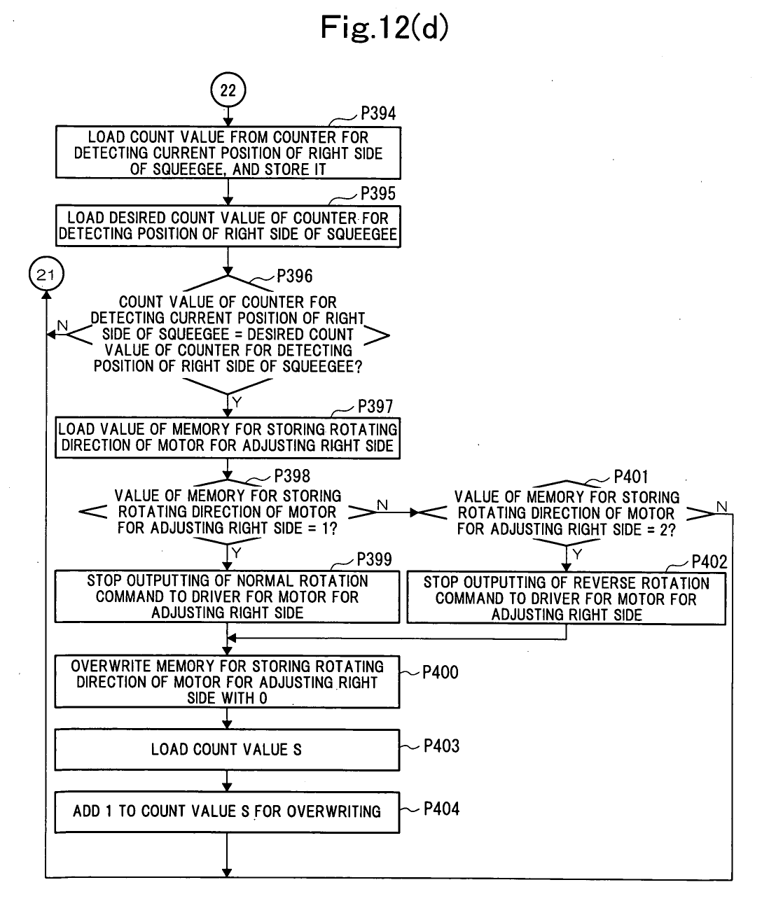

FIG. 1 is a schematic configurational sectional view of a rotary screen printing unit in a rotary screen printing press showing Embodiment 1 of the present invention. FIG. 2 is a right side view of the rotary screen printing unit in FIG. 1. FIG. 3 is a left side view of the rotary screen printing unit in FIG. 1. FIGS. 4(a) and 4(b) are operating state views. FIGS. 5(a) to 5(c) are control block diagrams of a squeegee throw-on and throw-off control device. FIGS. 6(a) to 6(e) are motion flow charts of the squeegee throw-on and throw-off control device. FIGS. 7(a) to 7(d) are motion flow charts of the squeegee throw-on and throw-off control device. FIGS. 8(a) to 8(d) are motion flow charts of the squeegee throw-on and throw-off control device. FIGS. 9(a) to 9(d) are motion flow charts of the squeegee throw-on and throw-off control device. FIGS. 10(a) to 10(d) are motion flow charts of the squeegee throw-on and throw-off control device. FIGS. 11(a) to 11(d) are motion flow charts of the squeegee throw-on and throw-off control device. FIGS. 12(a) to 12(d) are motion flow charts of the squeegee throw-on and throw-off control device.

In the rotary screen printing unit in the rotary screen printing press (rotary stencil printing press=rotary stencil printing plate liquid coating machine), as shown in FIG. 1, a rotary screen cylinder (stencil printing plate cylinder) 11 is supported between right and left frames 10 via eccentric bearings 12 to be capable of being thrown on and thrown off an impression cylinder 13. The right and left eccentric bearings 12 are supported by the right and left frames 10 to be pivotable and slidable in a lateral direction (axial direction).

The impression cylinder 13 has notches (concavities) 13b provided in an outer peripheral surface thereof, each notch 13b accommodating a gripper device (a device for holding a material to be liquid coated) 13a for holding a material to be printed (a material to be liquid coated), W, such as paper, as shown in FIGS. 4(a) and 4(b). In the illustrated embodiment, two of the notches 13b are provided at positions symmetrical with respect to the central point of the impression cylinder 13, but this is not limitative.

The rotary screen cylinder 11 has a cylindrical screen printing forme (stencil printing plate) 11c supported between right and left tubular end members 11a via intermediate members 11b. Also, the rotary screen cylinder 11 is supported by bearings 14 at small-diameter portions of the right and left tubular end members 11a to be rotatable with respect to the eccentric bearings 12.

A gear 15 is located at, and secured to, an end part of the small-diameter portion of the right tubular end member 11a, and a gear 17 secured onto an output shaft of a motor 16 meshes with the gear 15. The motor 16 is mounted on a subframe 18 bound to the right frame 10.

Thus, the rotary screen cylinder 11 can be rotationally driven and circumferentially registered by the motor 16 via the above-mentioned gear mechanism.

One end of a link 19 is pinned to each of the right and left eccentric bearings 12, and the leading end of a lever 20 is pinned to the other end of the link 19. Proximal end portions of the right and left levers 20 are secured to right and left end portions of a rotating shaft 21 journaled between the right and left frames 10. A leading end of an actuator 22 is pinned to the left lever 20.

Hence, the eccentric bearing 12 is pivoted by the actuator 22 via the above-mentioned link mechanism, whereby the rotary screen cylinder 11 is eccentrically rotated to be capable of being thrown on and thrown off the impression cylinder 13 (see FIG. 4(a) and FIG. 4(b)).

An elongated hole, which is formed in a flange portion 12a of each of the right and left eccentric bearings 12, is fitted with a head 23a of a bolt 23 such that the head 23a is rotatable, and movable in the direction of the major diameter of the elongated hole, but immovable in the axial direction. On the other hand, a threaded portion 23b of the bolt 23 is fitted into a tapped hole of the frame 10. A gear 24a is secured to the head 23a of each of the right and left bolts 23, and a gear 24b secured onto an output shaft of a motor 25 meshes with the gear 24a. The right and left motors 25 are mounted on support brackets 26 bound to the right and left frames 10.

Thus, the right and left eccentric bearings 12 are slid in the lateral direction (axial direction) by the motors 25 via the aforementioned gear mechanism and feed screw mechanism to make possible the tension adjustment of the screen printing forme 11c and the movement of the bearing at the time of rotary screen cylinder removal.

As shown in FIGS. 2 and 3 as well, a pipe-shaped support shaft 27 closed at the right end is inserted through the interior of the rotary screen cylinder 11. The right end side of the support shaft 27 is fitted into, and supported by, a fitting hole 28a of a bearing member 28, which is located outwardly and laterally of the subframe 18, in such a manner as to be turnable and movable (slidable) in the lateral direction (axial direction), while the left end side of the support shaft 27 is fitted into, and supported by, a bearing member 29, which is located outwardly and laterally of the left frame 10, in such a manner as not to be turnable and movable (slidable) in the lateral direction (axial direction).

That is, the left end side of the support shaft 27 is inhibited from moving (sliding) in the lateral direction (axial direction) by stepped portions 27a and 27b at two (right and left) locations, and is also inhibited from turning because it is pressed from above by a holding plate 30a while being accommodated within a fitting groove 29a of the bearing member 29 having a groove bottom formed in a taper shape.

The holding plate 30a horizontally rotates about a fulcrum pin 31, and can thus open and close the fitting groove 29a. With the fitting groove 29a being closed, a fixing lever 30b is screwed into the holding plate 30a and the bearing member 29, whereby the closed state is retained.

The right and left bearing members 28 and 29 are supported movably in a vertical direction via ball screws 32 by support cases 31 annexed to the frame 10 and the subframe 18. Concretely, a nut member 32a of the ball screw 32 is secured to the interior of the support case 31, and a screw member 32b screwed to the nut member 32a penetrates the interior of the support case 31 in a vertical direction. A non-screw-forming shaft portion of the screw member 32b is supported pivotably and slidably within the support case 31 via a bearing 33.

An upper end portion of the screw member 32b is engaged with an engaging hole 28b or 29b of the bearing member 28 or 29 via a spherical bearing 34 to permit the rotation of the screw member 32b and the inclination of the support shaft 27 during position adjustment (to be described later) of the support shaft 27. A gear 35a is secured to a lower end portion of the screw member 32b, and a gear 35b secured onto an output shaft of a motor 36A or 36B meshes with the gear 35a. The motor 36A for adjusting the left side is mounted on an outer surface of the frame 10, and the motor 36B for adjusting the right side is mounted on an outer surface of the subframe 18.

In FIG. 1, reference numeral 39 denotes a whirl-stop pin for positioning of the bearing member 28 or 29 in the absence of the support shaft 27, and for positioning, in the longitudinal direction, of the support shaft 27.

A rubber squeegee (ink transfer member=liquid transfer member) 38 is supported on the support shaft 27 via a holder 37, as shown in FIGS. 4(a) and 4(b). A leading end of the squeegee 38 makes a sliding contact with the inner peripheral surface of the screen printing forme 11c, with the result that ink (liquid) supplied into the screen printing forme 11c through the interior of the support shaft 27 is transferred onto a printing surface of the material to be printed, W, via holes of the screen printing forme 11c.

In the present Embodiment 1, the motors 36A and 36B are drivingly controlled, independently of each other, by a squeegee throw-on and throw-off control device (control means) 40A to be described later, whereby throw-on and throw-off of the squeegee 38 with respect to the inner peripheral surface of the screen printing forme 11c, and the adjustment of the throw-on position of the squeegee 38 are automatically carried out. Moreover, the squeegee throw-on and throw-off control device 40A brings the squeegee 38 into contact with the inner peripheral surface of the screen printing forme 11c, and controls the pressing force of the squeegee 38 acting on the inner peripheral surface of the screen printing forme 11c to be smaller than the pressing force exerted during printing (liquid coating), when the squeegee 38 opposes the notch 13b of the impression cylinder 13, as a result of the throw-on position adjustment.

The squeegee throw-on and throw-off control device 40A can preset the pressing force of the squeegee 38 when it opposes the notch 13b of the impression cylinder 13 (in other words, the retreat position of the squeegee 38), in accordance with the type of the screen printing forme 11c (material, forme thickness, mesh size, etc.), the picture pattern area rate (or image area rate) of a picture pattern printed on the material W to be printed, the type of ink used in printing (viscosity, yield value, type of pigment, etc.), and the type of the squeegee 38 (material, thickness, etc.). Concretely, relevant motions will be described by motion flow charts to be offered later.

The squeegee throw-on and throw-off control device 40A comprises CPU 41, RAM 42, ROM 43, input/output devices 44 to 50, and an interface 51 connected together by BUS (bus line), as shown in FIGS. 5(a) to 5(c). To the BUS (bus line), the following memories are connected: A memory M1 for storing the type of the material to be printed, a memory M2 for storing the thickness of the material to be printed, a memory M3 for storing the material for the screen printing forme, a memory M4 for storing the thickness of the screen printing forme, a memory M5 for storing the picture pattern area rate, a memory M6 for storing the mesh size of the screen printing forme, a memory M7 for storing the viscosity of ink, a memory M8 for storing the yield value of ink, a memory M9 for storing the type of a pigment of ink, a memory M10 for storing the material for the squeegee, and a memory M11 for storing the thickness of the squeegee.

To the BUS (bus line), the following memories are further connected: A memory M12 for storing a table of conversion from the type of the material to be printed to the throw-on position (count value of a counter) of the squeegee, a memory M13 for storing the provisional reference throw-on position (count value of the counter) of the squeegee, a memory M14 for storing a table of conversion from the thickness of the material to be printed to the throw-on position (count value of the counter) of the squeegee, a memory M15 for storing the first correction value (count value of the counter) of the throw-on position of the squeegee, a memory M16 for storing a table of conversion from the material for the screen printing forme to the throw-on position (count value of the counter) of the squeegee, a memory M17 for storing the second correction value (count value of the counter) of the throw-on position of the squeegee, a memory M18 for storing a table of conversion from the thickness of the screen printing forme to the throw-on position (count value of the counter) of the squeegee, a memory M19 for storing the third correction value (count value of the counter) of the throw-on position of the squeegee, a memory M20 for storing a table of conversion from the picture pattern area rate to the throw-on position (count value of the counter) of the squeegee, and a memory M21 for storing the fourth correction value (count value of the counter) of the throw-on position of the squeegee.

To the BUS (bus line), the following memories are further connected: A memory M22 for storing a table of conversion from the mesh size of the screen printing forme to the throw-on position (count value of the counter) of the squeegee, a memory M23 for storing the fifth correction value (count value of the counter) of the throw-on position of the squeegee, a memory M24 for storing a table of conversion from the viscosity of ink to the throw-on position (count value of the counter) of the squeegee, a memory M25 for storing the sixth correction value (count value of the counter) of the throw-on position of the squeegee, a memory M26 for storing a table of conversion from the yield value of ink to the throw-on position (count value of the counter) of the squeegee, a memory M27 for storing the seventh correction value (count value of the counter) of the throw-on position of the squeegee, a memory M28 for storing a table of conversion from the type of the pigment of ink to the throw-on position (count value of the counter) of the squeegee, a memory M29 for storing the eighth correction value (count value of the counter) of the throw-on position of the squeegee, a memory M30 for storing a table of conversion from the material for the squeegee to the throw-on position (count value of the counter) of the squeegee, a memory M31 for storing the ninth correction value (count value of the counter) of the throw-on position of the squeegee, a memory M32 for storing a table of conversion from the thickness of the squeegee to the throw-on position (count value of the counter) of the squeegee, and a memory M33 for storing the tenth correction value (count value of the counter) of the throw-on position of the squeegee.

To the BUS (bus line), the following memories are further connected: A memory M34 for storing the reference throw-on position (count value of the counter) of the squeegee, a memory M35 for storing a table of conversion from the material for the screen printing forme to the retreat position (count value of the counter) of the squeegee, a memory M36 for storing the provisional reference retreat position (count value of the counter) of the squeegee, a memory M37 for storing a table of conversion from the thickness of the screen printing forme to the retreat position (count value of the counter) of the squeegee, a memory M38 for storing the first correction value (count value of the counter) of the retreat position of the squeegee, a memory M39 for storing a table of conversion from the picture pattern area rate to the retreat position (count value of the counter) of the squeegee, a memory M40 for storing the second correction value (count value of the counter) of the retreat position of the squeegee, a memory M41 for storing a table of conversion from the mesh size of the screen printing forme to the retreat position (count value of the counter) of the squeegee, a memory M42 for storing the third correction value (count value of the counter) of the retreat position of the squeegee, a memory M43 for storing a table of conversion from the viscosity of ink to the retreat position (count value of the counter) of the squeegee, a memory M44 for storing the fourth correction value (count value of the counter) of the retreat position of the squeegee, a memory M45 for storing a table of conversion from the yield value of ink to the retreat position (count value of the counter) of the squeegee, and a memory M46 for storing the fifth correction value (count value of the counter) of the retreat position of the squeegee.

To the BUS (bus line), the following memories are further connected: A memory M47 for storing a table of conversion from the type of the pigment of ink to the retreat position (count value of the counter) of the squeegee, a memory M48 for storing the sixth correction value (count value of the counter) of the retreat position of the squeegee, a memory M49 for storing a table of conversion from the material for the squeegee to the retreat position (count value of the counter) of the squeegee, a memory M50 for storing the seventh correction value (count value of the counter) of the retreat position of the squeegee, a memory M51 for storing a table of conversion from the thickness of the squeegee to the retreat position (count value of the counter) of the squeegee, a memory M52 for storing the eighth correction value (count value of the counter) of the retreat position of the squeegee, a memory M53 for storing the reference retreat position (count value of the counter) of the squeegee, a memory M54 for storing the throw-off position (count value of the counter) of the squeegee, a memory M55 for storing the desired count value of a counter for detecting the position of the left side of the squeegee, a memory M56 for storing the desired count value of a counter for detecting the position of the right side of the squeegee, a memory M57 for storing the rotation phase of the rotary screen cylinder at the position of the rear end of the notch of the impression cylinder, and a memory M58 for storing the rotation phase of the rotary screen cylinder during squeegee throw-off.

To the BUS (bus line), the following memories are further connected: A memory M59 for storing the count value S, a memory M60 for storing the rotating direction of the motor for adjusting the left side, a memory M61 for storing the rotating direction of the motor for adjusting the right side, a memory M62 for storing the count value of a counter for detecting the current position of the left side of the squeegee, a memory M63 for storing the count value of a counter for detecting the current position of the right side of the squeegee, a memory M64 for storing a table of conversion from the total number of revolutions during squeegee throw-on to the correction amount (count value of the counter) of the squeegee position, a memory M65 for storing the count value of a counter for counting the total number of revolutions during squeegee throw-on, a memory M66 for storing the correction amount (count value of the counter) of the squeegee position, a memory M67 for storing the retreat position (count value of the counter) of the squeegee, a memory M68 for storing the count value of a counter for detecting the rotation phase of the rotary screen cylinder, a memory M69 for storing the rotation phase of the rotary screen cylinder during squeegee throw-on, a memory M70 for storing the printing position (count value of the counter) of the squeegee, and a memory M71 for storing the rotation phase of the rotary screen cylinder at the position of the leading end of the notch of the impression cylinder.

To the input/output device 44, the following are connected: A squeegee throw-on and throw-off automatic control switch 52, an input device 53 such as a keyboard, a display device 54 such as CRT or a display, and an output device 55 such as a printer or a floppy disk (registered trademark) drive.

To the input/output device 45, the following are connected: A setting instrument 56 for the type of the material to be printed, a setting instrument 57 for the thickness of the material to be printed, a setting instrument 58 for the material for the screen printing forme, a setting instrument 59 for the thickness of the screen printing forme, a setting instrument 60 for the mesh size of the screen printing forme, a setting instrument 61 for the viscosity of ink, a setting instrument 62 for the yield value of ink, a setting instrument 63 for the type of the pigment of ink, a setting instrument 64 for the material for the squeegee, and a setting instrument 65 for the thickness of the squeegee.

To the input/output device 46, the motor 36A for adjusting the left side is connected via a driver 66 for the motor for adjusting the left side, and a rotary encoder 69 for the motor for adjusting the left side which is drivingly connected to the motor 36A is connected via a counter 68 for detecting the current position of the left side of the squeegee.

To the input/output device 47, the motor 36B for adjusting the right side is connected via a driver 70 for the motor for adjusting the right side, and a rotary encoder 73 for the motor for adjusting the right side which is drivingly connected to the motor 36B is connected via a counter 72 for detecting the current position of the right side of the squeegee.

To the input/output device 48, a rotary encoder 75 for detecting the rotation phase of the rotary screen cylinder is connected via a counter 74 for detecting the rotation phase of the rotary screen cylinder. The rotary encoder 75 for detecting the rotation phase of the rotary screen cylinder is provided on a rotating part of the rotary screen printing press rotating in synchronism with the rotary screen cylinder in such a manner as to generate a zero pulse in the reference rotation phase of the rotary screen cylinder. Thus, the counter 74 for detecting the rotation phase of the rotary screen cylinder is reset in the reference rotation phase of the rotary screen cylinder each time the rotary screen cylinder makes one rotation. Then, the counter 74 for detecting the rotation phase of the rotary screen cylinder counts clock pulses generated in accordance with the rotation of the rotary screen cylinder, producing a count value conformed to the rotation phase of the rotary screen cylinder.

To the input/output device 49, a sensor 77 for detecting one rotation of the rotary screen cylinder is connected via a counter 76 for counting the total number of revolutions during squeegee throw-on. The sensor 77 for detecting one rotation of the rotary screen cylinder is provided on a rotating part of the rotary screen printing press so as to produce one pulse each time the rotary screen cylinder makes one rotation. Thus, the counter 76 for counting the total number of revolutions during squeegee throw-on is adapted to count the number of revolutions of the rotary screen cylinder in an operating state.

To the input/output device 50, a cylinder engagement circuit 78 for the rotary screen cylinder is connected.

To the interface 51, a picture pattern area rate measuring device 79 for measuring the picture pattern area rate of the picture pattern to be printed on the material W to be printed is connected. The picture pattern area rate measuring device 79 used is a publicly known one, for example, that which images the picture pattern surface of the screen printing forme 11c by a TV camera having solid photoelectric conversion elements arranged in a matrix form, and measures the picture pattern area rate.

The control actions or motions of the squeegee throw-on and throw-off control device 40A configured as above will be described in detail based on the motion flow charts of FIGS. 6(a) to 6(e), FIGS. 7(a) to 7(d), FIGS. 8(a) to 8(d), FIGS. 9(a) to 9(d), FIGS. 10(a) to 10(d), FIGS. 11(a) to 11(d), and FIGS. 12(a) to 12(d).

In Step P1, it is determined whether there is an input to the setting instrument 56 for the type of the material to be printed. If the answer is Y (yes), the type of the material W to be printed is loaded from the setting instrument 56 for the type of the material to be printed, and stored into the memory M1, in Step P2, and the program proceeds to Step P3. If the answer is N (no), the program directly shifts to Step P3.

Then, in Step P3, it is determined whether there is an input to the setting instrument 57 for the thickness of the material to be printed. If the answer is Y, the thickness of the material to be printed is loaded from the setting instrument 57 for the thickness of the material to be printed, and stored into the memory M2, in Step P4. Then, the program proceeds to Step P5. If the answer is N, the program directly shifts to Step P5.

Then, in Step P5, it is determined whether there is an input to the setting instrument 58 for the material for the screen printing forme. If the answer is Y, the material for the screen printing forme 11c is loaded from the setting instrument 58 for the material for the screen printing forme, and stored into the memory M3, in Step P6. Then, the program proceeds to Step P7. If the answer is N, the program directly shifts to Step P7.

Then, in Step P7, it is determined whether there is an input to the setting instrument 59 for the thickness of the screen printing forme. If the answer is Y, the thickness of the screen printing forme is loaded from the setting instrument 59 for the thickness of the screen printing forme, and stored into the memory M4, in Step P8. Then, the program proceeds to Step P9. If the answer is N, the program directly shifts to Step P9.

Then, in Step P9, it is determined whether the picture pattern area rate has been transmitted from the picture pattern area rate measuring device 79. If the answer is Y, the picture pattern area rate is received from the picture pattern area rate measuring device 79, and stored into the memory M5, in Step P10. Then, the program proceeds to Step P11. If the answer is N, the program directly shifts to Step P11.

Then, in Step P11, it is determined whether there is an input to the setting instrument 60 for the mesh size of the screen printing forme. If the answer is Y, the mesh size of the screen printing forme 11c is loaded from the setting instrument 60 for the mesh size of the screen printing forme, and stored into the memory M6, in Step P12. Then, the program proceeds to Step P13. If the answer is N, the program directly shifts to Step P13.

Then, in Step P13, it is determined whether there is an input to the setting instrument 61 for the viscosity of ink. If the answer is Y, the viscosity of ink is loaded from the setting instrument 61 for the viscosity of ink, and stored into the memory M7, in Step P14. Then, the program proceeds to Step P15. If the answer is N, the program directly shifts to Step P15.

Then, in Step P15, it is determined whether there is an input to the setting instrument 62 for the yield value of ink. If the answer is Y, the yield value of ink is loaded from the setting instrument 62 for the yield value of ink, and stored into the memory M8, in Step P16. Then, the program proceeds to Step P17. If the answer is N, the program directly shifts to Step P17.

Then, in Step P17, it is determined whether there is an input to the setting instrument 63 for the type of the pigment of ink. If the answer is Y, the type of the pigment of ink is loaded from the setting instrument 63 for the type of the pigment of ink, and stored into the memory M9, in Step P18. Then, the program proceeds to Step P19. If the answer is N, the program directly shifts to Step P19.

Then, in Step P19, it is determined whether there is an input to the setting instrument 64 for the material for the squeegee. If the answer is Y, the material for the squeegee 38 is loaded from the setting instrument 64 for the material for the squeegee, and stored into the memory M10, in Step P20. Then, the program proceeds to Step P21. If the answer is N, the program directly shifts to Step P21.

Then, in Step P21, it is determined whether there is an input to the setting instrument 65 for the thickness of the squeegee. If the answer is Y, the thickness of the squeegee is loaded from the setting instrument 65 for the thickness of the squeegee, and stored into the memory M11, in Step P22. Then, the program proceeds to Step P23. If the answer is N, the program directly shifts to Step P23.

Then, in Step P23, it is determined whether the squeegee throw-on and throw-off automatic control switch 52 is ON. If the answer is Y, the table of conversion from the type of the material to be printed to the throw-on position (count value of the counter) of the squeegee is loaded from the memory M12 in Step P24. If the answer is N, the program returns to Step P1.

Then, in Step P25, the type of the material W to be printed is loaded from the memory M1. Then, in Step P26, the provisional reference throw-on position (count value of the counter) of the squeegee is obtained from the type of the material W to be printed, with the use of the table of conversion from the type of the material to be printed to the throw-on position (count value of the counter) of the squeegee, and is stored into the memory M13.

Then, in Step P27, the type of the material W to be printed is loaded from the memory M1. Then, in Step P28, the table of conversion from the thickness of the material to be printed to the throw-on position (count value of the counter) of the squeegee, which is commensurate with the type of the material to be printed, is loaded from the memory M14.

Then, in Step P29, the thickness of the material to be printed is loaded from the memory M2. Then, in Step P30, the first correction value (count value of the counter) of the throw-on position of the squeegee is obtained from the thickness of the material to be printed, with the use of the table of conversion from the thickness of the material to be printed to the throw-on position (count value of the counter) of the squeegee, which is commensurate with the type of the material to be printed, and this correction value is stored into the memory M15.

Then, in Step P31, the table of conversion from the material for the screen printing forme to the throw-on position (count value of the counter) of the squeegee is loaded from the memory M16. Then, in Step P32, the material for the screen printing forme 11c is loaded from the memory M3. Then, in Step P33, the second correction value (count value of the counter) of the throw-on position of the squeegee is obtained from the material for the screen printing forme 11c, with the use of the table of conversion from the material for the screen printing forme to the throw-on position (count value of the counter) of the squeegee, and this correction value is stored into the memory M17.

Then, in Step P34, the material for the screen printing forme 11c is loaded from the memory M3. Then, in Step P35, the table of conversion from the thickness of the screen printing forme to the throw-on position (count value of the counter) of the squeegee, which is commensurate with the material for the screen printing forme, is loaded from the memory M18.

Then, in Step P36, the thickness of the screen printing forme is loaded from the memory M4. Then, in Step P37, the third correction value (count value of the counter) of the throw-on position of the squeegee is obtained from the thickness of the screen printing forme, with the use of the table of conversion from the thickness of the screen printing forme to the throw-on position (count value of the counter) of the squeegee, which is commensurate with the material for the screen printing forme, and this correction value is stored into the memory M19.

Then, in Step P38, the material for the screen printing forme 11c is loaded from the memory M3. Then, in Step P39, the thickness of the screen printing forme is loaded from the memory M4. Then, in Step P40, the table of conversion from the picture pattern area rate to the throw-on position (count value of the counter) of the squeegee, which is commensurate with the material for the screen printing forme and the thickness of the screen printing forme, is loaded from the memory M20.

Then, in Step P41, the picture pattern area rate is loaded from the memory M5. Then, in Step P42, the fourth correction value (count value of the counter) of the throw-on position of the squeegee is obtained from the picture pattern area rate, with the use of the table of conversion from the picture pattern area rate to the throw-on position (count value of the counter) of the squeegee, which is commensurate with the material for the screen printing forme and the thickness of the screen printing forme, and this correction value is stored into the memory M21.

Then, in Step P43, the material for the screen printing forme 11c is loaded from the memory M3. Then, in Step P44, the thickness of the screen printing forme is loaded from the memory M4. Then, in Step P45, the table of conversion from the mesh size of the screen printing forme to the throw-on position (count value of the counter) of the squeegee, which is commensurate with the material for the screen printing forme and the thickness of the screen printing forme, is loaded from the memory M22.

Then, in Step P46, the mesh size of the screen printing forme is loaded from the memory M6. Then, in Step P47, the fifth correction value (count value of the counter) of the throw-on position of the squeegee is obtained from the mesh size of the screen printing forme, with the use of the table of conversion from the mesh size of the screen printing forme to the throw-on position (count value of the counter) of the squeegee, which is commensurate with the material for the screen printing forme and the thickness of the screen printing forme, and this correction value is stored into the memory M23.

Then, in Step P48, the table of conversion from the viscosity of ink to the throw-on position (count value of the counter) of the squeegee is loaded from the memory M24. Then, in Step P49, the viscosity of ink is loaded from the memory M7. Then, in Step P50, the sixth correction value (count value of the counter) of the throw-on position of the squeegee is obtained from the viscosity of ink with the use of the table of conversion from the viscosity of ink to the throw-on position (count value of the counter) of the squeegee, and this correction value is stored into the memory M25.

Then, in Step P51, the table of conversion from the yield value of ink to the throw-on position (count value of the counter) of the squeegee is loaded from the memory M26. Then, in Step P52, the yield value of ink is loaded from the memory M8. Then, in Step P53, the seventh correction value (count value of the counter) of the throw-on position of the squeegee is obtained from the yield value of ink with the use of the table of conversion from the yield value of ink to the throw-on position (count value of the counter) of the squeegee, and this correction value is stored into the memory M27.

Then, in Step P54, the table of conversion from the type of the pigment of ink to the throw-on position (count value of the counter) of the squeegee is loaded from the memory M28. Then, in Step P55, the type of the pigment of ink is loaded from the memory M9. Then, in Step P56, the eighth correction value (count value of the counter) of the throw-on position of the squeegee is obtained from the type of the pigment of ink with the use of the table of conversion from the type of the pigment of ink to the throw-on position (count value of the counter) of the squeegee, and this correction value is stored into the memory M29.

Then, in Step P57, the table of conversion from the material for the squeegee to the throw-on position (count value of the counter) of the squeegee is loaded from the memory M30. Then, in Step P58, the material for the squeegee 38 is loaded from the memory M10. Then, in Step P59, the ninth correction value (count value of the counter) of the throw-on position of the squeegee is obtained from the material for the squeegee 38 with the use of the table of conversion from the material for the squeegee to the throw-on position (count value of the counter) of the squeegee, and this correction value is stored into the memory M31.

Then, in Step P60, the material for the squeegee 38 is loaded from the memory M10. Then, in Step P61, the table of conversion from the thickness of the squeegee to the throw-on position (count value of the counter) of the squeegee, which is commensurate with the material for the squeegee, is loaded from the memory M32.

Then, in Step P62, the thickness of the squeegee is loaded from the memory M11. Then, in Step P63, the tenth correction value (count value of the counter) of the throw-on position of the squeegee is obtained from the thickness of the squeegee with the use of the table of conversion from the thickness of the squeegee to the throw-on position (count value of the counter) of the squeegee, which is commensurate with the material for the squeegee, and this correction value is stored into the memory M33.

Then, in Step P64, the provisional reference throw-on position (count value of the counter) of the squeegee is loaded from the memory M13, whereafter, in Step P65, the first correction value (count value of the counter) of the throw-on position of the squeegee is loaded from the memory M15. Then, in Step P66, the second correction value (count value of the counter) of the throw-on position of the squeegee is loaded from the memory M17.

Then, in Step P67, the third correction value (count value of the counter) of the throw-on position of the squeegee is loaded from the memory M19, whereafter, in Step P68, the fourth correction value (count value of the counter) of the throw-on position of the squeegee is loaded from the memory M21. Then, in Step P69, the fifth correction value (count value of the counter) of the throw-on position of the squeegee is loaded from the memory M23.

Then, in Step P70, the sixth correction value (count value of the counter) of the throw-on position of the squeegee is loaded from the memory M25, whereafter, in Step P71, the seventh correction value (count value of the counter) of the throw-on position of the squeegee is loaded from the memory M27. Then, in Step P72, the eighth correction value (count value of the counter) of the throw-on position of the squeegee is loaded from the memory M29.

Then, in Step P73, the ninth correction value (count value of the counter) of the throw-on position of the squeegee is loaded from the memory M31, whereafter, in Step P74, the tenth correction value (count value of the counter) of the throw-on position of the squeegee is loaded from the memory M33.

Then, in Step P75, the first correction value (count value of the counter) of the throw-on position of the squeegee, the second correction value (count value of the counter) of the throw-on position of the squeegee, the third correction value (count value of the counter) of the throw-on position of the squeegee, the fourth correction value (count value of the counter) of the throw-on position of the squeegee, the fifth correction value (count value of the counter) of the throw-on position of the squeegee, the sixth correction value (count value of the counter) of the throw-on position of the squeegee, the seventh correction value (count value of the counter) of the throw-on position of the squeegee, the eighth correction value (count value of the counter) of the throw-on position of the squeegee, the ninth correction value (count value of the counter) of the throw-on position of the squeegee, and the tenth correction value (count value of the counter) of the throw-on position of the squeegee are added to the provisional reference throw-on position (count value of the counter) of the squeegee to compute the reference throw-on position (count value of the counter) of the squeegee, and this reference throw-on position (count value of the counter) of the squeegee is stored into the memory M34.

In accordance with the above-described motion flow, the throw-on position of the squeegee 38 during printing is preset, based on the type of the material W to be printed, in conformity with the thickness of the material to be printed, the material for the screen printing forme 11c, the thickness of the screen printing forme, the picture pattern area rate, the mesh size of the screen printing forme 11c, the viscosity of ink, the yield value of ink, the type of the pigment of ink, the material for the squeegee, and the thickness of the squeegee.

Then, in Step P76, the table of conversion from the material for the screen printing forme to the retreat position (count value of the counter) of the squeegee is loaded from the memory M35. Then, in Step P77, the material for the screen printing forme 11c is loaded from the memory M3. Then, in Step P78, the provisional reference retreat position (count value of the counter) of the squeegee is obtained from the material for the screen printing forme 11c with the use of the table of conversion from the material for the screen printing forme to the retreat position (count value of the counter) of the squeegee, and is stored into the memory M36.

Then, in Step P79, the material for the screen printing forme 11c is loaded from the memory M3. Then, in Step P80, the table of conversion from the thickness of the screen printing forme to the retreat position (count value of the counter) of the squeegee, which is commensurate with the material for the screen printing forme, is loaded from the memory M37.

Then, in Step P81, the thickness of the screen printing forme is loaded from the memory M4. Then, in Step P82, the first correction value (count value of the counter) of the retreat position of the squeegee is obtained from the thickness of the screen printing forme with the use of the table of conversion from the thickness of the screen printing forme to the retreat position (count value of the counter) of the squeegee, which is commensurate with the material for the screen printing forme, and this correction value is stored into the memory M38.

Then, in Step P83, the material for the screen printing forme 11c is loaded from the memory M3, whereafter, in Step P84, the thickness of the screen printing forme is loaded from the memory M4. Then, in Step P85, the table of conversion from the picture pattern area rate to the retreat position (count value of the counter) of the squeegee, which is commensurate with the material for the screen printing forme and the thickness of the screen printing forme, is loaded from the memory M39.

Then, in Step P86, the picture pattern area rate is loaded from the memory M5. Then, in Step P87, the second correction value (count value of the counter) of the retreat position of the squeegee is obtained from the picture pattern area rate with the use of the table of conversion from the picture pattern area rate to the retreat position (count value of the counter) of the squeegee, which is commensurate with the material for the screen printing forme and the thickness of the screen printing forme, and this correction value is stored into the memory M40.

Then, in Step P88, the material for the screen printing forme is loaded from the memory M3. Then, in Step P89, the thickness of the screen printing forme is loaded from the memory M4. Then, in Step P90, the table of conversion from the mesh size of the screen printing forme to the retreat position (count value of the counter) of the squeegee, which is commensurate with the material for the screen printing forme and the thickness of the screen printing forme, is loaded from the memory M41.

Then, in Step P91, the mesh size of the screen printing forme 11c is loaded from the memory M6. Then, in Step P92, the third correction value (count value of the counter) of the retreat position of the squeegee is obtained from the mesh size of the screen printing forme 11c with the use of the table of conversion from the mesh size of the screen printing forme to the retreat position (count value of the counter) of the squeegee, which is commensurate with the material for the screen printing forme and the thickness of the screen printing forme, and this correction value is stored into the memory M42.

Then, in Step P93, the table of conversion from the viscosity of ink to the retreat position (count value of the counter) of the squeegee is loaded from the memory M43. Then, in Step P94, the viscosity of ink is loaded from the memory M7. Then, in Step P95, the fourth correction value (count value of the counter) of the retreat position of the squeegee is obtained from the viscosity of ink with the use of the table of conversion from the viscosity of ink to the retreat position (count value of the counter) of the squeegee, and this correction value is stored into the memory M44.

Then, in Step P96, the table of conversion from the yield value of ink to the retreat position (count value of the counter) of the squeegee is loaded from the memory M45. Then, in Step P97, the yield value of ink is loaded from the memory M8. Then, in Step P98, the fifth correction value (count value of the counter) of the retreat position of the squeegee is obtained from the yield value of ink with the use of the table of conversion from the yield value of ink to the retreat position (count value of the counter) of the squeegee, and this correction value is stored into the memory M46.

Then, in Step P99, the table of conversion from the type of the pigment of ink to the retreat position (count value of the counter) of the squeegee is loaded from the memory M47. Then, in Step P100, the type of the pigment of ink is loaded from the memory M9. Then, in Step P101, the sixth correction value (count value of the counter) of the retreat position of the squeegee is obtained from the type of the pigment of ink with the use of the table of conversion from the type of the pigment of ink to the retreat position (count value of the counter) of the squeegee, and this correction value is stored into the memory M48.

Then, in Step P102, the table of conversion from the material for the squeegee to the retreat position (count value of the counter) of the squeegee is loaded from the memory M49. Then, in Step P103, the material for the squeegee is loaded from the memory M10. Then, in Step P104, the seventh correction value (count value of the counter) of the retreat position of the squeegee is obtained from the material for the squeegee with the use of the table of conversion from the material for the squeegee to the retreat position (count value of the counter) of the squeegee, and this correction value is stored into the memory M50.

Then, in Step P105, the material for the squeegee is loaded from the memory M10. Then, in Step P106, the table of conversion from the thickness of the squeegee to the retreat position (count value of the counter) of the squeegee, which is commensurate with the material for the squeegee, is loaded from the memory M51.

Then, in Step P107, the thickness of the squeegee is loaded from the memory M11. Then, in Step P108, the eighth correction value (count value of the counter) of the retreat position of the squeegee is obtained from the thickness of the squeegee with the use of the table of conversion from the thickness of the squeegee to the retreat position (count value of the counter) of the squeegee, which is commensurate with the material for the squeegee, and this correction value is stored into the memory M52.

Then, in Step P109, the provisional reference retreat position (count value of the counter) of the squeegee is loaded from the memory M36, whereafter, in Step P110, the first correction value (count value of the counter) of the retreat position of the squeegee is loaded from the memory M38. Then, in Step P111, the second correction value (count value of the counter) of the retreat position of the squeegee is loaded from the memory M40.

Then, in Step P112, the third correction value (count value of the counter) of the retreat position of the squeegee is loaded from the memory M42, whereafter, in Step P113, the fourth correction value (count value of the counter) of the retreat position of the squeegee is loaded from the memory M44. Then, in Step P114, the fifth correction value (count value of the counter) of the retreat position of the squeegee is loaded from the memory M46.

Then, in Step P115, the sixth correction value (count value of the counter) of the retreat position of the squeegee is loaded from the memory M48, whereafter, in Step P116, the seventh correction value (count value of the counter) of the retreat position of the squeegee is loaded from the memory M50. Then, in Step P117, the eighth correction value (count value of the counter) of the retreat position of the squeegee is loaded from the memory M52.

Then, in Step P118, the first correction value (count value of the counter) of the retreat position of the squeegee, the second correction value (count value of the counter) of the retreat position of the squeegee, the third correction value (count value of the counter) of the retreat position of the squeegee, the fourth correction value (count value of the counter) of the retreat position of the squeegee, the fifth correction value (count value of the counter) of the retreat position of the squeegee, the sixth correction value (count value of the counter) of the retreat position of the squeegee, the seventh correction value (count value of the counter) of the retreat position of the squeegee, and the eighth correction value (count value of the counter) of the retreat position of the squeegee are added to the provisional reference retreat position (count value of the counter) of the squeegee to compute the reference retreat position (count value of the counter) of the squeegee, and this reference retreat position (count value of the counter) of the squeegee is stored into the memory M53. The reference retreat position (count value of the counter) of the squeegee obtained is a position closer to the throw-off position of the squeegee than to the reference throw-on position of the squeegee obtained in Step P75, in other words, a position at which the leading end of the squeegee 38 does not leave the inner peripheral surface of the screen printing forme 11c, and its pressing force decreases.

In accordance with the above-described motion flow, the retreat position of the squeegee 38, when opposing the notch 13b of the impression cylinder 13, is preset, based on the material for the screen printing forme 11c, in conformity with the thickness of the screen printing forme, the picture pattern area rate, the mesh size of the screen printing forme 11c, the viscosity of ink, the yield value of ink, the type of the pigment of ink, the material for the squeegee, and the thickness of the squeegee.

Then, in Step P119, it is determined whether the squeegee throw-on and throw-off automatic control switch 52 is OFF. If the answer is Y (yes), the program shifts to Step P351 to be described later. If the answer is N (no), it is determined, in Step P120, whether a cylinder engagement signal from the cylinder engagement circuit 78 for the rotary screen cylinder is ON.

If the answer is Y in the above Step P120, the program shifts to Step P175 to be described later. If the answer is N, the throw-off position (count value of the counter) of the squeegee is loaded from the memory M54 in Step P121.

Then, in Step P122, the memory M55 for storing the desired count value of the counter for detecting the position of the left side of the squeegee is overwritten with the throw-off position (count value of the counter) of the squeegee. Then, in Step P123, the memory M56 for storing the desired count value of the counter for detecting the position of the right side of the squeegee is overwritten with the throw-off position (count value of the counter) of the squeegee.

Then, in Step P124, the count value is loaded from the counter 74 for detecting the rotation phase of the rotary screen cylinder, and stored into the memory M68. Then, in Step P125, the rotation phase of the rotary screen cylinder during squeegee throw-off is loaded from the memory M58.

Then, in Step P126, it is determined whether the count value of the counter for detecting the rotation phase of the rotary screen cylinder is equal to the rotation phase of the rotary screen cylinder during squeegee throw-off. If the answer is N, the program returns to Step P124 mentioned above. If the answer is Y, the count value S of the memory M59 is overwritten with 0 in Step P127.

Then, in Step P128, the memory M60 for storing the rotating direction of the motor for adjusting the left side is overwritten with 0. Then, in Step P129, the memory M61 for storing the rotating direction of the motor for adjusting the right side is overwritten with 0.

Then, in Step P130, the count value is loaded from the counter 68 for detecting the current position of the left side of the squeegee, and stored into the memory M62. Then, in Step P131, the desired count value of the counter for detecting the position of the left side of the squeegee is loaded from the memory M55.

Then, in Step P132, it is determined whether the count value of the counter for detecting the current position of the left side of the squeegee is equal to the desired count value of the counter for detecting the position of the left side of the squeegee. If the answer is N, it is determined, in Step P133, whether the count value of the counter for detecting the current position of the left side of the squeegee is less than the desired count value of the counter for detecting the position of the left side of the squeegee.

If the answer is Y in the above Step P133, the memory M60 for storing the rotating direction of the motor for adjusting the left side is overwritten with 1 in Step P134. Then, in Step P135, a normal rotation command is outputted to the driver 66 for the motor for adjusting the left side, whereafter the program proceeds to Step P136. If the answer is N in Step P133, the memory M60 for storing the rotating direction of the motor for adjusting the left side is overwritten with 2 in Step P137. Then, in Step P138, a reverse rotation command is outputted to the driver 66 for the motor for adjusting the left side, whereafter the program shifts to Step P136.

If the answer is Y in the aforementioned Step P132, the count value S is loaded from the memory M59. Then, in Step P140, 1 is added to the count value S of the memory M59 for overwriting, whereafter the program shifts to Step P136 mentioned above.

Then, in the aforementioned Step P136, the count value is loaded from the counter 72 for detecting the current position of the right side of the squeegee, and stored into the memory M63. Then, in Step P141, the desired count value of the counter for detecting the position of the right side of the squeegee is loaded from the memory M56.

Then, in Step P142, it is determined whether the count value of the counter for detecting the current position of the right side of the squeegee is equal to the desired count value of the counter for detecting the position of the right side of the squeegee. If the answer is N, it is determined, in Step P143, whether the count value of the counter for detecting the current position of the right side of the squeegee is less than the desired count value of the counter for detecting the position of the right side of the squeegee.

If the answer is Y in the above Step P143, the memory M61 for storing the rotating direction of the motor for adjusting the right side is overwritten with 1 in Step P144. Then, in Step P145, a normal rotation command is outputted to the driver 70 for the motor for adjusting the right side, whereafter the program proceeds to Step P146. If the answer is N in Step P143, the memory M61 for storing the rotating direction of the motor for adjusting the right side is overwritten with 2 in Step P147. Then, in Step P148, a reverse rotation command is outputted to the driver 70 for the motor for adjusting the right side, whereafter the program shifts to Step P146.

If the answer is Y in the aforementioned Step P142, the count value S is loaded from the memory M59 in Step P149. Then, in Step P150, 1 is added to the count value S of the memory M59 for overwriting, whereafter the program shifts to Step P146 mentioned above.

Then, in Step P146 mentioned above, the count value S is loaded from the memory M59, whereafter it is determined in Step P151 whether the count value S is 2. If the answer is Y, outputting of the enabling signal to the counter 76 for counting the total number of revolutions during squeegee throw-on is stopped in Step P152, and the program returns to Step P119 mentioned earlier.

Then, in Step P153, the count value is loaded from the counter 68 for detecting the current position of the left side of the squeegee, and stored into the memory M62. Then, in Step P154, the desired count value of the counter for detecting the position of the left side of the squeegee is loaded from the memory M55.

Then, in Step P155, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P156. If the answer is N, the program shifts to Step P164 to be described later.

Then, in Step P157, it is determined whether the value of the memory for storing the rotating direction of the motor for adjusting the left side is 1. If the answer is Y, outputting of the normal rotation command to the driver 66 for the motor for adjusting the left side is stopped in Step P158, and the program proceeds to Step P159. If the answer is N, it is determined in Step P160 whether the value of the memory for storing the rotating direction of the motor for adjusting the left side is 2.

If the answer is Y in the above Step P160, outputting of the reverse rotation command to the driver 66 for the motor for adjusting the left side is stopped in Step P161, and the program shifts to the aforementioned Step P159. If the answer is N, the program shifts to the aforementioned Step P164.

Then, in the above-mentioned Step P159, the memory M60 for storing the rotating direction of the motor for adjusting the left side is overwritten with 0. Then, in Step P162, the count value S is loaded from the memory M59, whereafter 1 is added to the count value S of the memory M59 for overwriting in Step P163.

Then, in Step P164, the count value is loaded from the counter 72 for detecting the current position of the right side of the squeegee, and stored into the memory M63. Then, in Step P165, the desired count value of the counter for detecting the position of the right side of the squeegee is loaded from the memory M56.

Then, in Step P166, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P167. If the answer is N, the program returns to Step P146.

Then, in Step P168, it is determined whether the value of the memory for storing the rotating direction of the motor for adjusting the right side is 1. If the answer is Y, outputting of the normal rotation command to the driver 70 for the motor for adjusting the right side is stopped in Step P169, and the program proceeds to Step P170. If the answer is N, it is determined in Step P171 whether the value of the memory for storing the rotating direction of the motor for adjusting the right side is 2.

If the answer is Y in the above Step P171, outputting of the reverse rotation command to the driver 70 for the motor for adjusting the right side is stopped in Step P172, and the program shifts to the aforementioned Step P170. If the answer is N, the program returns to Step P146.

Then, in the aforementioned Step P170, the memory M61 for storing the rotating direction of the motor for adjusting the right side is overwritten with 0. Then, in Step P173, the count value S is loaded from the memory M59, whereafter 1 is added to the count value S of the memory M59 for overwriting in Step P174. Then, the program returns to Step P146.

In accordance with the above-described motion flow, when the squeegee throw-on and throw-off automatic control switch 52 is ON and the cylinder engagement signal for the rotary screen cylinder 11 is OFF, the squeegee 38 is moved to the throw-off position.

Then, in Step P175 shifted from the aforementioned Step P120, the table of conversion from the total number of revolutions during squeegee throw-onto the correction amount (count value of the counter) of the squeegee position is loaded from the memory M64. Then, in Step P176, the count value is loaded from the counter 76 for counting the total number of revolutions during squeegee throw-on, and stored into the memory M65.

Then, in Step P177, the correction amount (count value of the counter) of the squeegee position is obtained from the count value of the counter 76 for counting the total number of revolutions during squeegee throw-on, with the use of the table of conversion from the total number of revolutions during squeegee throw-on to the correction amount (count value of the counter) of the squeegee position, and this correction amount is stored into the memory M66. Then, in Step P178, the reference retreat position (count value of the counter) of the squeegee is loaded from the memory M53.

Then, in Step P179, the correction amount (count value of the counter) of the squeegee position is loaded from the memory M66. Then, in Step P180, the correction amount (count value of the counter) of the squeegee position is added to the reference retreat position (count value of the counter) of the squeegee to compute the retreat position (count value of the counter) of the squeegee, which is stored into the memory M67.

Then, in Step P181, the memory M55 for storing the desired count value of the counter for detecting the position of the left side of the squeegee is overwritten with the retreat position (count value of the counter) of the squeegee. Then, in Step P182, the memory M56 for storing the desired count value of the counter for detecting the position of the right side of the squeegee is overwritten with the retreat position (count value of the counter) of the squeegee.

Then, in Step P183, the count value is loaded from the counter 74 for detecting the rotation phase of the rotary screen cylinder, and stored into the memory M68. Then, in Step P184, the rotation phase of the rotary screen cylinder during squeegee throw-on is loaded from the memory M69.

Then, in Step P185, it is determined whether the count value of the counter for detecting the rotation phase of the rotary screen cylinder is equal to the rotation phase of the rotary screen cylinder during squeegee throw-on. If the answer is N, the program returns to Step P183 mentioned above. If the answer is Y, the count value S of the memory M59 is overwritten with 0 in Step P186. Then, in Step P187, the memory M60 for storing the rotating direction of the motor for adjusting the left side is overwritten with 0. Then, in Step P188, the memory M61 for storing the rotating direction of the motor for adjusting the right side is overwritten with 0.

Then, in Step P189, the count value is loaded from the counter 68 for detecting the current position of the left side of the squeegee, and stored into the memory M62. Then, in Step P190, the desired count value of the counter for detecting the position of the left side of the squeegee is loaded from the memory M55.

Then, in Step P191, it is determined whether the count value of the counter for detecting the current position of the left side of the squeegee is equal to the desired count value of the counter for detecting the position of the left side of the squeegee. If the answer is N, it is determined, in Step P192, whether the count value of the counter for detecting the current position of the left side of the squeegee is less than the desired count value of the counter for detecting the position of the left side of the squeegee.

If the answer is Y in the above Step P192, the memory M60 for storing the rotating direction of the motor for adjusting the left side is overwritten with 1 in Step P193. Then, in Step P194, a normal rotation command is outputted to the driver 66 for the motor for adjusting the left side, whereafter the program proceeds to Step P195. If the answer is N in Step P192, the memory M60 for storing the rotating direction of the motor for adjusting the left side is overwritten with 2 in Step P196. Then, in Step P197, a reverse rotation command is outputted to the driver 66 for the motor for adjusting the left side, whereafter the program shifts to the aforementioned Step P195.

If the answer is Y in Step P191, the count value S is loaded from the memory M59 in Step P198. Then, in Step P199, 1 is added to the count value S of the memory M59 for overwriting, whereafter the program shifts to Step P195 mentioned above.

Then, in the aforementioned Step P195, the count value is loaded from the counter 72 for detecting the current position of the right side of the squeegee, and stored into the memory M63. Then, in Step P200, the desired count value of the counter for detecting the position of the right side of the squeegee is loaded from the memory M56.

Then, in Step P201, it is determined whether the count value of the counter for detecting the current position of the right side of the squeegee is equal to the desired count value of the counter for detecting the position of the right side of the squeegee. If the answer is N, it is determined, in Step P202, whether the count value of the counter for detecting the current position of the right side of the squeegee is less than the desired count value of the counter for detecting the position of the right side of the squeegee.

If the answer is Y in the above Step P202, the memory M61 for storing the rotating direction of the motor for adjusting the right side is overwritten with 1 in Step P203. Then, in Step P204, a normal rotation command is outputted to the driver 70 for the motor for adjusting the right side, whereafter the program proceeds to Step P205. If the answer is N in Step P202, the memory M61 for storing the rotating direction of the motor for adjusting the right side is overwritten with 2 in Step P206. Then, in Step P207, a reverse rotation command is outputted to the driver 70 for the motor for adjusting the right side, whereafter the program shifts to Step P205.

If the answer is Y in the aforementioned Step P201, the count value S is loaded from the memory M59 in Step P208. Then, in Step P209, 1 is added to the count value S of the memory M59 for overwriting, whereafter the program shifts to Step P205 mentioned above.

Then, in Step P205 mentioned above, the count value S is loaded from the memory M59, whereafter it is determined in Step P210 whether the count value S is 2. If the answer is Y, an enabling signal is outputted in Step P211 to the counter 76 for counting the total number of revolutions during squeegee throw-on, and the program shifts to Step P234 to be described later.

If the answer is N in the above-mentioned Step P210, the count value is loaded from the counter 68 for detecting the current position of the left side of the squeegee, and stored into the memory M62, in Step P212. Then, in Step P213, the desired count value of the counter for detecting the position of the left side of the squeegee is loaded from the memory M55.

Then, in Step P214, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P215. If the answer is N, the program shifts to Step P223 to be described later.

Then, in Step P216, it is determined whether the value of the memory for storing the rotating direction of the motor for adjusting the left side is 1. If the answer is Y, outputting of the normal rotation command to the driver 66 for the motor for adjusting the left side is stopped in Step P217, and the program proceeds to Step P218. If the answer is N, it is determined in Step P219 whether the value of the memory for storing the rotating direction of the motor for adjusting the left side is 2.

If the answer is Y in the above Step P219, outputting of the reverse rotation command to the driver 66 for the motor for adjusting the left side is stopped in Step P220, and the program shifts to the aforementioned Step P218. If the answer is N, the program shifts to the aforementioned Step P223.

Then, in the above-mentioned Step P218, the memory M60 for storing the rotating direction of the motor for adjusting the left side is overwritten with 0. Then, in Step P221, the count value S is loaded from the memory M59, whereafter 1 is added to the count value S of the memory M59 for overwriting in Step P222.

Then, in Step P223, the count value is loaded from the counter 72 for detecting the current position of the right side of the squeegee, and stored into the memory M63. Then, in Step P224, the desired count value of the counter for detecting the position of the right side of the squeegee is loaded from the memory M56.

Then, in Step P225, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P226. If the answer is N, the program returns to Step P205.

Then, in Step P227, it is determined whether the value of the memory for storing the rotating direction of the motor for adjusting the right side is 1. If the answer is Y, outputting of the normal rotation command to the driver 70 for the motor for adjusting the right side is stopped in Step P228, and the program proceeds to Step P229. If the answer is N, it is determined in Step P230 whether the value of the memory for storing the rotating direction of the motor for adjusting the right side is 2.

If the answer is Y in the above Step P230, outputting of the reverse rotation command to the driver 70 for the motor for adjusting the right side is stopped in Step P231, and the program shifts to the aforementioned Step P229. If the answer is N, the program returns to Step P205.

Then, in the aforementioned Step P229, the memory M61 for storing the rotating direction of the motor for adjusting the right side is overwritten with 0. Then, in Step P232, the count value S is loaded from the memory M59, whereafter 1 is added to the count value S of the memory M59 for overwriting in Step P233. Then, the program returns to Step P205.

In accordance with the above-described motion flow, when the squeegee throw-on and throw-off automatic control switch 52 is ON and the cylinder engagement signal for the rotary screen cylinder 11 is ON, the squeegee 38 is moved to the predetermined retreat position when it opposes the notch 13b of the impression cylinder 13.

Then, in Step P234 shifted from the aforementioned Step P211, the table of conversion from the total number of revolutions during squeegee throw-onto the correction amount (count value of the counter) of the squeegee position is loaded from the memory M64. Then, in Step P235, the count value is loaded from the counter 76 for counting the total number of revolutions during squeegee throw-on, and stored into the memory M65.

Then, in Step P236, the correction amount (count value of the counter) of the squeegee position is obtained from the count value of the counter 76 for counting the total number of revolutions during squeegee throw-on, with the use of the table of conversion from the total number of revolutions during squeegee throw-on to the correction amount (count value of the counter) of the squeegee position, and this correction amount is stored into the memory M66. Then, in Step P237, the reference throw-on position (count value of the counter) of the squeegee is loaded from the memory M34.

Then, in Step P238, the correction amount (count value of the counter) of the squeegee position is loaded from the memory M66. Then, in Step P239, the correction amount (count value of the counter) of the squeegee position is added to the reference throw-on position (count value of the counter) of the squeegee to compute the printing position (count value of the counter) of the squeegee, which is stored into the memory M70.

Then, in Step P240, the memory M55 for storing the desired count value of the counter for detecting the position of the left side of the squeegee is overwritten with the printing position (count value of the counter) of the squeegee. Then, in Step P241, the memory M56 for storing the desired count value of the counter for detecting the position of the right side of the squeegee is overwritten with the printing position (count value of the counter) of the squeegee.

Then, in Step P242, the count value is loaded from the counter 74 for detecting the rotation phase of the rotary screen cylinder, and stored into the memory M68. Then, in Step P243, the rotation phase of the rotary screen cylinder at the position of the rear end of the notch of the impression cylinder is loaded from the memory M57.

Then, in Step P244, it is determined whether the count value of the counter for detecting the rotation phase of the rotary screen cylinder is equal to the rotation phase of the rotary screen cylinder at the position of the rear end of the notch of the impression cylinder. If the answer is N, the program returns to Step P242 mentioned above. If the answer is Y, the count value S of the memory M59 is overwritten with 0 in Step P245. Then, in Step P246, the memory M60 for storing the rotating direction of the motor for adjusting the left side is overwritten with 0. Then, in Step P247, the memory M61 for storing the rotating direction of the motor for adjusting the right side is overwritten with 0.

Then, in Step P248, the count value is loaded from the counter 68 for detecting the current position of the left side of the squeegee, and stored into the memory M62. Then, in Step P249, the desired count value of the counter for detecting the position of the left side of the squeegee is loaded from the memory M55.

Then, in Step P250, it is determined whether the count value of the counter for detecting the current position of the left side of the squeegee is equal to the desired count value of the counter for detecting the position of the left side of the squeegee. If the answer is N, it is determined, in Step P251, whether the count value of the counter for detecting the current position of the left side of the squeegee is less than the desired count value of the counter for detecting the position of the left side of the squeegee.

If the answer is Y in the above Step P251, the memory M60 for storing the rotating direction of the motor for adjusting the left side is overwritten with 1 in Step P252. Then, in Step P253, a normal rotation command is outputted to the driver 66 for the motor for adjusting the left side, whereafter the program proceeds to Step P254. If the answer is N in Step P251, the memory M60 for storing the rotating direction of the motor for adjusting the left side is overwritten with 2 in Step P255. Then, in Step P256, a reverse rotation command is outputted to the driver 66 for the motor for adjusting the left side, whereafter the program shifts to the aforementioned Step P254.

If the answer is Y in the aforementioned Step P250, the count value S is loaded from the memory M59 in Step P257. Then, in Step P258, 1 is added to the count value S of the memory M59 for overwriting, whereafter the program shifts to Step P254 mentioned above.

Then, in the aforementioned Step P254, the count value is loaded from the counter 72 for detecting the current position of the right side of the squeegee, and stored into the memory M63. Then, in Step P259, the desired count value of the counter for detecting the position of the right side of the squeegee is loaded from the memory M56.

Then, in Step P260, it is determined whether the count value of the counter for detecting the current position of the right side of the squeegee is equal to the desired count value of the counter for detecting the position of the right side of the squeegee. If the answer is N, it is determined, in Step P261, whether the count value of the counter for detecting the current position of the right side of the squeegee is less than the desired count value of the counter for detecting the position of the right side of the squeegee.

If the answer is Y in the above Step P261, the memory M61 for storing the rotating direction of the motor for adjusting the right side is overwritten with 1 in Step P262. Then, in Step P263, a normal rotation command is outputted to the driver 70 for the motor for adjusting the right side, whereafter the program proceeds to Step P264. If the answer is N in Step P261, the memory M61 for storing the rotating direction of the motor for adjusting the right side is overwritten with 2 in Step P265. Then, in Step P266, a reverse rotation command is outputted to the driver 70 for the motor for adjusting the right side, whereafter the program shifts to Step P264.

If the answer is Y in the aforementioned Step P260, the count value S is loaded from the memory M59 in Step P267. Then, in Step P268, 1 is added to the count value S of the memory M59 for overwriting, whereafter the program shifts to Step P264 mentioned above.

Then, in Step P264 mentioned above, the count value S is loaded from the memory M59, whereafter it is determined in Step P269 whether the count value S is 2. If the answer is Y, the program shifts to Step P292 to be described later.

If the answer is N in the above-mentioned Step P269, the count value is loaded from the counter 68 for detecting the current position of the left side of the squeegee, and stored into the memory M62, in Step P270. Then, in Step P271, the desired count value of the counter for detecting the position of the left side of the squeegee is loaded from the memory M55.

Then, in Step P272, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P273. If the answer is N, the program shifts to Step P281 to be described later.

Then, in Step P274, it is determined whether the value of the memory for storing the rotating direction of the motor for adjusting the left side is 1. If the answer is Y, outputting of the normal rotation command to the driver 66 for the motor for adjusting the left side is stopped in Step P275, and the program proceeds to Step P276. If the answer is N, it is determined in Step P277 whether the value of the memory for storing the rotating direction of the motor for adjusting the left side is 2.

If the answer is Y in the above Step P277, outputting of the reverse rotation command to the driver 66 for the motor for adjusting the left side is stopped in Step P278, and the program shifts to the aforementioned Step P276. If the answer is N, the program shifts to the aforementioned Step P281.

Then, in the above-mentioned Step P276, the memory M60 for storing the rotating direction of the motor for adjusting the left side is overwritten with 0. Then, in Step P279, the count value S is loaded from the memory M59, whereafter 1 is added to the count value S of the memory M59 for overwriting in Step P280.

Then, in Step P281, the count value is loaded from the counter 72 for detecting the current position of the right side of the squeegee, and stored into the memory M63. Then, in Step P282, the desired count value of the counter for detecting the position of the right side of the squeegee is loaded from the memory M56.

Then, in Step P283, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P284. If the answer is N, the program returns to Step P264.

Then, in Step P285, it is determined whether the value of the memory for storing the rotating direction of the motor for adjusting the right side is 1. If the answer is Y, outputting of the normal rotation command to the driver 70 for the motor for adjusting the right side is stopped in Step P286, and the program proceeds to Step P287. If the answer is N, it is determined in Step P288 whether the value of the memory for storing the rotating direction of the motor for adjusting the right side is 2.

If the answer is Y in the above Step P288, outputting of the reverse rotation command to the driver 70 for the motor for adjusting the right side is stopped in Step P289, and the program shifts to the aforementioned Step P287. If the answer is N, the program returns to Step P264.

Then, in the aforementioned Step P287, the memory M61 for storing the rotating direction of the motor for adjusting the right side is overwritten with 0. Then, in Step P290, the count value S is loaded from the memory M59, whereafter 1 is added to the count value S of the memory M59 for overwriting in Step P291. Then, the program returns to Step P264.

In accordance with the above-described motion flow, when the squeegee throw-on and throw-off automatic control switch 52 is ON and the cylinder engagement signal for the rotary screen cylinder 11 is ON, the squeegee 38 is moved to the predetermined printing position when it enters the rotation phase of the rotary screen cylinder 11 corresponding to the position of the rear end of the notch of the impression cylinder 13.

Then, in Step P292 shifted from the aforementioned Step P269, the table of conversion from the total number of revolutions during squeegee throw-onto the correction amount (count value of the counter) of the squeegee position is loaded from the memory M64. Then, in Step P293, the count value is loaded from the counter 76 for counting the total number of revolutions during squeegee throw-on, and stored into the memory M65.

Then, in Step P294, the correction amount (count value of the counter) of the squeegee position is obtained from the count value of the counter 76 for counting the total number of revolutions during squeegee throw-on, with the use of the table of conversion from the total number of revolutions during squeegee throw-on to the correction amount (count value of the counter) of the squeegee position, and this correction amount is stored into the memory M66. Then, in Step P295, the reference retreat position (count value of the counter) of the squeegee is loaded from the memory M53.

Then, in Step P296, the correction amount (count value of the counter) of the squeegee position is loaded from the memory M66. Then, in Step P297, the correction amount (count value of the counter) of the squeegee position is added to the reference retreat position (count value of the counter) of the squeegee to compute the retreat position (count value of the counter) of the squeegee, which is stored into the memory M67.

Then, in Step P298, the memory M55 for storing the desired count value of the counter for detecting the position of the left side of the squeegee is overwritten with the retreat position (count value of the counter) of the squeegee. Then, in Step P299, the memory M56 for storing the desired count value of the counter for detecting the position of the right side of the squeegee is overwritten with the retreat position (count value of the counter) of the squeegee.

Then, in Step P300, the count value is loaded from the counter 74 for detecting the rotation phase of the rotary screen cylinder, and stored into the memory M68. Then, in Step P301, the rotation phase of the rotary screen cylinder at the position of the leading end of the notch of the impression cylinder is loaded from the memory M71.

Then, in Step P302, it is determined whether the count value of the counter for detecting the rotation phase of the rotary screen cylinder is equal to the rotation phase of the rotary screen cylinder at the position of the leading end of the notch of the impression cylinder. If the answer is N, the program returns to Step P300 mentioned above. If the answer is Y, the count value S of the memory M59 is overwritten with 0 in Step P303. Then, in Step P304, the memory M60 for storing the rotating direction of the motor for adjusting the left side is overwritten with 0. Then, in Step P305, the memory M61 for storing the rotating direction of the motor for adjusting the right side is overwritten with 0.

Then, in Step P306, the count value is loaded from the counter 68 for detecting the current position of the left side of the squeegee, and stored into the memory M62. Then, in Step P307, the desired count value of the counter for detecting the position of the left side of the squeegee is loaded from the memory M55.

Then, in Step P308, it is determined whether the count value of the counter for detecting the current position of the left side of the squeegee is equal to the desired count value of the counter for detecting the position of the left side of the squeegee. If the answer is N, it is determined, in Step P309, whether the count value of the counter for detecting the current position of the left side of the squeegee is less than the desired count value of the counter for detecting the position of the left side of the squeegee.

If the answer is Y in the above Step P309, the memory M60 for storing the rotating direction of the motor for adjusting the left side is overwritten with 1 in Step P310. Then, in Step P311, a normal rotation command is outputted to the driver 66 for the motor for adjusting the left side, whereafter the program proceeds to Step P312. If the answer is N in Step P309, the memory M60 for storing the rotating direction of the motor for adjusting the left side is overwritten with 2 in Step P313. Then, in Step P314, a reverse rotation command is outputted to the driver 66 for the motor for adjusting the left side, whereafter the program shifts to the aforementioned Step P312.

If the answer is Y in the aforementioned Step P308, the count value S is loaded from the memory M59 in Step P315. Then, in Step P316, 1 is added to the count value S of the memory M59 for overwriting, whereafter the program shifts to Step P312 mentioned above.

Then, in the aforementioned Step P312, the count value is loaded from the counter 72 for detecting the current position of the right side of the squeegee, and stored into the memory M63. Then, in Step P317, the desired count value of the counter for detecting the position of the right side of the squeegee is loaded from the memory M56.

Then, in Step P318, it is determined whether the count value of the counter for detecting the current position of the right side of the squeegee is equal to the desired count value of the counter for detecting the position of the right side of the squeegee. If the answer is N, it is determined, in Step P319, whether the count value of the counter for detecting the current position of the right side of the squeegee is less than the desired count value of the counter for detecting the position of the right side of the squeegee.

If the answer is Y in the above Step P319, the memory M61 for storing the rotating direction of the motor for adjusting the right side is overwritten with 1 in Step P320. Then, in Step P321, a normal rotation command is outputted to the driver 70 for the motor for adjusting the right side, whereafter the program proceeds to Step P322. If the answer is N in Step P319, the memory M61 for storing the rotating direction of the motor for adjusting the right side is overwritten with 2 in Step P323. Then, in Step P324, a reverse rotation command is outputted to the driver 70 for the motor for adjusting the right side, whereafter the program shifts to the aforementioned Step P322.

If the answer is Y in the aforementioned Step P318, the count value S is loaded from the memory M59 in Step P325. Then, in Step P326, 1 is added to the count value S of the memory M59 for overwriting, whereafter the program shifts to Step P322 mentioned above.

Then, in Step P322 mentioned above, the count value S is loaded from the memory M59, whereafter it is determined in Step P327 whether the count value S is 2. If the answer is Y in this Step P327, it is determined in Step P328 whether the cylinder engagement signal for the rotary screen cylinder is ON. If the answer is Y in this step, the program returns to the aforementioned Step P234. If the answer is N, the program returns to the aforementioned Step P121.

If the answer is N in the above-mentioned Step P327, the count value is loaded from the counter 68 for detecting the current position of the left side of the squeegee, and stored into the memory M62, in Step P329. Then, in Step P330, the desired count value of the counter for detecting the position of the left side of the squeegee is loaded from the memory M55.

Then, in Step P331, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P332. If the answer is N, the program shifts to Step P340 to be described later.

Then, in Step P333, it is determined whether the value of the memory for storing the rotating direction of the motor for adjusting the left side is 1. If the answer is Y, outputting of the normal rotation command to the driver 66 for the motor for adjusting the left side is stopped in Step P334, and the program proceeds to Step P335. If the answer is N, it is determined in Step P336 whether the value of the memory for storing the rotating direction of the motor for adjusting the left side is 2.

If the answer is Y in the above Step P336, outputting of the reverse rotation command to the driver 66 for the motor for adjusting the left side is stopped in Step P337, and the program shifts to the aforementioned Step P335. If the answer is N, the program shifts to the aforementioned Step P340.

Then, in the aforementioned Step P335, the memory M60 for storing the rotating direction of the motor for adjusting the left side is overwritten with 0. Then, in Step P338, the count value S is loaded from the memory M59, whereafter 1 is added to the count value S of the memory M59 for overwriting in Step P339.

Then, in Step P340, the count value is loaded from the counter 72 for detecting the current position of the right side of the squeegee, and stored into the memory M63. Then, in Step P341, the desired count value of the counter for detecting the position of the right side of the squeegee is loaded from the memory M56.

Then, in Step P342, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P343. If the answer is N, the program returns to Step P322.

Then, in Step P344, it is determined whether the value of the memory for storing the rotating direction of the motor for adjusting the right side is 1. If the answer is Y, outputting of the normal rotation command to the driver 70 for the motor for adjusting the right side is stopped in Step P345, and the program proceeds to Step P346. If the answer is N, it is determined in Step P347 whether the value of the memory for storing the rotating direction of the motor for adjusting the right side is 2.

If the answer is Y in the above Step P347, outputting of the reverse rotation command to the driver 70 for the motor for adjusting the right side is stopped in Step P348, and the program shifts to the aforementioned Step P346. If the answer is N, the program returns to Step P322.

Then, in the aforementioned Step P346, the memory M61 for storing the rotating direction of the motor for adjusting the right side is overwritten with 0. Then, in Step P349, the count value S is loaded from the memory M59, whereafter 1 is added to the count value S of the memory M59 for overwriting in Step P350. Then, the program returns to Step P322.

In accordance with the above-described motion flow, when the squeegee throw-on and throw-off automatic control switch 52 is ON and the cylinder engagement signal for the rotary screen cylinder 11 is ON, the squeegee 38 is moved to the predetermined retreat position when it enters the rotation phase of the rotary screen cylinder 11 corresponding to the position of the leading end of the notch of the impression cylinder 13.

Then, in Step P351 shifted from the aforementioned Step P119, the throw-off position (count value of the counter) of the squeegee is loaded from the memory M54.

Then, in Step P352, the memory M55 for storing the desired count value of the counter for detecting the position of the left side of the squeegee is overwritten with the throw-off position (count value of the counter) of the squeegee. Then, in Step P353, the memory M56 for storing the desired count value of the counter for detecting the position of the right side of the squeegee is overwritten with the throw-off position (count value of the counter) of the squeegee.

Then, in Step P354, the count value S of the memory M59 is overwritten with 0, whereafter the memory M60 for storing the rotating direction of the motor for adjusting the left side is overwritten with 0 in Step P355. Then, in Step P356, the memory M61 for storing the rotating direction of the motor for adjusting the right side is overwritten with 0.

Then, in Step P357, the count value is loaded from the counter 74 for detecting the rotation phase of the rotary screen cylinder, and stored into the memory M68. Then, in Step P358, the rotation phase of the rotary screen cylinder during squeegee throw-off is loaded from the memory M58.

Then, in Step P359, it is determined whether the count value of the counter for detecting the rotation phase of the rotary screen cylinder is equal to the rotation phase of the rotary screen cylinder during squeegee throw-off. If the answer is N, the program returns to Step P357 mentioned above. If the answer is Y, the count value is loaded from the counter 68 for detecting the current position of the left side of the squeegee, and stored into the memory M62, in Step P360. Then, in Step P361, the desired count value of the counter for detecting the position of the left side of the squeegee is loaded from the memory M55.

Then, in Step P362, it is determined whether the count value of the counter for detecting the current position of the left side of the squeegee is equal to the desired count value of the counter for detecting the position of the left side of the squeegee. If the answer is N, it is determined, in Step P363, whether the count value of the counter for detecting the current position of the left side of the squeegee is less than the desired count value of the counter for detecting the position of the left side of the squeegee.

If the answer is Y in the above Step P363, the memory M60 for storing the rotating direction of the motor for adjusting the left side is overwritten with 1 in Step P364. Then, in Step P365, a normal rotation command is outputted to the driver 66 for the motor for adjusting the left side, whereafter the program proceeds to Step P366. If the answer is N in Step P363, the memory M60 for storing the rotating direction of the motor for adjusting the left side is overwritten with 2 in Step P367. Then, in Step P368, a reverse rotation command is outputted to the driver 66 for the motor for adjusting the left side, whereafter the program shifts to the aforementioned Step P366.

If the answer is Y in the aforementioned Step P362, the count value S is loaded from the memory M59 in Step P369. Then, in Step P370, 1 is added to the count value S of the memory M59 for overwriting, whereafter the program shifts to Step P366 mentioned above.

Then, in the aforementioned Step P366, the count value is loaded from the counter 72 for detecting the current position of the right side of the squeegee, and stored into the memory M63. Then, in Step P371, the desired count value of the counter for detecting the position of the right side of the squeegee is loaded from the memory M56.

Then, in Step P372, it is determined whether the count value of the counter for detecting the current position of the right side of the squeegee is equal to the desired count value of the counter for detecting the position of the right side of the squeegee. If the answer is N, it is determined, in Step P373, whether the count value of the counter for detecting the current position of the right side of the squeegee is less than the desired count value of the counter for detecting the position of the right side of the squeegee.

If the answer is Y in the above Step P373, the memory M61 for storing the rotating direction of the motor for adjusting the right side is overwritten with 1 in Step P374. Then, in Step P375, a normal rotation command is outputted to the driver 70 for the motor for adjusting the right side, whereafter the program proceeds to Step P376. If the answer is N in Step P373, the memory M61 for storing the rotating direction of the motor for adjusting the right side is overwritten with 2 in Step P377. Then, in Step P378, a reverse rotation command is outputted to the driver 70 for the motor for adjusting the right side, whereafter the program shifts to the aforementioned Step P376.

If the answer is Y in the aforementioned Step P372, the count value S is loaded from the memory M59 in Step P379. Then, in Step P380, 1 is added to the count value S of the memory M59 for overwriting, whereafter the program shifts to Step P376 mentioned above.

Then, in Step P376 mentioned above, the count value S is loaded from the memory M59, whereafter it is determined in Step P381 whether the count value S is 2. If the answer is Y in this Step P381, outputting of the enabling signal to the counter 76 for counting the total number of revolutions during squeegee throw-on is stopped in Step P382, and the program returns to Step P1.

Then, in Step P383, the count value is loaded from the counter 68 for detecting the current position of the left side of the squeegee, and stored into the memory M62. Then, in Step P384, the desired count value of the counter for detecting the position of the left side of the squeegee is loaded from the memory M55.

Then, in Step P385, it is determined whether the count value of the counter for detecting the current position of the left side of the squeegee is equal to the desired count value of the counter for detecting the position of the left side of the squeegee. If the answer is Y, the value of the memory M60 for storing the rotating direction of the motor for adjusting the left side is loaded in Step P386. If the answer is N, the program shifts to Step P394 to be described later.

Then, in Step P387, it is determined whether the value of the memory for storing the rotating direction of the motor for adjusting the left side is 1. If the answer is Y, outputting of the normal rotation command to the driver 66 for the motor for adjusting the left side is stopped in Step P388, and the program proceeds to Step P389. If the answer is N, it is determined in Step P390 whether the value of the memory for storing the rotating direction of the motor for adjusting the left side is 2.

If the answer is Y in the above Step P390, outputting of the reverse rotation command to the driver 66 for the motor for adjusting the left side is stopped in Step P391, and the program shifts to the aforementioned Step P389. If the answer is N, the program shifts to the aforementioned Step P394.

Then, in the aforementioned Step P389, the memory M60 for storing the rotating direction of the motor for adjusting the left side is overwritten with 0. Then, in Step P392, the count value S is loaded from the memory M59, whereafter 1 is added to the count value S of the memory M59 for overwriting in Step P393.

Then, in Step P394, the count value is loaded from the counter 72 for detecting the current position of the right side of the squeegee, and stored into the memory M63. Then, in Step P395, the desired count value of the counter for detecting the position of the right side of the squeegee is loaded from the memory M56.

Then, in Step P396, it is determined whether the count value of the counter for detecting the current position of the right side of the squeegee is equal to the desired count value of the counter for detecting the position of the right side of the squeegee. If the answer is Y, the value of the memory M61 for storing the rotating direction of the motor for adjusting the right side is loaded in Step P397. If the answer is N, the program returns to Step P376.

Then, in Step P398, it is determined whether the value of the memory for storing the rotating direction of the motor for adjusting the right side is 1. If the answer is Y, outputting of the normal rotation command to the driver 70 for the motor for adjusting the right side is stopped in Step P399, and the program proceeds to Step P400. If the answer is N, it is determined in Step P401 whether the value of the memory for storing the rotating direction of the motor for adjusting the right side is 2.

If the answer is Y in the above Step P401, outputting of the reverse rotation command to the driver 70 for the motor for adjusting the right side is stopped in Step P402, and the program shifts to the aforementioned Step P400. If the answer is N, the program returns to Step P376.

Then, in the aforementioned Step P400, the memory M61 for storing the rotating direction of the motor for adjusting the right side is overwritten with 0. Then, in Step P403, the count value S is loaded from the memory M59, whereafter 1 is added to the count value S of the memory M59 for overwriting in Step P404. Then, the program returns to Step P376.

In accordance with the above-described motion flow, when the squeegee throw-on and throw-off automatic control switch 52 is brought to the OFF-state, the squeegee 38 is moved to the throw-off position.

According to the present Embodiment 1, as described above, even when the squeegee 38 is located at a position where it opposes the notch 13b of the impression cylinder 13 (i.e., the retreat position), the leading end of the squeegee 38 does not leave the inner peripheral surface of the screen printing forme 11c, and only its pressure exerted on this surface (i.e., pressing force) is rendered lower than the pressure during printing. Thus, the screen printing forme 11c is prevented from being pushed into the notch 13b of the impression cylinder 13 by the squeegee 38 and damaged thereby, and there is no ink leaking out toward the downstream side in the rotating direction of the screen printing forme 11c, so that deterioration of printing quality is prevented.

That is, the following problems are avoided: Because of leaks of ink toward the downstream side in the rotating direction of the screen printing forme 11c, the amount of ink remaining in front of the squeegee 38 becomes small to decrease the ink density at the start of printing. The ink leaking out toward the downstream side leaks out through the holes of the picture pattern portion under a centrifugal force during high speed rotation, adheres to outside portions of the holes, and sticks to the outside of the picture pattern portion during printing, thereby deteriorating printing quality.

In the present Embodiment 1, the above-mentioned pressing force (in other words, the retreat position of the squeegee 38) is variably controlled in accordance with the type of the screen printing forme 11c (material, forme thickness, mesh size, etc.), the picture pattern area rate (or image area rate) of the picture pattern printed on the material W to be printed, the type of ink used in printing (viscosity, yield value, type of pigment, etc.), and the type of the squeegee 38 (material, thickness, etc.). Hence, damage to the screen printing forme 11c and deterioration of printing quality are prevented with even higher accuracy.

In the present Embodiment 1, the control pressure may be switched using a hydraulic or pneumatic actuator instead of the motor 36A for adjusting the left side and the motor 36B for adjusting the right side. Moreover, the motors 36A and 36B are disposed on the right side and the left side. However, there may be adopted a configuration in which a one-sided motor moves the right and left sides, for example, by connecting the right and left sides by a lever mechanism.

### Embodiment 2

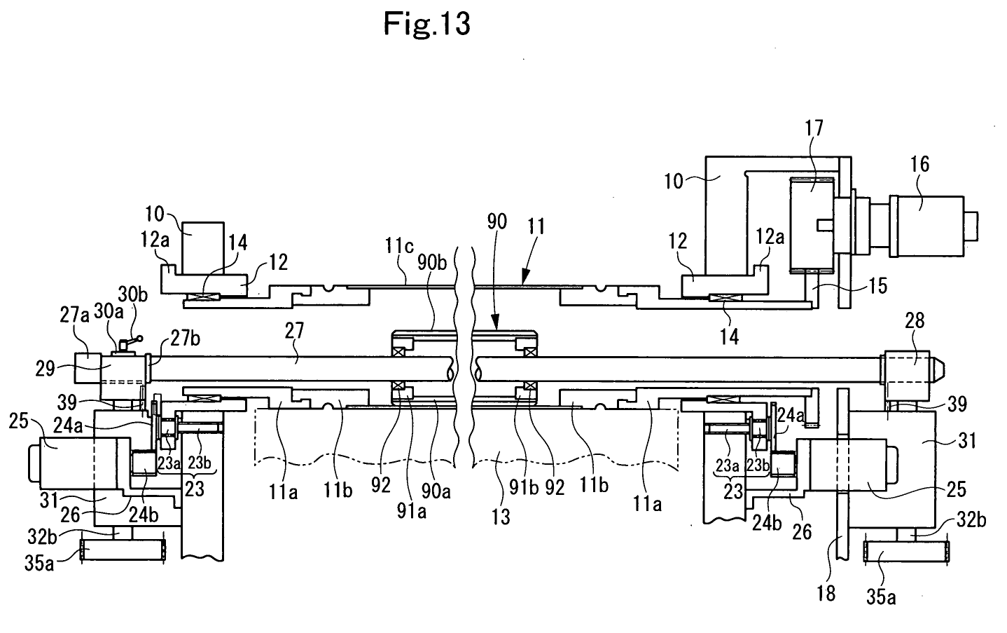

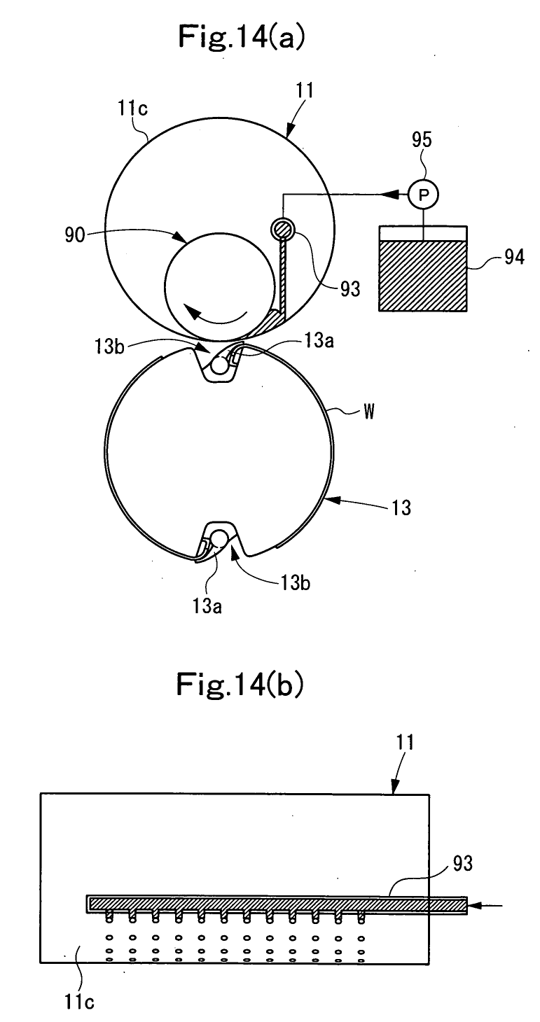

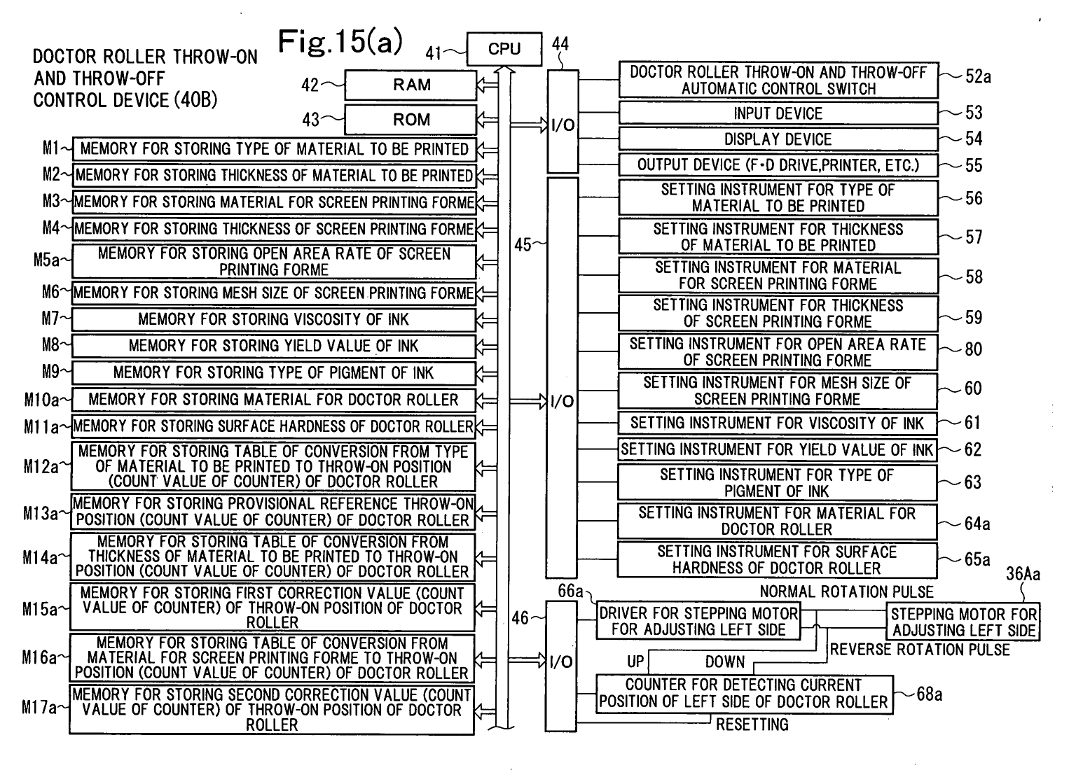

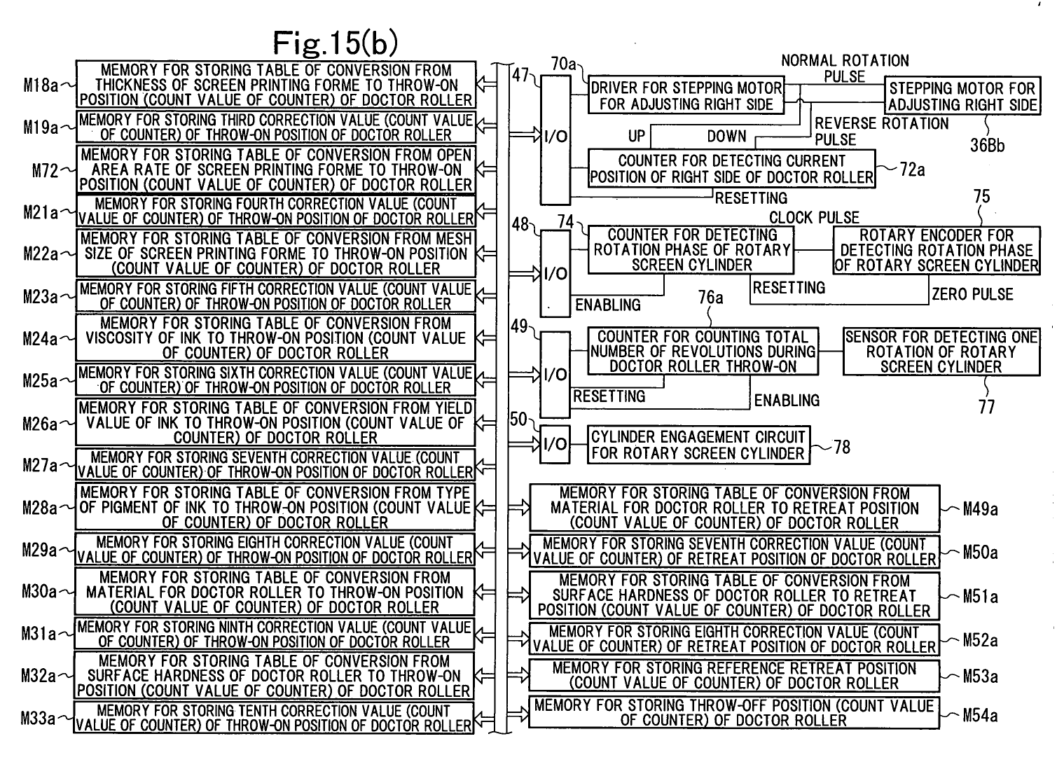

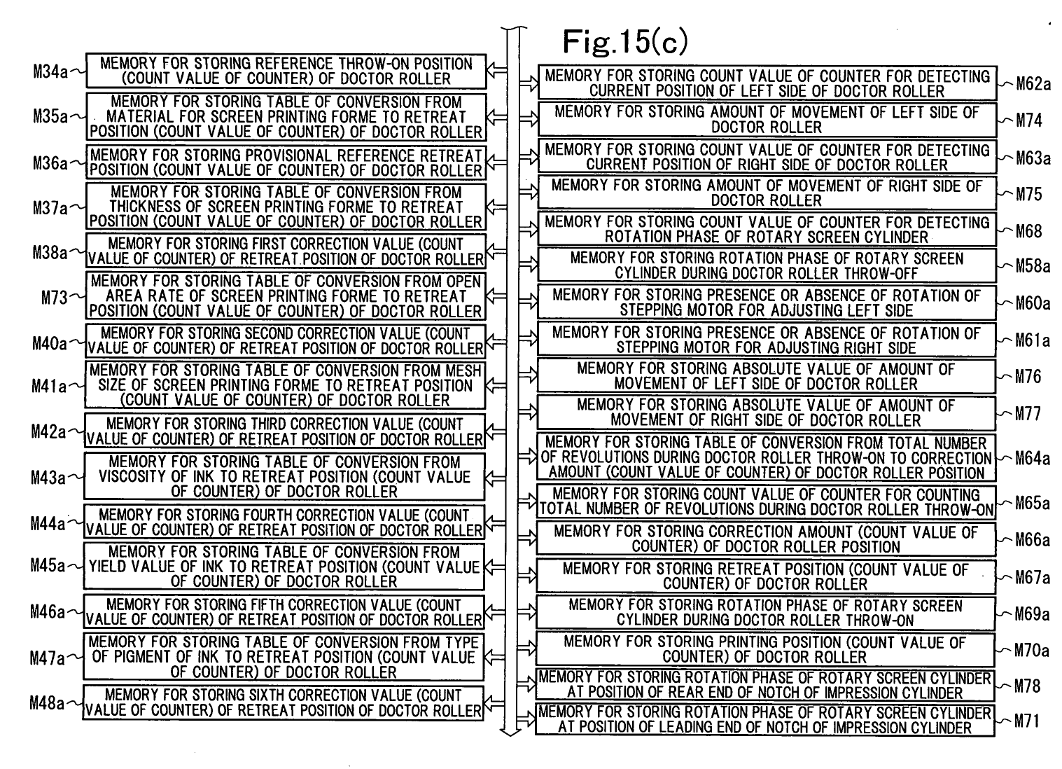

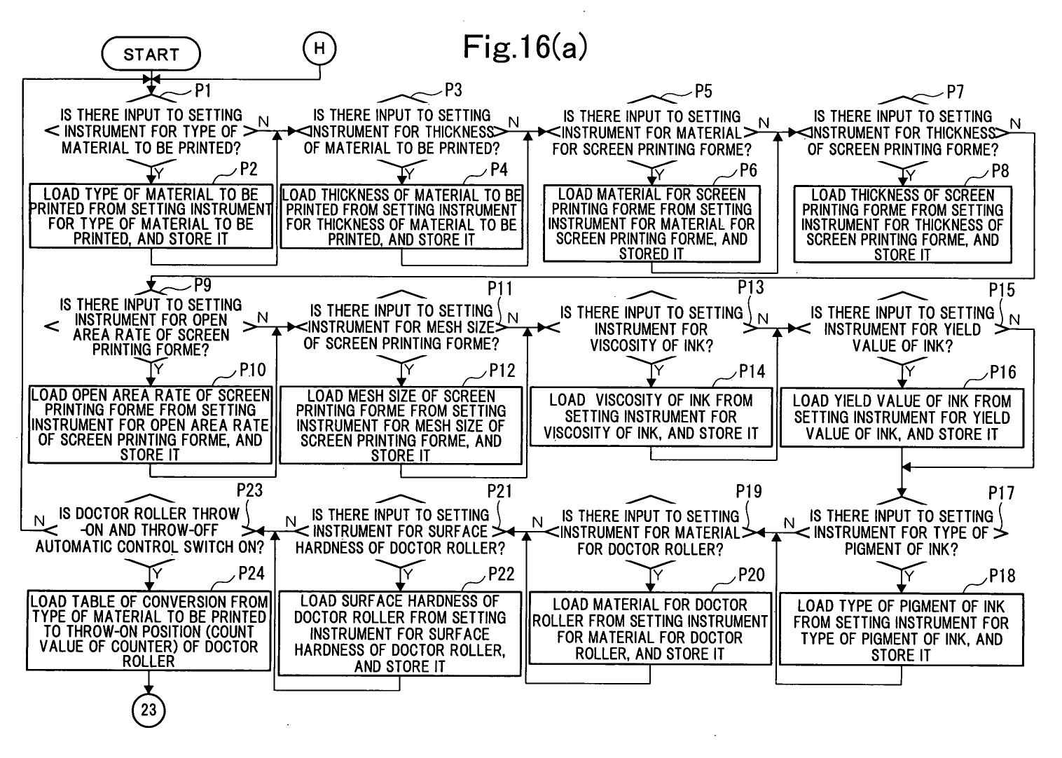

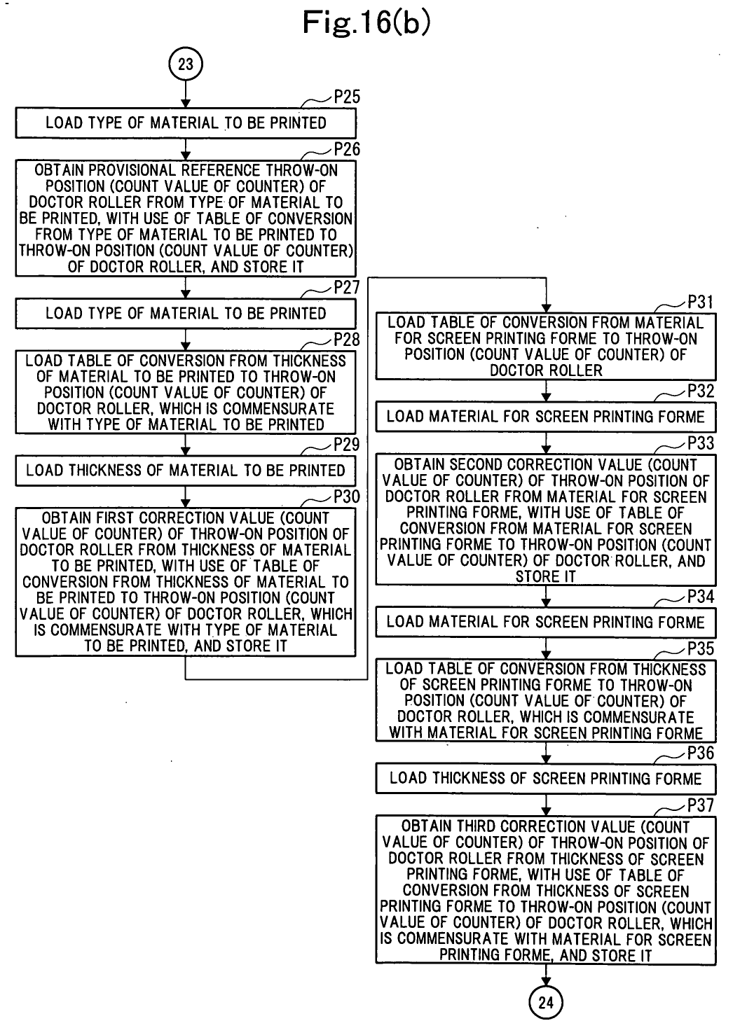

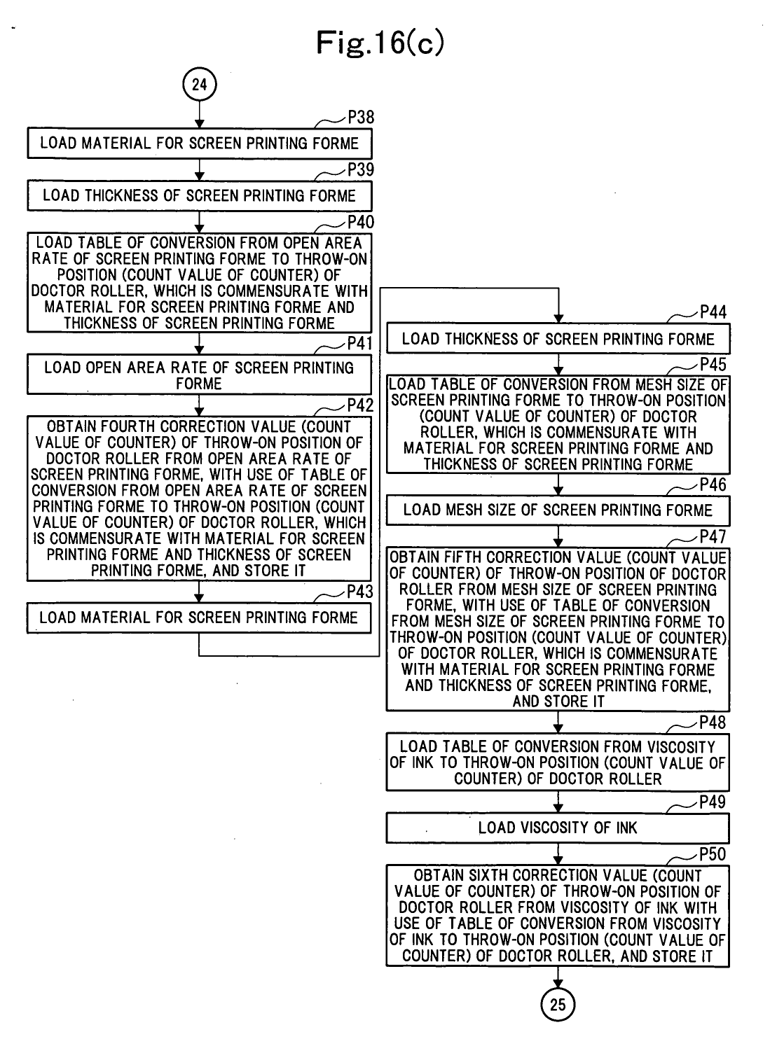

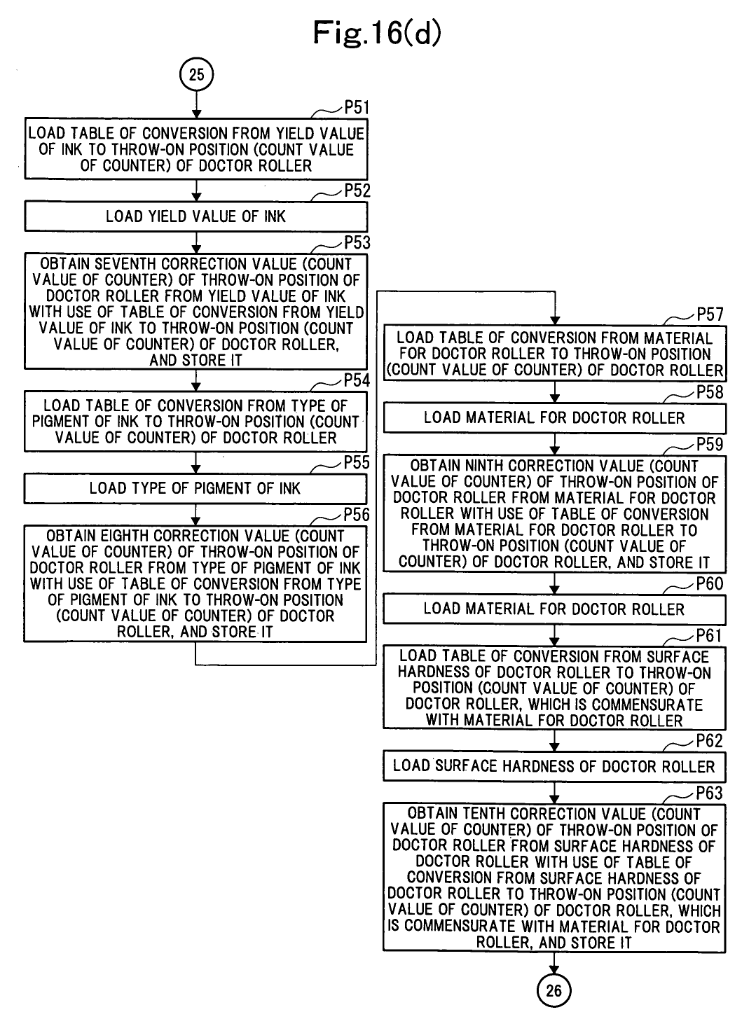

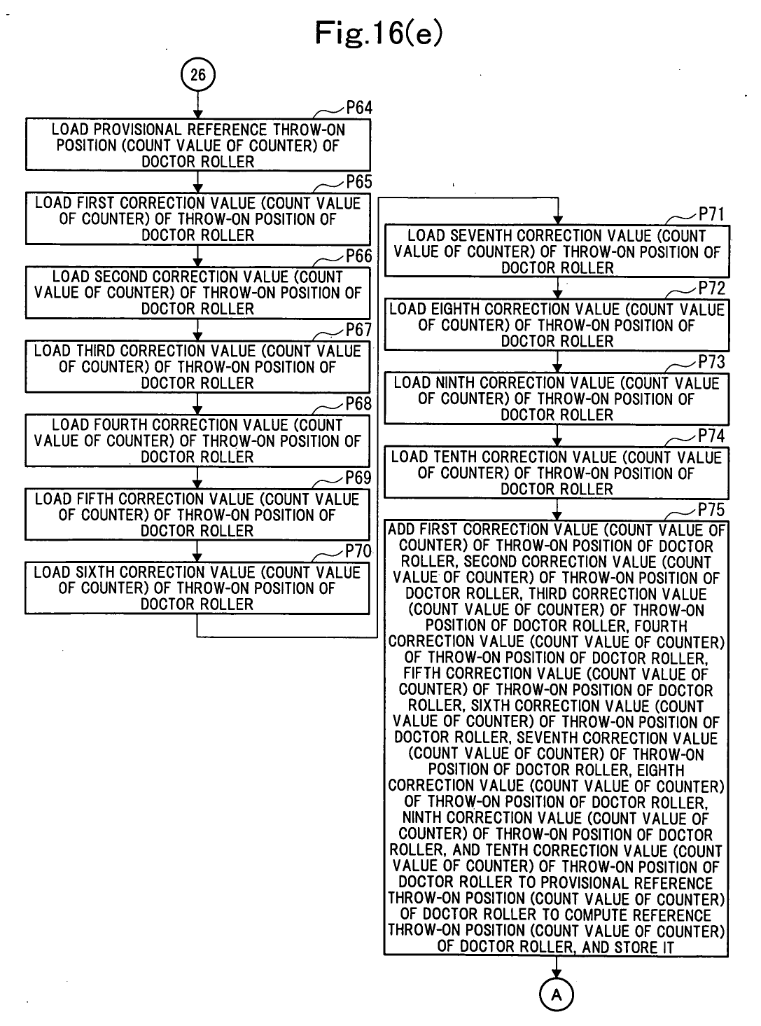

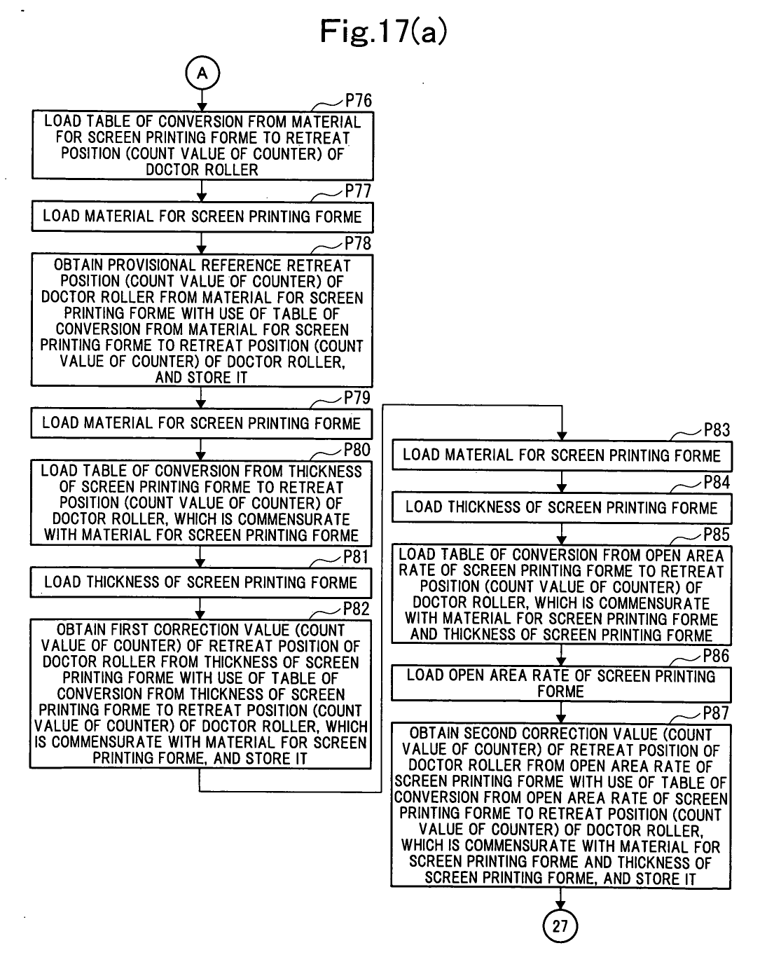

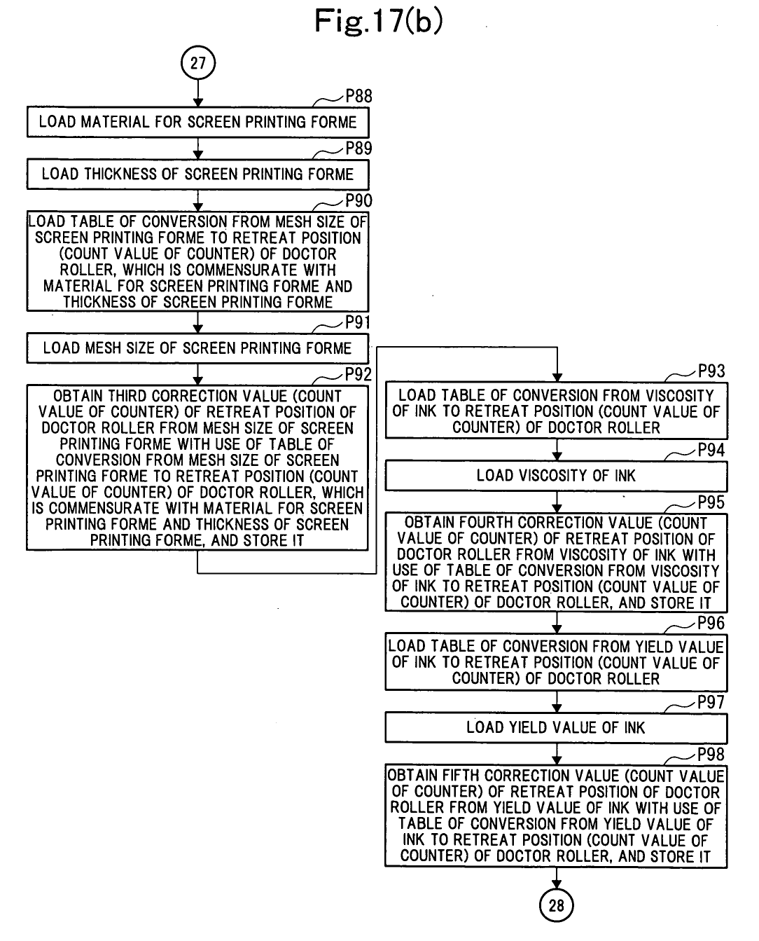

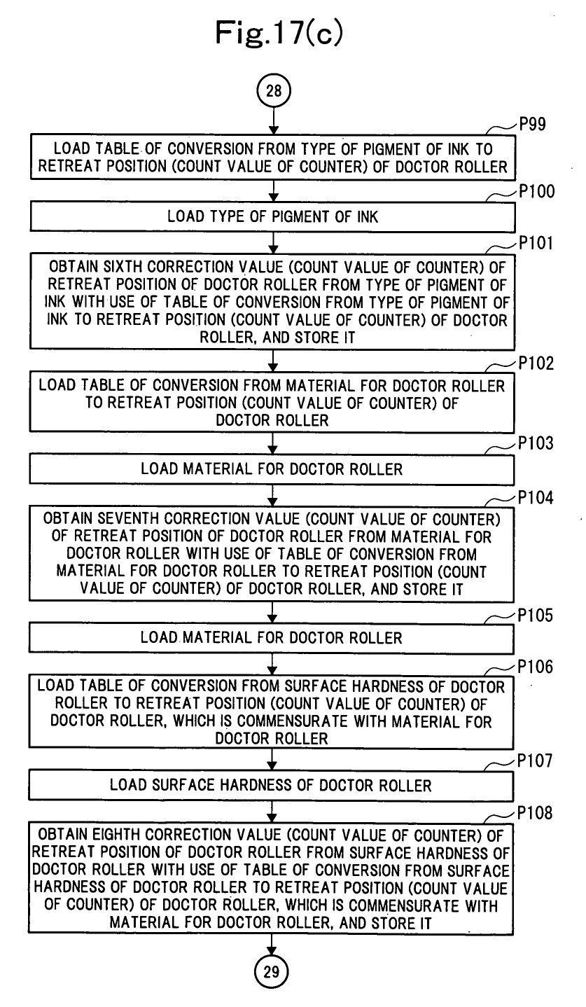

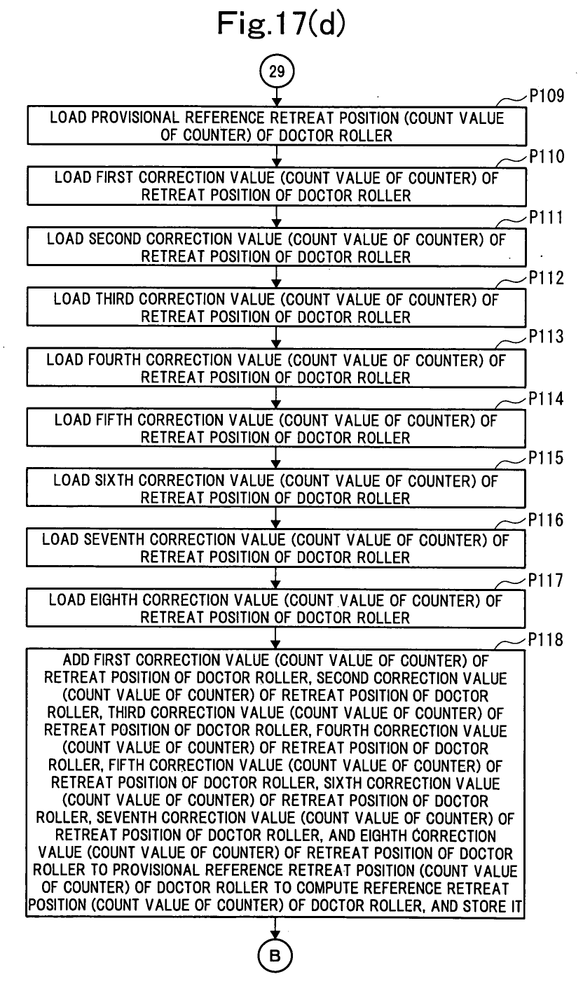

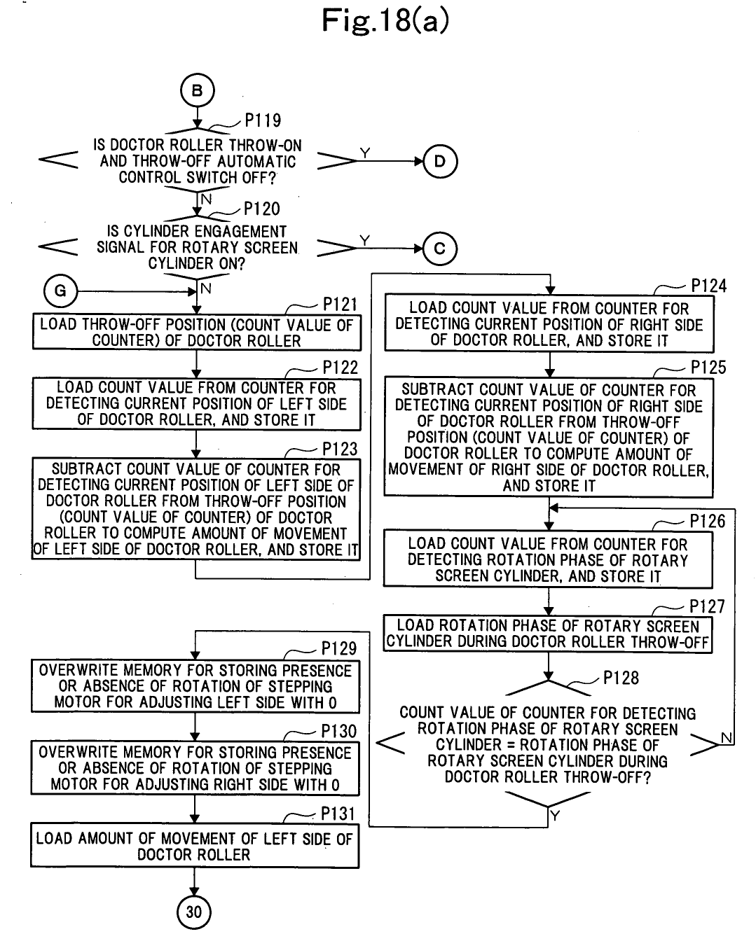

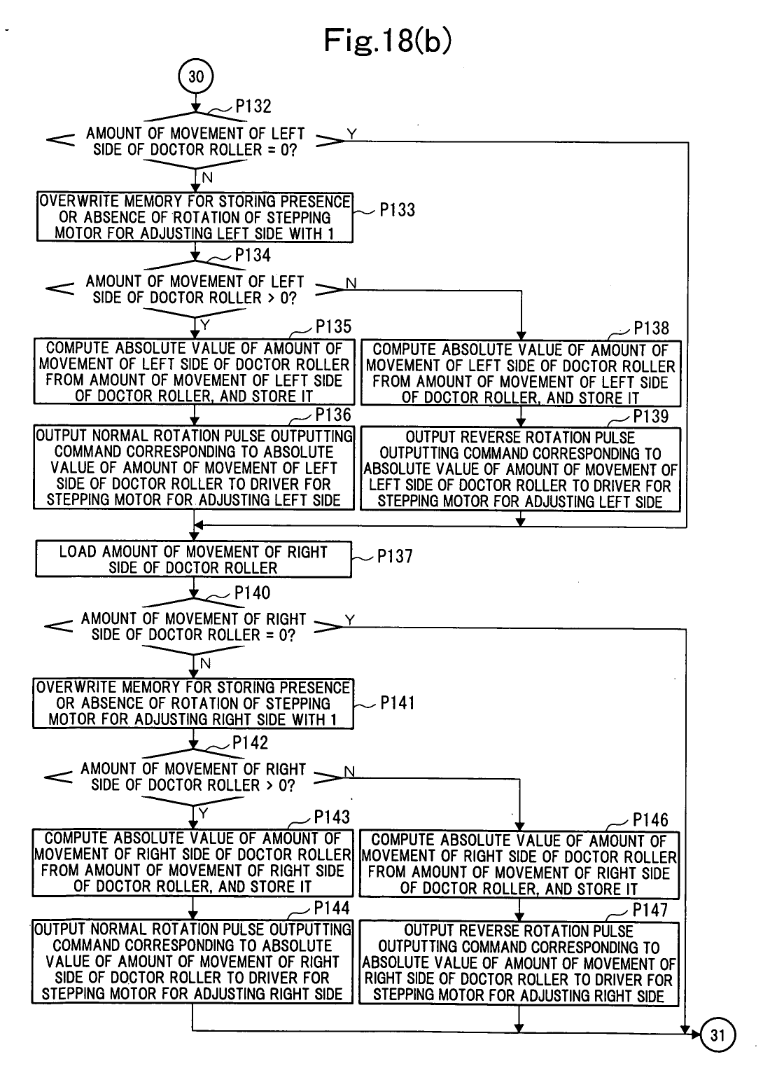

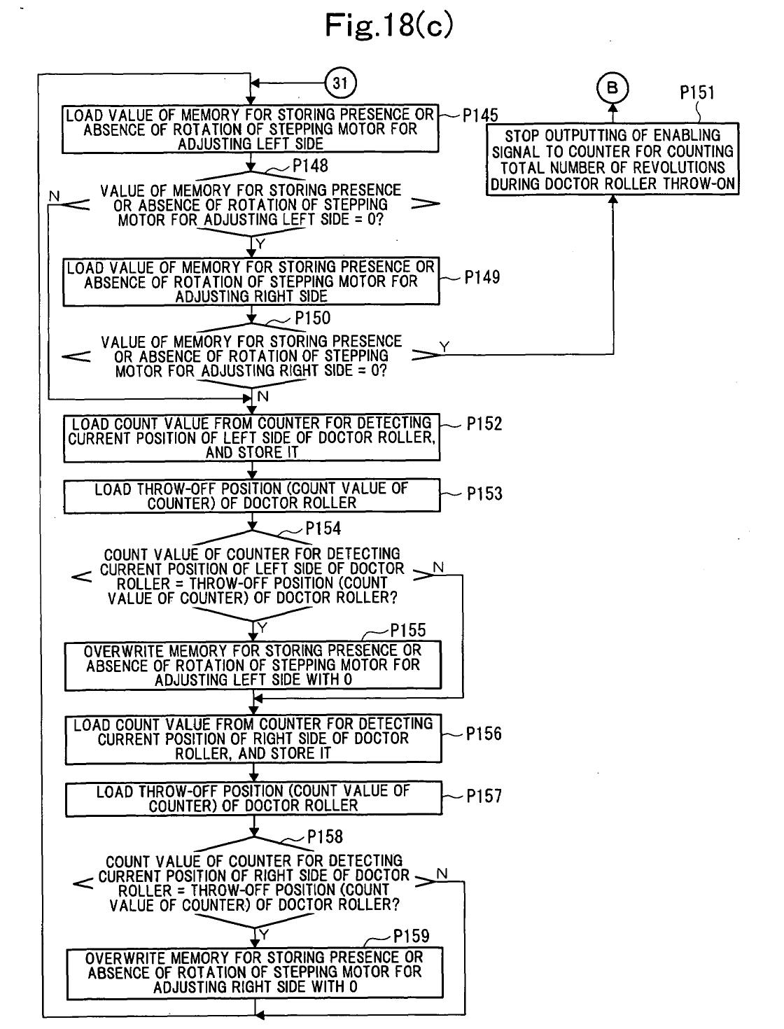

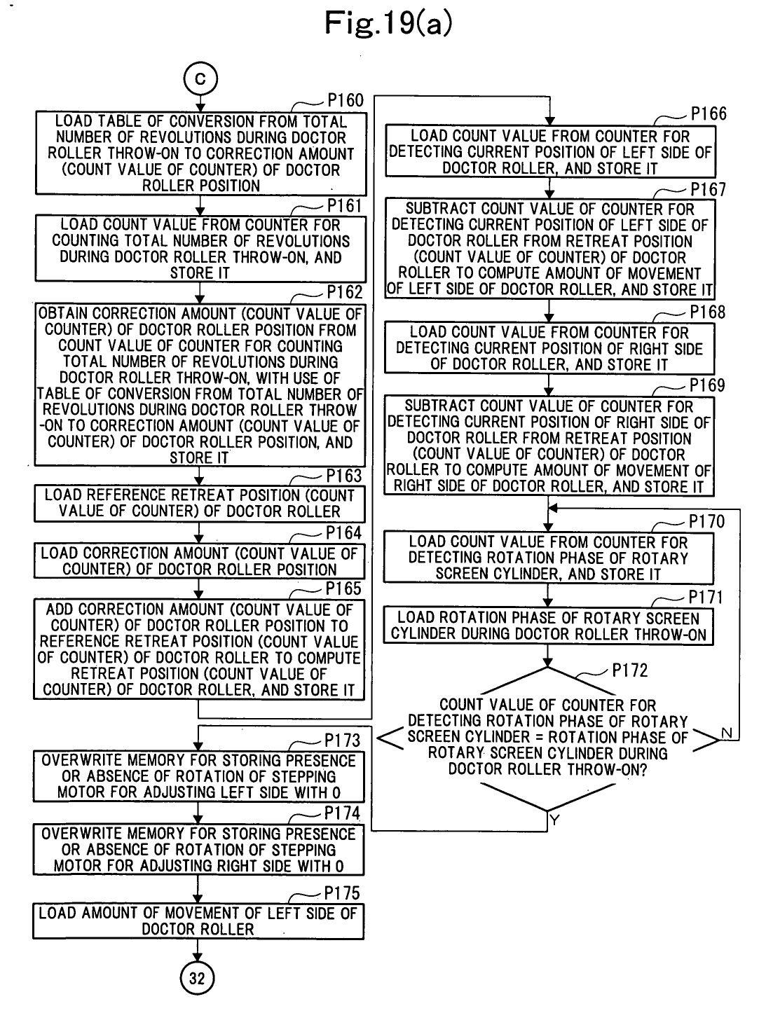

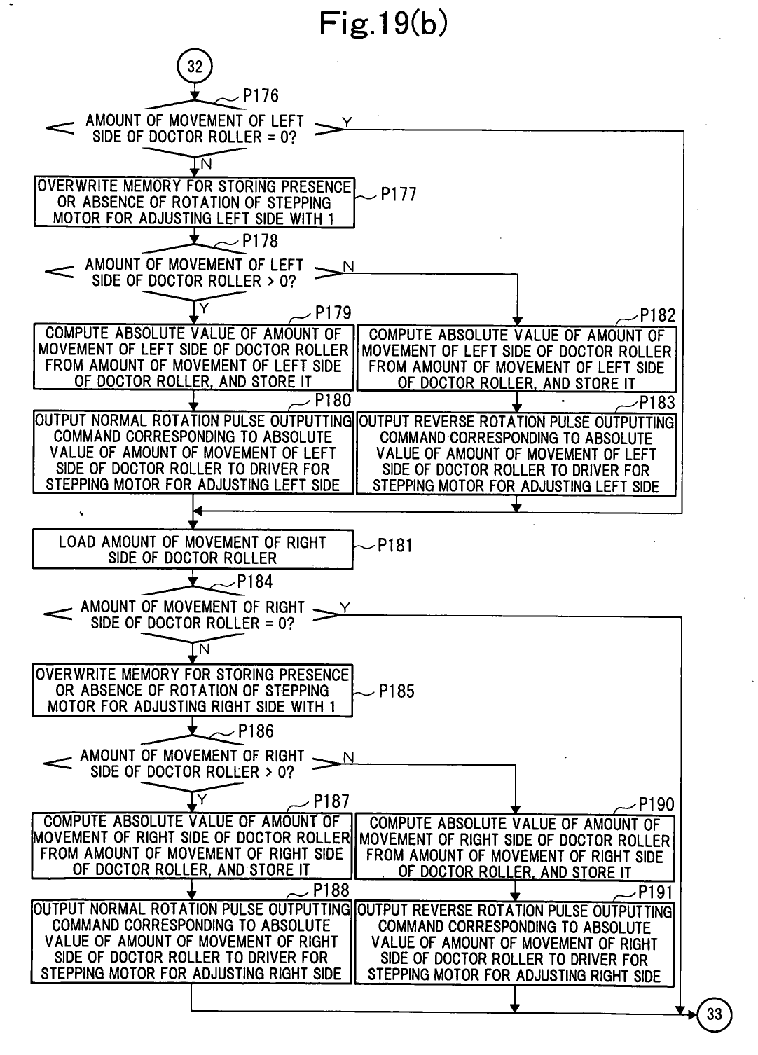

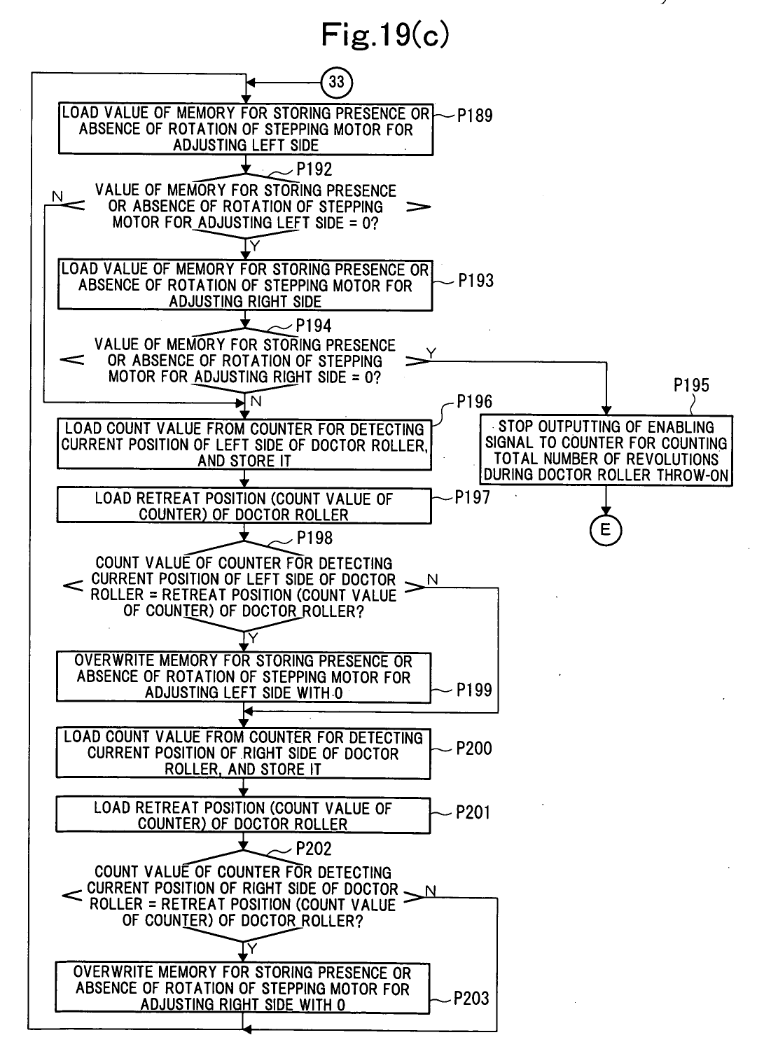

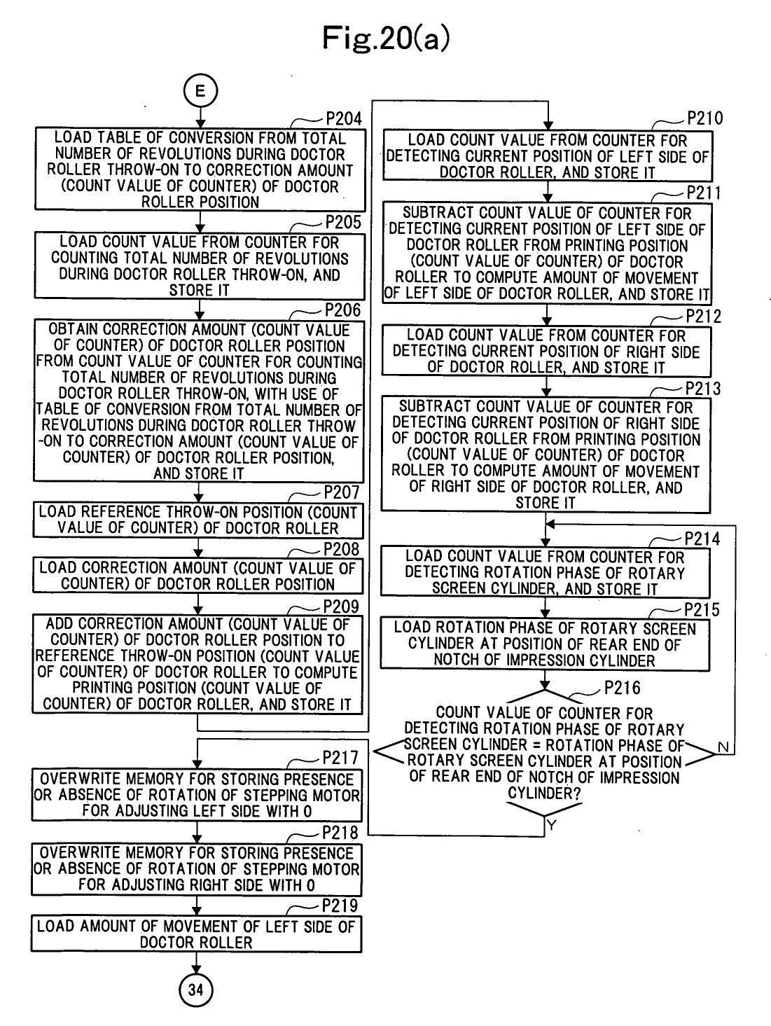

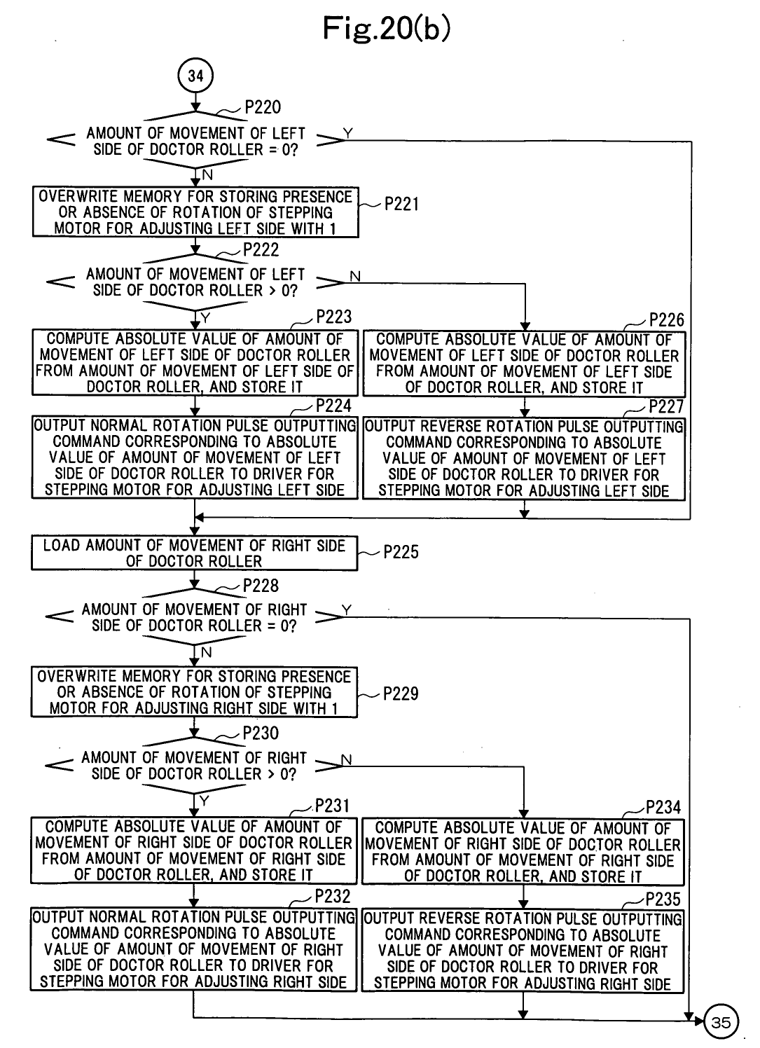

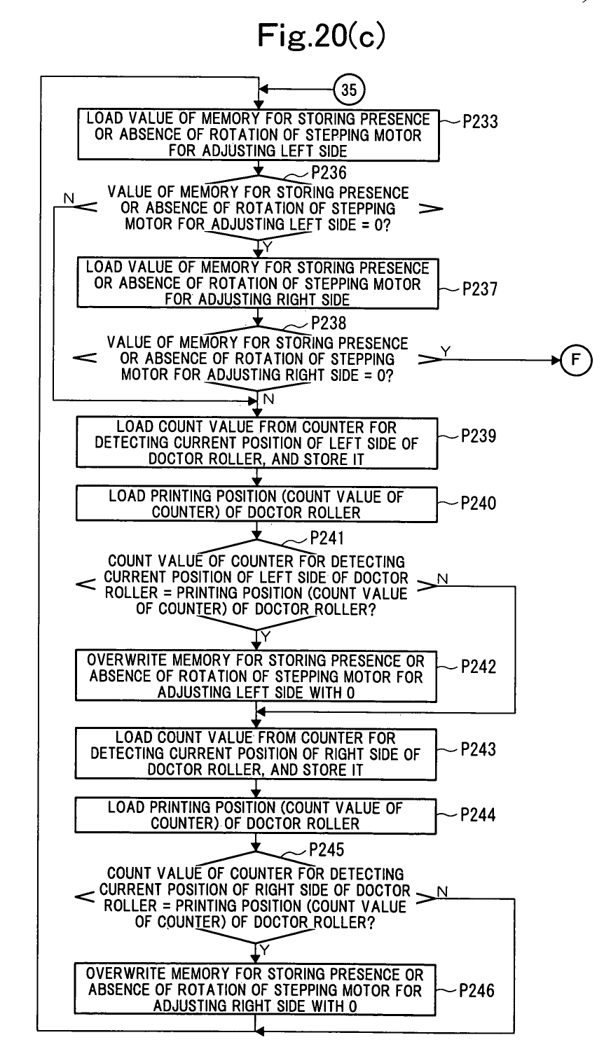

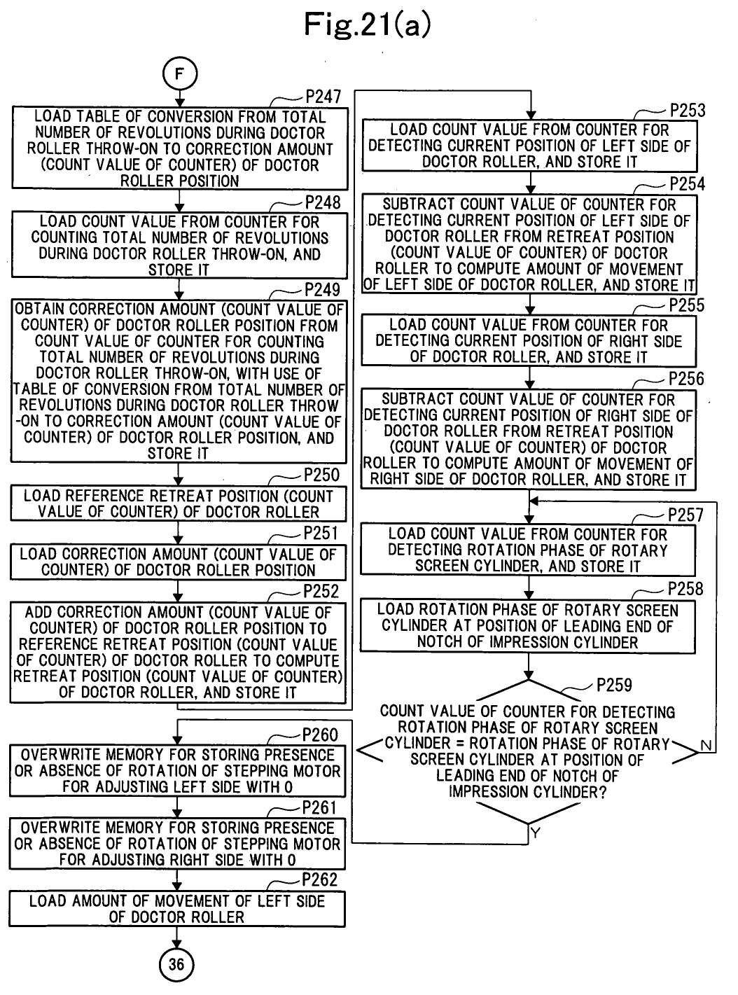

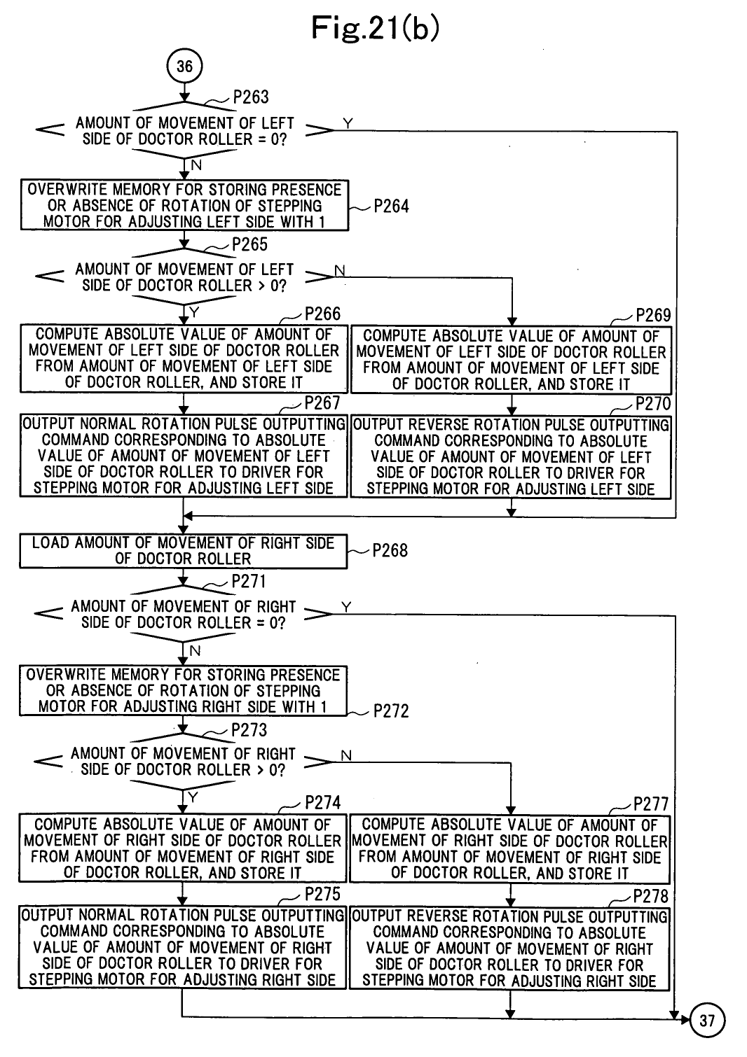

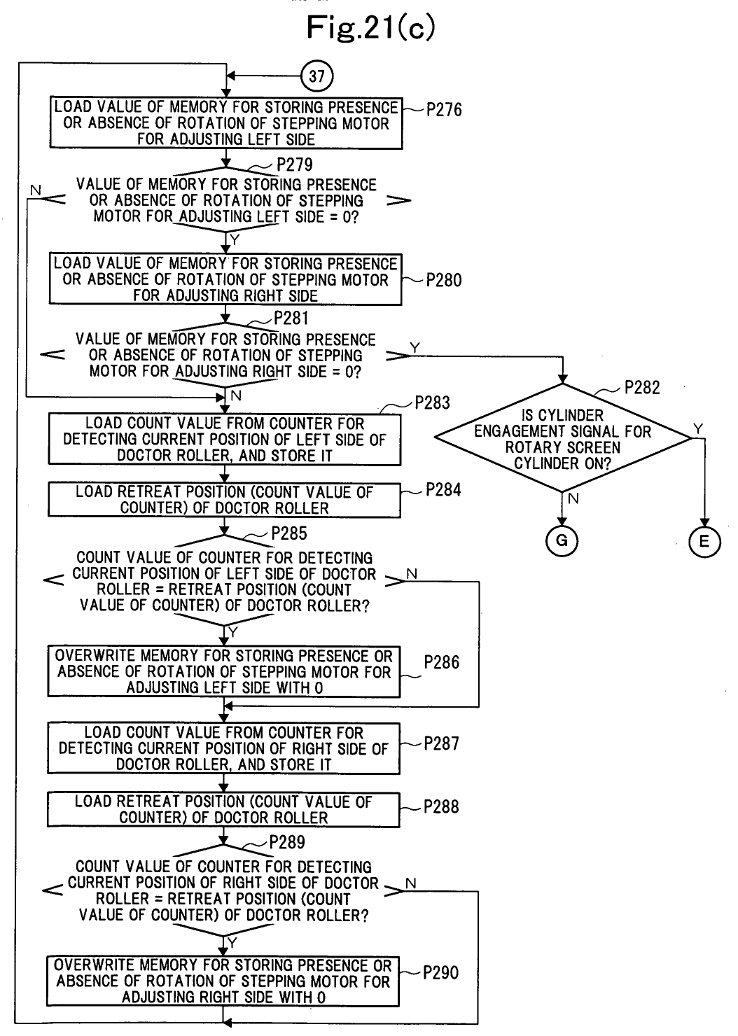

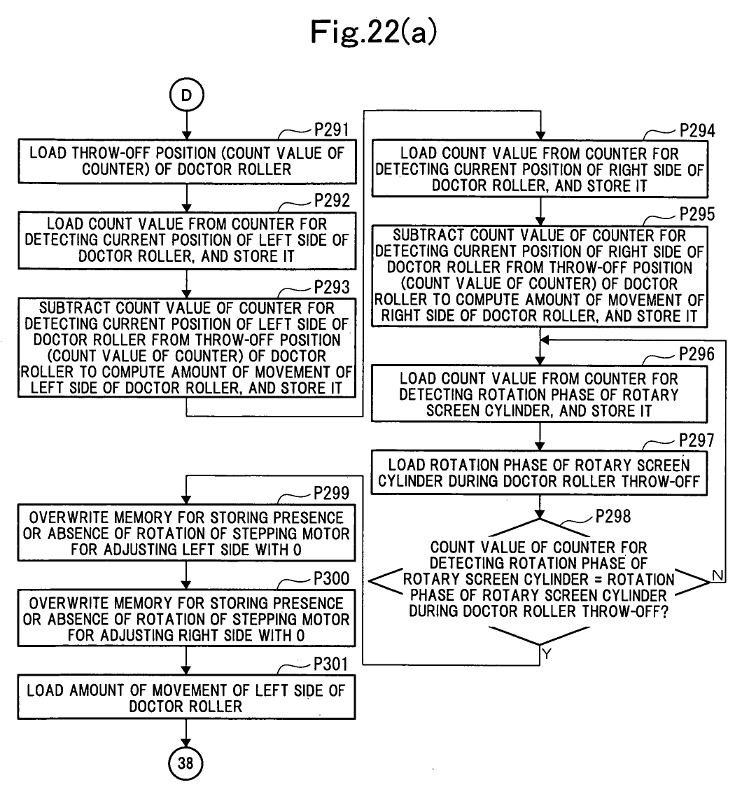

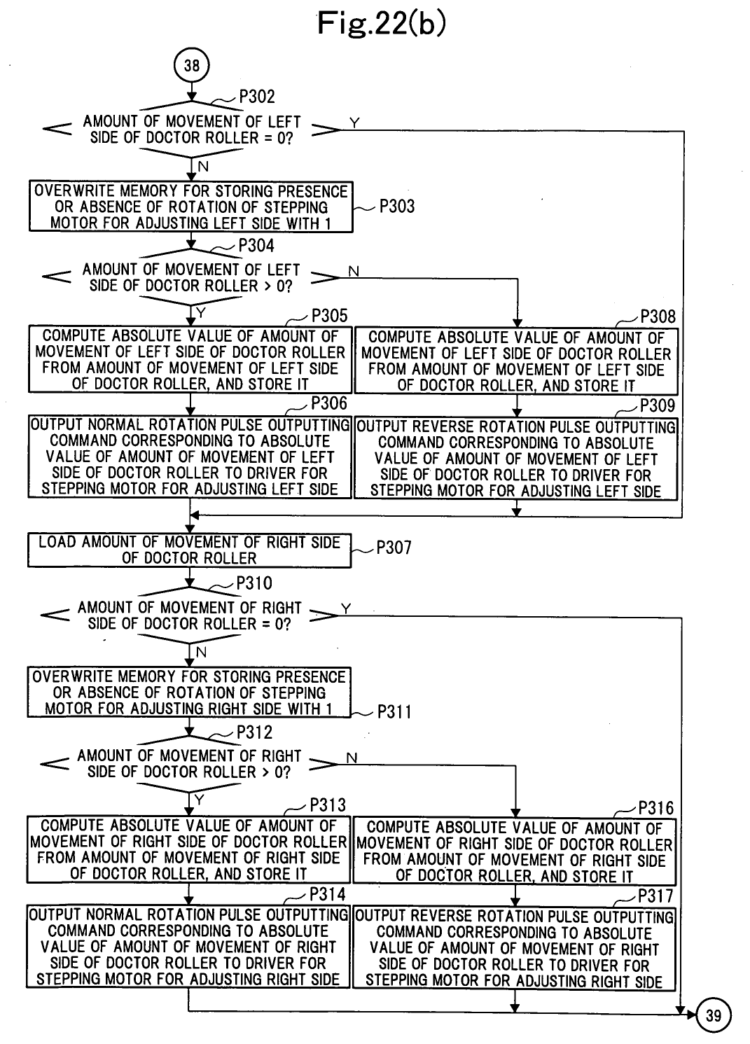

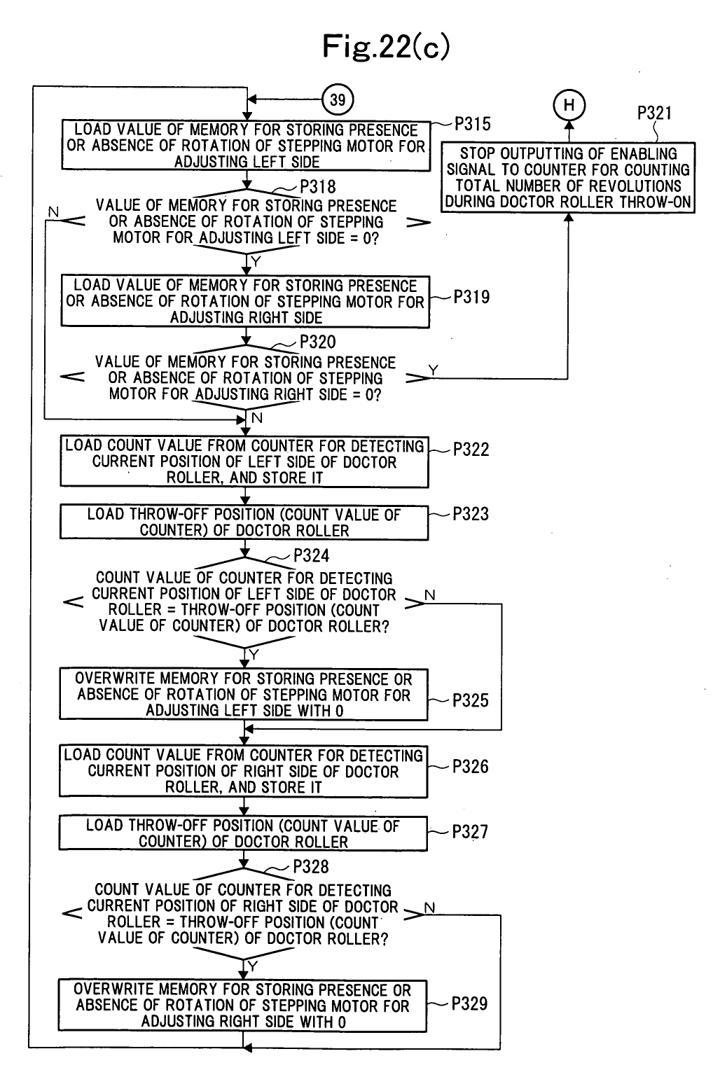

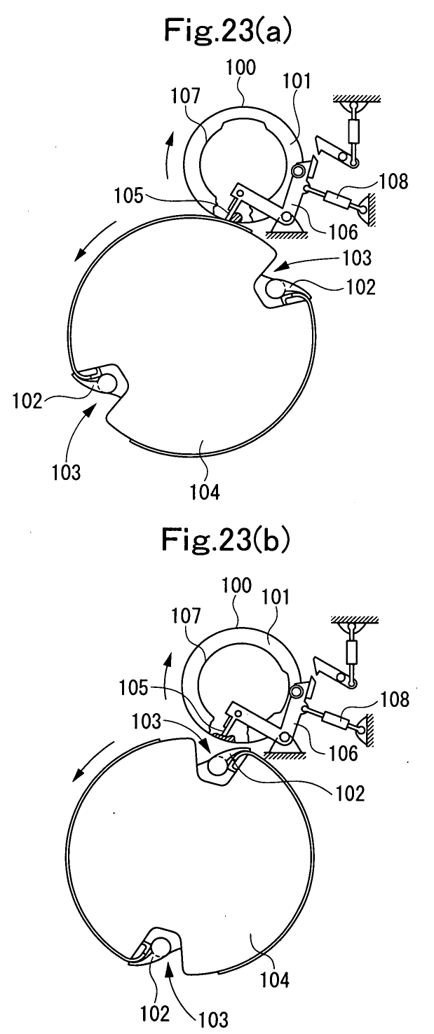

FIG. 13 is a schematic configurational sectional view of a rotary screen printing unit in a rotary screen printing press showing Embodiment 2 of the present invention. FIG. 14(a) is an explanation drawing of an ink supply system. FIG. 14(b) is an explanation drawing of an ink supply pipe. FIGS. 15(a) to 15(c) are control block diagrams of a doctor roller throw-on and throw-off control device. FIGS. 16(a) to 16(e) are motion flow charts of the doctor roller throw-on and throw-off control device. FIGS. 17(a) to 17(d) are motion flow charts of the doctor roller throw-on and throw-off control device. FIGS. 18(a) to 18(c) are motion flow charts of the doctor roller throw-on and throw-off control device. FIGS. 19(a) to 19(c) are motion flow charts of the doctor roller throw-on and throw-off control device. FIGS. 20(a) to 20(c) are motion flow charts of the doctor roller throw-on and throw-off control device. FIGS. 21(a) to 21(c) are motion flow charts of the doctor roller throw-on and throw-off control device. FIGS. 22(a) to 22(c) are motion flow charts of the doctor roller throw-on and throw-off control device.

The present Embodiment 2 is an embodiment in which a stepping motor 36Aa for adjusting a left side and a stepping motor 36Bb for adjusting a right side (see FIGS. 15(a) and 15(b)) are used instead of the motor 36A for adjusting the left side of the support shaft 27 and the motor 36B for adjusting the right side of the support shaft 27 in Embodiment 1, and a doctor roller 90 is used instead of the squeegee 38 as the liquid transfer member, as shown in FIG. 13.

The doctor roller 90 has a double structure composed of an inner roller 90a formed from a metal and an outer roller 90b formed from rubber. The doctor roller 90 is rotatably supported on a support shaft 27 via bearings 92 at left and right end members 91a and 91b fitted into the inner roller 90a.

As shown in FIGS. 14(a) and 14(b), an ink supply pipe 93 is horizontally installed within the screen printing forme 11c, and ink stored within an external tank 94 is supplied to the ink supply pipe 93 by a pump 95. The ink is dropped from the ink supply pipe 93 toward the inner peripheral surface of the screen printing forme 11c at multiple points in the cylinder axis direction of the rotary screen cylinder 11.

Thus, the outer peripheral surface of the doctor roller 90 makes a rolling contact with the inner peripheral surface of the screen printing forme 11c, whereby the ink supplied to the interior of the screen printing forme 11c through the ink supply pipe 93 is transferred to the printing surface of the material W to be printed via the holes of the screen printing forme 11c.

Other features are the same as those in Embodiment 1, so that duplicate explanations are omitted by reference to FIGS. 1 to 4(a), 4(b).

The doctor roller throw-on and throw-off control device 40B of the present Embodiment 2 comprises CPU 41, RAM 42, ROM 43, and input/output devices 44 to 50 connected together by BUS (bus line), as shown in FIGS. 15(a) to 15(c). To the BUS (bus line), the following memories are connected: A memory M1 for storing the type of the material to be printed, a memory M2 for storing the thickness of the material to be printed, a memory M3 for storing the material for the screen printing forme, a memory M4 for storing the thickness of the screen printing forme, a memory M5a for storing the open area rate of the screen printing forme, a memory M6 for storing the mesh size of the screen printing forme, a memory M7 for storing the viscosity of ink, a memory M8 for storing the yield value of ink, a memory M9 for storing the type of a pigment of ink, a memory M10a for storing the material for the doctor roller, and a memory M11a for storing the surface hardness of the doctor roller.

To the BUS (bus line), the following memories are further connected: A memory M12a for storing a table of conversion from the type of the material to be printed to the throw-on position (count value of a counter) of the doctor roller, a memory M13a for storing the provisional reference throw-on position (count value of the counter) of the doctor roller, a memory M14a for storing a table of conversion from the thickness of the material to be printed to the throw-on position (count value of the counter) of the doctor roller, a memory M15a for storing the first correction value (count value of the counter) of the throw-on position of the doctor roller, a memory M16a for storing a table of conversion from the material for the screen printing forme to the throw-on position (count value of the counter) of the doctor roller, a memory M17a for storing the second correction value (count value of the counter) of the throw-on position of the doctor roller, a memory M18a for storing a table of conversion from the thickness of the screen printing forme to the throw-on position (count value of the counter) of the doctor roller, a memory M19a for storing the third correction value (count value of the counter) of the throw-on position of the doctor roller, and a memory M21a for storing the fourth correction value (count value of the counter) of the throw-on position of the doctor roller.

To the BUS (bus line), the following memories are further connected: A memory M22a for storing a table of conversion from the mesh size of the screen printing forme to the throw-on position (count value of the counter) of the doctor roller, a memory M23a for storing the fifth correction value (count value of the counter) of the throw-on position of the doctor roller, a memory M24a for storing a table of conversion from the viscosity of ink to the throw-on position (count value of the counter) of the doctor roller, a memory M25a for storing the sixth correction value (count value of the counter) of the throw-on position of the doctor roller, a memory M26a for storing a table of conversion from the yield value of ink to the throw-on position (count value of the counter) of the doctor roller, a memory M27a for storing the seventh correction value (count value of the counter) of the throw-on position of the doctor roller, a memory M28a for storing a table of conversion from the type of the pigment of ink to the throw-on position (count value of the counter) of the doctor roller, a memory M29a for storing the eighth correction value (count value of the counter) of the throw-on position of the doctor roller, a memory M30a for storing a table of conversion from the material for the doctor roller to the throw-on position (count value of the counter) of the doctor roller, a memory M31a for storing the ninth correction value (count value of the counter) of the throw-on position of the doctor roller, a memory M32a for storing a table of conversion from the surface hardness of the doctor roller to the throw-on position (count value of the counter) of the doctor roller, and a memory M33a for storing the tenth correction value (count value of the counter) of the throw-on position of the doctor roller.

To the BUS (bus line), the following memories are further connected: A memory M34a for storing the reference throw-on position (count value of the counter) of the doctor roller, a memory M35a for storing a table of conversion from the material for the screen printing forme to the retreat position (count value of the counter) of the doctor roller, a memory M36a for storing the provisional reference retreat position (count value of the counter) of the doctor roller, a memory M37a for storing a table of conversion from the thickness of the screen printing forme to the retreat position (count value of the counter) of the doctor roller, a memory M38a for storing the first correction value (count value of the counter) of the retreat position of the doctor roller, a memory M40a for storing the second correction value (count value of the counter) of the retreat position of the doctor roller, a memory M41a for storing a table of conversion from the mesh size of the screen printing forme to the retreat position (count value of the counter) of the doctor roller, a memory M42a for storing the third correction value (count value of the counter) of the retreat position of the doctor roller, a memory M43a for storing a table of conversion from the viscosity of ink to the retreat position (count value of the counter) of the doctor roller, a memory M44a for storing the fourth correction value (count value of the counter) of the retreat position of the doctor roller, a memory M45a for storing a table of conversion from the yield value of ink to the retreat position (count value of the counter) of the doctor roller, and a memory M46a for storing the fifth correction value (count value of the counter) of the retreat position of the doctor roller.

To the BUS (bus line), the following memories are further connected: A memory M47a for storing a table of conversion from the type of the pigment of ink to the retreat position (count value of the counter) of the doctor roller, a memory M48a for storing the sixth correction value (count value of the counter) of the retreat position of the doctor roller, a memory M49a for storing a table of conversion from the material for the doctor roller to the retreat position (count value of the counter) of the doctor roller, a memory M50a for storing the seventh correction value (count value of the counter) of the retreat position of the doctor roller, a memory M51a for storing a table of conversion from the surface hardness of the doctor roller to the retreat position (count value of the counter) of the doctor roller, a memory M52a for storing the eighth correction value (count value of the counter) of the retreat position of the doctor roller, a memory M53a for storing the reference retreat position (count value of the counter) of the doctor roller, a memory M54a for storing the throw-off position (count value of the counter) of the doctor roller, and a memory M58a for storing the rotation phase of the rotary screen cylinder during doctor roller throw-off.

To the BUS (bus line), the following memories are further connected: A memory M60a for storing the presence or absence of rotation of a stepping motor for adjusting a left side, a memory M61a for storing the presence or absence of rotation of a stepping motor for adjusting a right side, a memory M62a for storing the count value of a counter for detecting the current position of the left side of the doctor roller, a memory M63a for storing the count value of a counter for detecting the current position of the right side of the doctor roller, a memory M64a for storing a table of conversion from the total number of revolutions during doctor roller throw-on to the correction amount (count value of the counter) of the doctor roller position, a memory M65a for storing the count value of a counter for counting the total number of revolutions during doctor roller throw-on, a memory M66a for storing the correction amount (count value of the counter) of the doctor roller position, a memory M67a for storing the retreat position (count value of the counter) of the doctor roller, a memory M68 for storing the count value of a counter for detecting the rotation phase of the rotary screen cylinder, a memory M69a for storing the rotation phase of the rotary screen cylinder during doctor roller throw-on, a memory M70a for storing the printing position (count value of the counter) of the doctor roller, a memory M71 for storing the rotation phase of the rotary screen cylinder at the position of the leading end of the notch of the impression cylinder, a memory M72 for storing a table of conversion from the open area rate of the screen printing forme to the throw-on position (count value of the counter) of the doctor roller, a memory M73 for storing a table of conversion from the open area rate of the screen printing forme to the retreat position (count value of the counter) of the doctor roller, a memory M74 for storing the amount of movement of the left side of the doctor roller, a memory M75 for storing the amount of movement of the right side of the doctor roller, a memory M76 for storing the absolute value of the amount of movement of the left side of the doctor roller, a memory M77 for storing the absolute value of the amount of movement of the right side of the doctor roller, and a memory M78 for storing the rotation phase of the rotary screen cylinder at the position of the rear end of the notch of the impression cylinder.

To the input/output device 44, the following are connected: A doctor roller throw-on and throw-off automatic control switch 52a, an input device 53 such as a keyboard, a display device 54 such as CRT or a display, and an output device 55 such as a printer or a floppy disk (registered trademark) drive.

To the input/output device 45, the following are connected: A setting instrument 56 for the type of the material to be printed, a setting instrument 57 for the thickness of the material to be printed, a setting instrument 58 for the material for the screen printing forme, a setting instrument 59 for the thickness of the screen printing forme, a setting instrument 60 for the mesh size of the screen printing forme, a setting instrument 61 for the viscosity of ink, a setting instrument 62 for the yield value of ink, a setting instrument 63 for the type of the pigment of ink, a setting instrument 64a for the material for the doctor roller, a setting instrument 65a for the surface hardness of the doctor roller, and a setting instrument 80 for the open area rate of the screen printing forme.

To the input/output device 46, the stepping motor 36Aa for adjusting the left side is connected via a driver 66a for the stepping motor for adjusting the left side, and a counter 68a for detecting the current position of the left side of the doctor roller is also connected.

To the input/output device 47, the stepping motor 36Bb for adjusting the right side is connected via a driver 70a for the stepping motor for adjusting the right side, and a counter 72a for detecting the current position of the right side of the doctor roller is also connected.

To the input/output device 48, a rotary encoder 75 for detecting the rotation phase of the rotary screen cylinder is connected via a counter 74 for detecting the rotation phase of the rotary screen cylinder. The rotary encoder 75 for detecting the rotation phase of the rotary screen cylinder is provided on a rotating part of the rotary screen printing press rotating in synchronism with the rotary screen cylinder in such a manner as to generate a zero pulse in the reference rotation phase of the rotary screen cylinder. Thus, the counter 74 for detecting the rotation phase of the rotary screen cylinder is reset in the reference rotation phase of the rotary screen cylinder each time the rotary screen cylinder makes one rotation. Then, the counter 74 for detecting the rotation phase of the rotary screen cylinder counts clock pulses generated in accordance with the rotation of the rotary screen cylinder, producing a count value conformed to the rotation phase of the rotary screen cylinder.

To the input/output device 49, a sensor 77 for detecting one rotation of the rotary screen cylinder is connected via a counter 76a for counting the total number of revolutions during doctor roller throw-on. The sensor 77 for detecting one rotation of the rotary screen cylinder is provided on a rotating part of the rotary screen printing press so as to produce one pulse each time the rotary screen cylinder makes one rotation. Thus, the counter 76a for counting the total number of revolutions during doctor roller throw-on is adapted to count the number of revolutions of the rotary screen cylinder in an operating state.

To the input/output device 50, a cylinder engagement circuit 78 for the rotary screen cylinder is connected.

The control actions or motions of the doctor roller throw-on and throw-off control device 40B configured as above will be described in detail based on the motion flow charts of FIGS. 16(a) to 16(e), FIGS. 17(a) to 17(d), FIGS. 18(a) to 18(c), FIGS. 19(a) to 19(c), FIGS. 20(a) to 20(c), FIGS. 21(a) to 21(c), and FIGS. 22(a) to 22(c).

In Step P1, it is determined whether there is an input to the setting instrument 56 for the type of the material to be printed. If the answer is Y (yes), the type of the material W to be printed is loaded from the setting instrument 56 for the type of the material to be printed, and stored into the memory M1, in Step P2, and the program proceeds to Step P3. If the answer is N (no), the program directly shifts to Step P3.

Then, in Step P3, it is determined whether there is an input to the setting instrument 57 for the thickness of the material to be printed. If the answer is Y, the thickness of the material to be printed is loaded from the setting instrument 57 for the thickness of the material to be printed, and stored into the memory M2, in Step P4. Then, the program proceeds to Step P5. If the answer is N, the program directly shifts to Step P5.

Then, in Step P5, it is determined whether there is an input to the setting instrument 58 for the material for the screen printing forme. If the answer is Y, the material for the screen printing forme 11c is loaded from the setting instrument 58 for the material for the screen printing forme, and stored into the memory M3, in Step P6. Then, the program proceeds to Step P7. If the answer is N, the program directly shifts to Step P7.

Then, in Step P7, it is determined whether there is an input to the setting instrument 59 for the thickness of the screen printing forme. If the answer is Y, the thickness of the screen printing forme is loaded from the setting instrument 59 for the thickness of the screen printing forme, and stored into the memory M4, in Step P8. Then, the program proceeds to Step P9. If the answer is N, the program directly shifts to Step P9.

Then, in Step P9, it is determined whether there is an input to the setting instrument 80 for the open area rate of the screen printing forme. If the answer is Y, the open area rate of the screen printing forme is loaded from the setting instrument 80 for the open area rate of the screen printing forme, and stored into the memory M5a, in Step P10. Then, the program proceeds to Step P11. If the answer is N, the program directly shifts to Step P11.

Then, in Step P11, it is determined whether there is an input to the setting instrument 60 for the mesh size of the screen printing forme. If the answer is Y, the mesh size of the screen printing forme 11c is loaded from the setting instrument 60 for the mesh size of the screen printing forme, and stored into the memory M6, in Step P12. Then, the program proceeds to Step P13. If the answer is N, the program directly shifts to Step P13.

Then, in Step P13, it is determined whether there is an input to the setting instrument 61 for the viscosity of ink. If the answer is Y, the viscosity of ink is loaded from the setting instrument 61 for the viscosity of ink, and stored into the memory M7, in Step P14. Then, the program proceeds to Step P15. If the answer is N, the program directly shifts to Step P15.

Then, in Step P15, it is determined whether there is an input to the setting instrument 62 for the yield value of ink. If the answer is Y, the yield value of ink is loaded from the setting instrument 62 for the yield value of ink, and stored into the memory M8, in Step P16. Then, the program proceeds to Step P17. If the answer is N, the program directly shifts to Step P17.

Then, in Step P17, it is determined whether there is an input to the setting instrument 63 for the type of the pigment of ink. If the answer is Y, the type of the pigment of ink is loaded from the setting instrument 63 for the type of the pigment of ink, and stored into the memory M9, in Step P18. Then, the program proceeds to Step P19. If the answer is N, the program directly shifts to Step P19.

Then, in Step P19, it is determined whether there is an input to the setting instrument 64a for the material for the doctor roller. If the answer is Y, the material for the doctor roller 90 is loaded from the setting instrument 64a for the material for the doctor roller, and stored into the memory M10a, in Step P20. Then, the program proceeds to Step P21. If the answer is N, the program directly shifts to Step P21.

Then, in Step P21, it is determined whether there is an input to the setting instrument 65a for the surface hardness of the doctor roller. If the answer is Y, the surface hardness of the doctor roller is loaded from the setting instrument 65a for the surface hardness of the doctor roller, and stored into the memory M11a, in Step P22. Then, the program proceeds to Step P23. If the answer is N, the program directly shifts to Step P23.

Then, in Step P23, it is determined whether the doctor roller throw-on and throw-off automatic control switch 52a is ON. If the answer is Y, the table of conversion from the type of the material to be printed to the throw-on position (count value of the counter) of the doctor roller is loaded from the memory M12a in Step P24. If the answer is N, the program returns to Step P1.

Then, in Step P25, the type of the material W to be printed is loaded from the memory M1. Then, in Step P26, the provisional reference throw-on position (count value of the counter) of the doctor roller is obtained from the type of the material W to be printed, with the use of the table of conversion from the type of the material to be printed to the throw-on position (count value of the counter) of the doctor roller, and is stored into the memory M13a.

Then, in Step P27, the type of the material W to be printed is loaded from the memory M1. Then, in Step P28, the table of conversion from the thickness of the material to be printed to the throw-on position (count value of the counter) of the doctor roller, which is commensurate with the type of the material to be printed, is loaded from the memory M14a.

Then, in Step P29, the thickness of the material to be printed is loaded from the memory M2. Then, in Step P30, the first correction value (count value of the counter) of the throw-on position of the doctor roller is obtained from the thickness of the material to be printed, with the use of the table of conversion from the thickness of the material to be printed to the throw-on position (count value of the counter) of the doctor roller, which is commensurate with the type of the material to be printed, and this correction value is stored into the memory M15a.

Then, in Step P31, the table of conversion from the material for the screen printing forme to the throw-on position (count value of the counter) of the doctor roller is loaded from the memory M16a. Then, in Step P32, the material for the screen printing forme 11c is loaded from the memory M3. Then, in Step P33, the second correction value (count value of the counter) of the throw-on position of the doctor roller is obtained from the material for the screen printing forme 11c, with the use of the table of conversion from the material for the screen printing forme to the throw-on position (count value of the counter) of the doctor roller, and this correction value is stored into the memory M17a.

Then, in Step P34, the material for the screen printing forme 11c is loaded from the memory M3. Then, in Step P35, the table of conversion from the thickness of the screen printing forme to the throw-on position (count value of the counter) of the doctor roller, which is commensurate with the material for the screen printing forme, is loaded from the memory M18a.

Then, in Step P36, the thickness of the screen printing forme is loaded from the memory M4. Then, in Step P37, the third correction value (count value of the counter) of the throw-on position of the doctor roller is obtained from the thickness of the screen printing forme, with the use of the table of conversion from the thickness of the screen printing forme to the throw-on position (count value of the counter) of the doctor roller, which is commensurate with the material for the screen printing forme, and this correction value is stored into the memory M19a.

Then, in Step P38, the material for the screen printing forme 11c is loaded from the memory M3. Then, in Step P39, the thickness of the screen printing forme is loaded from the memory M4. Then, in Step P40, the table of conversion from the open area rate of the screen printing forme to the throw-on position (count value of the counter) of the doctor roller, which is commensurate with the material for the screen printing forme and the thickness of the screen printing forme, is loaded from the memory M72.

Then, in Step P41, the open area rate of the screen printing forme is loaded from the memory M5a. Then, in Step P42, the fourth correction value (count value of the counter) of the throw-on position of the doctor roller is obtained from the open area rate of the screen printing forme, with the use of the table of conversion from the open area rate of the screen printing forme to the throw-on position (count value of the counter) of the doctor roller, which is commensurate with the material for the screen printing forme and the thickness of the screen printing forme, and this correction value is stored into the memory M21a.

Then, in Step P43, the material for the screen printing forme 11c is loaded from the memory M3. Then, in Step P44, the thickness of the screen printing forme is loaded from the memory M4. Then, in Step P45, the table of conversion from the mesh size of the screen printing forme to the throw-on position (count value of the counter) of the doctor roller, which is commensurate with the material for the screen printing forme and the thickness of the screen printing forme, is loaded from the memory M22a.

Then, in Step P46, the mesh size of the screen printing forme is loaded from the memory M6. Then, in Step P47, the fifth correction value (count value of the counter) of the throw-on position of the doctor roller is obtained from the mesh size of the screen printing forme, with the use of the table of conversion from the mesh size of the screen printing forme to the throw-on position (count value of the counter) of the doctor roller, which is commensurate with the material for the screen printing forme and the thickness of the screen printing forme, and this correction value is stored into the memory M23a.

Then, in Step P48, the table of conversion from the viscosity of ink to the throw-on position (count value of the counter) of the doctor roller is loaded from the memory M24a. Then, in Step P49, the viscosity of ink is loaded from the memory M7. Then, in Step P50, the sixth correction value (count value of the counter) of the throw-on position of the doctor roller is obtained from the viscosity of ink with the use of the table of conversion from the viscosity of ink to the throw-on position (count value of the counter) of the doctor roller, and this correction value is stored into the memory M25a.

Then, in Step P51, the table of conversion from the yield value of ink to the throw-on position (count value of the counter) of the doctor roller is loaded from the memory M26a. Then, in Step P52, the yield value of ink is loaded from the memory M8. Then, in Step P53, the seventh correction value (count value of the counter) of the throw-on position of the doctor roller is obtained from the yield value of ink with the use of the table of conversion from the yield value of ink to the throw-on position (count value of the counter) of the doctor roller, and this correction value is stored into the memory M27a.

Then, in Step P54, the table of conversion from the type of the pigment of ink to the throw-on position (count value of the counter) of the doctor roller is loaded from the memory M28a. Then, in Step P55, the type of the pigment of ink is loaded from the memory M9. Then, in Step P56, the eighth correction value (count value of the counter) of the throw-on position of the doctor roller is obtained from the type of the pigment of ink with the use of the table of conversion from the type of the pigment of ink to the throw-on position (count value of the counter) of the doctor roller, and this correction value is stored into the memory M29a.

Then, in Step P57, the table of conversion from the material for the doctor roller to the throw-on position (count value of the counter) of the doctor roller is loaded from the memory M30a. Then, in Step P58, the material for the doctor roller 90 is loaded from the memory M10a. Then, in Step P59, the ninth correction value (count value of the counter) of the throw-on position of the doctor roller is obtained from the material for the doctor roller 90 with the use of the table of conversion from the material for the doctor roller to the throw-on position (count value of the counter) of the doctor roller, and this correction value is stored into the memory M31a.

Then, in Step P60, the material for the doctor roller 90 is loaded from the memory M10a. Then, in Step P61, the table of conversion from the surface hardness of the doctor roller to the throw-on position (count value of the counter) of the doctor roller, which is commensurate with the material for the doctor roller, is loaded from the memory M32a.

Then, in Step P62, the surface hardness of the doctor roller is loaded from the memory M11a. Then, in Step P63, the tenth correction value (count value of the counter) of the throw-on position of the doctor roller is obtained from the surface hardness of the doctor roller with the use of the table of conversion from the surface hardness of the doctor roller to the throw-on position (count value of the counter) of the doctor roller, which is commensurate with the material for the doctor roller, and this correction value is stored into the memory M33a.

Then, in Step P64, the provisional reference throw-on position (count value of the counter) of the doctor roller is loaded from the memory M13a, whereafter, in Step P65, the first correction value (count value of the counter) of the throw-on position of the doctor roller is loaded from the memory M15a. Then, in Step P66, the second correction value (count value of the counter) of the throw-on position of the doctor roller is loaded from the memory M17a.

Then, in Step P67, the third correction value (count value of the counter) of the throw-on position of the doctor roller is loaded from the memory M19a, whereafter, in Step P68, the fourth correction value (count value of the counter) of the throw-on position of the doctor roller is loaded from the memory M21a. Then, in Step P69, the fifth correction value (count value of the counter) of the throw-on position of the doctor roller is loaded from the memory M23a.

Then, in Step P70, the sixth correction value (count value of the counter) of the throw-on position of the doctor roller is loaded from the memory M25a, whereafter, in Step P71, the seventh correction value (count value of the counter) of the throw-on position of the doctor roller is loaded from the memory M27a. Then, in Step P72, the eighth correction value (count value of the counter) of the throw-on position of the doctor roller is loaded from the memory M29a.

Then, in Step P73, the ninth correction value (count value of the counter) of the throw-on position of the doctor roller is loaded from the memory M31a, whereafter, in Step P74, the tenth correction value (count value of the counter) of the throw-on position of the doctor roller is loaded from the memory M33a.

Then, in Step P75, the first correction value (count value of the counter) of the throw-on position of the doctor roller, the second correction value (count value of the counter) of the throw-on position of the doctor roller, the third correction value (count value of the counter) of the throw-on position of the doctor roller, the fourth correction value (count value of the counter) of the throw-on position of the doctor roller, the fifth correction value (count value of the counter) of the throw-on position of the doctor roller, the sixth correction value (count value of the counter) of the throw-on position of the doctor roller, the seventh correction value (count value of the counter) of the throw-on position of the doctor roller, the eighth correction value (count value of the counter) of the throw-on position of the doctor roller, the ninth correction value (count value of the counter) of the throw-on position of the doctor roller, and the tenth correction value (count value of the counter) of the throw-on position of the doctor roller are added to the provisional reference throw-on position (count value of the counter) of the doctor roller to compute the reference throw-on position (count value of the counter) of the doctor roller, and this reference throw-on position (count value of the counter) of the doctor roller is stored into the memory M34a.

In accordance with the above-described motion flow, the throw-on position of the doctor roller 90 during printing is preset, based on the type of the material W to be printed (i.e., difference in the material, e.g., paper, cloth, film or corrugated board), in conformity with the thickness of the material to be printed, the material for the screen printing forme 11c, the thickness of the screen printing forme, the open area rate of the screen printing forme, the mesh size of the screen printing forme 11c, the viscosity of ink, the yield value of ink, the type of the pigment of ink, the material for the doctor roller, and the surface hardness of the doctor roller.

Then, in Step P76, the table of conversion from the material for the screen printing forme to the retreat position (count value of the counter) of the doctor roller is loaded from the memory M35a. Then, in Step P77, the material for the screen printing forme 11c is loaded from the memory M3. Then, in Step P78, the provisional reference retreat position (count value of the counter) of the doctor roller is obtained from the material for the screen printing forme 11c with the use of the table of conversion from the material for the screen printing forme to the retreat position (count value of the counter) of the doctor roller, and is stored into the memory M36a.

Then, in Step P79, the material for the screen printing forme 11c is loaded from the memory M3. Then, in Step P80, the table of conversion from the thickness of the screen printing forme to the retreat position (count value of the counter) of the doctor roller, which is commensurate with the material for the screen printing forme, is loaded from the memory M37a.

Then, in Step P81, the thickness of the screen printing forme is loaded from the memory M4. Then, in Step P82, the first correction value (count value of the counter) of the retreat position of the doctor roller is obtained from the thickness of the screen printing forme with the use of the table of conversion from the thickness of the screen printing forme to the retreat position (count value of the counter) of the doctor roller, which is commensurate with the material for the screen printing forme, and this correction value is stored into the memory M38a.

Then, in Step P83, the material for the screen printing forme 11c is loaded from the memory M3, whereafter, in Step P84, the thickness of the screen printing forme is loaded from the memory M4. Then, in Step P85, the table of conversion from the open area rate of the screen printing forme to the retreat position (count value of the counter) of the doctor roller, which is commensurate with the material for the screen printing forme and the thickness of the screen printing forme, is loaded from the memory M73.

Then, in Step P86, the open area rate of the screen printing forme is loaded from the memory M5a. Then, in Step P87, the second correction value (count value of the counter) of the retreat position of the doctor roller is obtained from the open area rate of the screen printing forme with the use of the table of conversion from the open area rate of the screen printing forme to the retreat position (count value of the counter) of the doctor roller, which is commensurate with the material for the screen printing forme and the thickness of the screen printing forme, and this correction value is stored into the memory M40a.

Then, in Step P88, the material for the screen printing forme is loaded from the memory M3. Then, in Step P89, the thickness of the screen printing forme is loaded from the memory M4. Then, in Step P90, the table of conversion from the mesh size of the screen printing forme to the retreat position (count value of the counter) of the doctor roller, which is commensurate with the material for the screen printing forme and the thickness of the screen printing forme, is loaded from the memory M41a.

Then, in Step P91, the mesh size of the screen printing forme 11c is loaded from the memory M6. Then, in Step P92, the third correction value (count value of the counter) of the retreat position of the doctor roller is obtained from the mesh size of the screen printing forme 11c with the use of the table of conversion from the mesh size of the screen printing forme to the retreat position (count value of the counter) of the doctor roller, which is commensurate with the material for the screen printing forme and the thickness of the screen printing forme, and this correction value is stored into the memory M42a.

Then, in Step P93, the table of conversion from the viscosity of ink to the retreat position (count value of the counter) of the doctor roller is loaded from the memory M43a. Then, in Step P94, the viscosity of ink is loaded from the memory M7. Then, in Step P95, the fourth correction value (count value of the counter) of the retreat position of the doctor roller is obtained from the viscosity of ink with the use of the table of conversion from the viscosity of ink to the retreat position (count value of the counter) of the doctor roller, and this correction value is stored into the memory M44a.

Then, in Step P96, the table of conversion from the yield value of ink to the retreat position (count value of the counter) of the doctor roller is loaded from the memory M45a. Then, in Step P97, the yield value of ink is loaded from the memory M8. Then, in Step P98, the fifth correction value (count value of the counter) of the retreat position of the doctor roller is obtained from the yield value of ink with the use of the table of conversion from the yield value of ink to the retreat position (count value of the counter) of the doctor roller, and this correction value is stored into the memory M46a.

Then, in Step P99, the table of conversion from the type of the pigment of ink to the retreat position (count value of the counter) of the doctor roller is loaded from the memory M47a. Then, in Step P100, the type of the pigment of ink is loaded from the memory M9. Then, in Step P101, the sixth correction value (count value of the counter) of the retreat position of the doctor roller is obtained from the type of the pigment of ink with the use of the table of conversion from the type of the pigment of ink to the retreat position (count value of the counter) of the doctor roller, and this correction value is stored into the memory M48a.

Then, in Step P102, the table of conversion from the material for the doctor roller to the retreat position (count value of the counter) of the doctor roller is loaded from the memory M49a. Then, in Step P103, the material for the doctor roller is loaded from the memory M10a. Then, in Step P104, the seventh correction value (count value of the counter) of the retreat position of the doctor roller is obtained from the material for the doctor roller with the use of the table of conversion from the material for the doctor roller to the retreat position (count value of the counter) of the doctor roller, and this correction value is stored into the memory M50a.

Then, in Step P105, the material for the doctor roller is loaded from the memory M10a. Then, in Step P106, the table of conversion from the surface hardness of the doctor roller to the retreat position (count value of the counter) of the doctor roller, which is commensurate with the material for the doctor roller, is loaded from the memory M51a.

Then, in Step P107, the surface hardness of the doctor roller is loaded from the memory M11a. Then, in Step P108, the eighth correction value (count value of the counter) of the retreat position of the doctor roller is obtained from the surface hardness of the doctor roller with the use of the table of conversion from the surface hardness of the doctor roller to the retreat position (count value of the counter) of the doctor roller, which is commensurate with the material for the doctor roller, and this correction value is stored into the memory M52a.

Then, in Step P109, the provisional reference retreat position (count value of the counter) of the doctor roller is loaded from the memory M36a, whereafter, in Step P110, the first correction value (count value of the counter) of the retreat position of the doctor roller is loaded from the memory M38a. Then, in Step P111, the second correction value (count value of the counter) of the retreat position of the doctor roller is loaded from the memory M40a.

Then, in Step P112, the third correction value (count value of the counter) of the retreat position of the doctor roller is loaded from the memory M42a, whereafter, in Step P113, the fourth correction value (count value of the counter) of the retreat position of the doctor roller is loaded from the memory M44a. Then, in Step P114, the fifth correction value (count value of the counter) of the retreat position of the doctor roller is loaded from the memory M46a.

Then, in Step P115, the sixth correction value (count value of the counter) of the retreat position of the doctor roller is loaded from the memory M48a, whereafter, in Step P116, the seventh correction value (count value of the counter) of the retreat position of the doctor roller is loaded from the memory M50a. Then, in Step P117, the eighth correction value (count value of the counter) of the retreat position of the doctor roller is loaded from the memory M52a.

Then, in Step P118, the first correction value (count value of the counter) of the retreat position of the doctor roller, the second correction value (count value of the counter) of the retreat position of the doctor roller, the third correction value (count value of the counter) of the retreat position of the doctor roller, the fourth correction value (count value of the counter) of the retreat position of the doctor roller, the fifth correction value (count value of the counter) of the retreat position of the doctor roller, the sixth correction value (count value of the counter) of the retreat position of the doctor roller, the seventh correction value (count value of the counter) of the retreat position of the doctor roller, and the eighth correction value (count value of the counter) of the retreat position of the doctor roller are added to the provisional reference retreat position (count value of the counter) of the doctor roller to compute the reference retreat position (count value of the counter) of the doctor roller. This reference retreat position (count value of the counter) of the doctor roller is stored into the memory M53a. The reference retreat position (count value of the counter) of the doctor roller obtained is a position closer to the throw-off position of the doctor roller than to the reference throw-on position of the doctor roller obtained in Step P75, in other words, a position at which the doctor roller 90 does not leave the inner peripheral surface of the screen printing forme 11c, and its pressing force decreases.

In accordance with the above-described motion flow, the retreat position of the doctor roller 90 when opposing the notch 13b of the impression cylinder 13 (in other words, the pressing force acting on the inner peripheral surface of the screen printing forme 11c) is preset, based on the material for the screen printing forme 11c, in conformity with the thickness of the screen printing forme, the open area rate of the screen printing forme, the mesh size of the screen printing forme 11c, the viscosity of ink, the yield value of ink, the type of the pigment of ink, the material for the doctor roller, and the surface hardness of the doctor roller.

Then, in Step P119, it is determined whether the doctor roller throw-on and throw-off automatic control switch 52a is OFF. If the answer is Y (yes), the program shifts to Step P291 to be described later. If the answer is N (no), it is determined, in Step P120, whether a cylinder engagement signal from the cylinder engagement circuit 78 for the rotary screen cylinder is ON.

If the answer is Y in the above Step P120, the program shifts to Step P160 to be described later. If the answer is N, the throw-off position (count value of the counter) of the doctor roller is loaded from the memory M54a in Step P121.

Then, in Step P122, the count value is loaded from the counter 68a for detecting the current position of the left side of the doctor roller, and stored into the memory M62a. Then follows Step P123 in which the count value of the counter for detecting the current position of the left side of the doctor roller is subtracted from the throw-off position (count value of the counter) of the doctor roller to compute the amount of movement of the left side of the doctor roller, which is stored into the memory M74.

Then, in Step P124, the count value is loaded from the counter 72a for detecting the current position of the right side of the doctor roller, and stored into the memory M63a. Then follows Step P125 in which the count value of the counter for detecting the current position of the right side of the doctor roller is subtracted from the throw-off position (count value of the counter) of the doctor roller to compute the amount of movement of the right side of the doctor roller, which is stored into the memory M75.

Then, in Step P126, the count value is loaded from the counter 74 for detecting the rotation phase of the rotary screen cylinder, and stored into the memory M68. Then, in Step P127, the rotation phase of the rotary screen cylinder during doctor roller throw-off is loaded from the memory M58a.

Then, in Step P128, it is determined whether the count value of the counter for detecting the rotation phase of the rotary screen cylinder is equal to the rotation phase of the rotary screen cylinder during doctor roller throw-off. If the answer is N, the program returns to Step P126 mentioned above. If the answer is Y, Step P129 is executed in which the memory M60a for storing the presence or absence of rotation of the stepping motor for adjusting the left side is overwritten with 0. Then, in Step P130, the memory M61a for storing the presence or absence of rotation of the stepping motor for adjusting the right side is overwritten with 0.

Then, in Step P131, the amount of movement of the left side of the doctor roller is loaded from the memory M74. Then, in Step P132, it is determined whether the amount of movement of the left side of the doctor roller is equal to 0. If the answer is Y in Step P132, the program shifts to Step P137 to be described later. If the answer is N in Step P132, the memory M60a for storing the presence or absence of rotation of the stepping motor for adjusting the left side is overwritten with 1 in Step P133.

Then, in Step P134, it is determined whether the amount of movement of the left side of the doctor roller is larger than 0. If the answer is Y in Step P134, Step P135 is executed to compute the absolute value of the amount of movement of the left side of the doctor roller from the amount of movement of the left side of the doctor roller, and store it into the memory M76. Then, in Step P136, a normal rotation pulse outputting command corresponding to the absolute value of the amount of movement of the left side of the doctor roller is outputted to the driver 66a for the stepping motor for adjusting the left side. Then, the program proceeds to the aforementioned Step P137.

If the answer is N in the above Step P134, Step P138 is executed to compute the absolute value of the amount of movement of the left side of the doctor roller from the amount of movement of the left side of the doctor roller, and store it into the memory M76. Then, in Step P139, a reverse rotation pulse outputting command corresponding to the absolute value of the amount of movement of the left side of the doctor roller is outputted to the driver 66a for the stepping motor for adjusting the left side. Then, the program shifts to the aforementioned Step P137.

Then, in the above Step P137, the amount of movement of the right side of the doctor roller is loaded from the memory M75. Then, in Step P140, it is determined whether the amount of movement of the right side of the doctor roller is equal to 0. If the answer is Y in Step P140, the program shifts to Step P145 to be described later. If the answer is N in Step P140, the memory M61a for storing the presence or absence of rotation of the stepping motor for adjusting the right side is overwritten with 1 in Step P141.

Then, in Step P142, it is determined whether the amount of movement of the right side of the doctor roller is larger than 0. If the answer is Y in Step P142, Step P143 is executed to compute the absolute value of the amount of movement of the right side of the doctor roller from the amount of movement of the right side of the doctor roller, and store it into the memory M77. Then, in Step P144, a normal rotation pulse outputting command corresponding to the absolute value of the amount of movement of the right side of the doctor roller is outputted to the driver 70a for the stepping motor for adjusting the right side. Then, the program proceeds to Step P145.

If the answer is N in the above Step P142, Step P146 is executed to compute the absolute value of the amount of movement of the right side of the doctor roller from the amount of movement of the right side of the doctor roller, and store it into the memory M77. Then, in Step P147, a reverse rotation pulse outputting command corresponding to the absolute value of the amount of movement of the right side of the doctor roller is outputted to the driver 70a for the stepping motor for adjusting the right side. Then, the program shifts to the aforementioned Step P145.

Subsequently, in Step P145, the value of the memory M60a for storing the presence or absence of rotation of the stepping motor for adjusting the left side is loaded. Then, in Step P148, it is determined whether the value of the memory for storing the presence or absence of rotation of the stepping motor for adjusting the left side is equal to 0. If the answer is Y in Step P148, the value of the memory M61a for storing the presence or absence of rotation of the stepping motor for adjusting the right side is loaded in Step P149. If the answer is N in Step P148, the program shifts to Step P152 to be described later.

Then, in Step P150, it is determined whether the value of the memory for storing the presence or absence of rotation of the stepping motor for adjusting the right side is equal to 0. If the answer is Y in Step P150, outputting of the enabling signal to the counter 76a for counting the total number of revolutions during doctor roller throw-on is stopped in Step P151, and the program returns to Step P119. If the answer is N in Step P150, the aforementioned Step P152 is executed to load the count value from the counter 68a for detecting the current position of the left side of the doctor roller, and store it into the memory M62a.

Then, in Step P153, the throw-off position (count value of the counter) of the doctor roller is loaded from the memory M54a. Then, in Step P154, it is determined whether the count value of the counter for detecting the current position of the left side of the doctor roller is equal to the throw-off position (count value of the counter) of the doctor roller. If the answer is Y, the memory M60a for storing the presence or absence of rotation of the stepping motor for adjusting the left side is overwritten with 0 in Step P155, and the program proceeds to Step P156. If the answer is N, the program directly shifts to Step P156.

Then, in the above Step P156, the count value is loaded from the counter 72a for detecting the current position of the right side of the doctor roller, and stored into the memory M63a. Then, in Step P157, the throw-off position (count value of the counter) of the doctor roller is loaded from the memory M54a.

Then, in Step P158, it is determined whether the count value of the counter 72a for detecting the current position of the right side of the doctor roller is equal to the throw-off position (count value of the counter) of the doctor roller. If the answer is Y, the memory M61a for storing the presence or absence of rotation of the stepping motor for adjusting the right side is overwritten with 0 in Step P159, and the program returns to Step P145. If the answer is N, the program directly returns to Step P145.

In accordance with the above-described motion flow, when the doctor roller throw-on and throw-off automatic control switch 52a is ON and the cylinder engagement signal for the rotary screen cylinder 11 is OFF, the doctor roller 90 is moved to the throw-off position.

Then, in Step P160 shifted from the aforementioned Step P120, the table of conversion from the total number of revolutions during doctor roller throw-on to the correction amount (count value of the counter) of the doctor roller position is loaded from the memory M64a. Then, in Step P161, the count value is loaded from the counter 76a for counting the total number of revolutions during doctor roller throw-on, and stored into the memory M65a.

Then, in Step P162, the correction amount (count value of the counter) of the doctor roller position is obtained from the count value of the counter 76a for counting the total number of revolutions during doctor roller throw-on, with the use of the table of conversion from the total number of revolutions during doctor roller throw-on to the correction amount (count value of the counter) of the doctor roller position, and this correction amount is stored into the memory M66a. Then, in Step P163, the reference retreat position (count value of the counter) of the doctor roller is loaded from the memory M53a.

Then, in Step P164, the correction amount (count value of the counter) of the doctor roller position is loaded from the memory M66a. Then, in Step P165, the correction amount (count value of the counter) of the doctor roller position is added to the reference retreat position (count value of the counter) of the doctor roller to compute the retreat position (count value of the counter) of the doctor roller, which is stored into the memory M67a.

Then, in Step P166, the count value is loaded from the counter 68a for detecting the current position of the left side of the doctor roller, and stored into the memory M62a. Then follows Step P167 in which the count value of the counter for detecting the current position of the left side of the doctor roller is subtracted from the retreat position (count value of the counter) of the doctor roller to compute the amount of movement of the left side of the doctor roller, which is stored into the memory M74.

Then, in Step P168, the count value is loaded from the counter 72a for detecting the current position of the right side of the doctor roller, and stored into the memory M63a. Then follows Step P169 in which the count value of the counter for detecting the current position of the right side of the doctor roller is subtracted from the retreat position (count value of the counter) of the doctor roller to compute the amount of movement of the right side of the doctor roller, which is stored into the memory M75.

Then, in Step P170, the count value is loaded from the counter 74 for detecting the rotation phase of the rotary screen cylinder, and stored into the memory M68. Then, in Step P171, the rotation phase of the rotary screen cylinder during doctor roller throw-on is loaded from the memory M69a.

Then, in Step P172, it is determined whether the count value of the counter for detecting the rotation phase of the rotary screen cylinder is equal to the rotation phase of the rotary screen cylinder during doctor roller throw-off. If the answer is N, the program returns to Step P170 mentioned above. If the answer is Y, Step P173 is executed in which the memory M60a for storing the presence or absence of rotation of the stepping motor for adjusting the left side is overwritten with 0. Then, in Step P174, the memory M61a for storing the presence or absence of rotation of the stepping motor for adjusting the right side is overwritten with 0.

Then, in Step P175, the amount of movement of the left side of the doctor roller is loaded from the memory M74. Then, in Step P176, it is determined whether the amount of movement of the left side of the doctor roller is equal to 0. If the answer is Y in Step P176, the program shifts to Step P181 to be described later. If the answer is N in Step P177, the memory M60a for storing the presence or absence of rotation of the stepping motor for adjusting the left side is overwritten with 1 in Step P177.

Then, in Step P178, it is determined whether the amount of movement of the left side of the doctor roller is larger than 0. If the answer is Y in Step P178, Step P179 is executed to compute the absolute value of the amount of movement of the left side of the doctor roller from the amount of movement of the left side of the doctor roller, and store it into the memory M76. Then, in Step P180, a normal rotation pulse outputting command corresponding to the absolute value of the amount of movement of the left side of the doctor roller is outputted to the driver 66a for the stepping motor for adjusting the left side. Then, the program proceeds to Step P181.

If the answer is N in Step P178, Step P182 is executed to compute the absolute value of the amount of movement of the left side of the doctor roller from the amount of movement of the left side of the doctor roller, and store it into the memory M76. Then, in Step P183, a reverse rotation pulse outputting command corresponding to the absolute value of the amount of movement of the left side of the doctor roller is outputted to the driver 66a for the stepping motor for adjusting the left side. Then, the program shifts to the aforementioned Step P181.

Then, in the above Step P181, the amount of movement of the right side of the doctor roller is loaded from the memory M75. Then, in Step P184, it is determined whether the amount of movement of the right side of the doctor roller is equal to 0. If the answer is Y in Step P184, the program shifts to Step P189 to be described later. If the answer is N in Step P184, the memory M61a for storing the presence or absence of rotation of the stepping motor for adjusting the right side is overwritten with 1 in Step P185.

Then, in Step P186, it is determined whether the amount of movement of the right side of the doctor roller is larger than 0. If the answer is Y in Step P186, Step P187 is executed to compute the absolute value of the amount of movement of the right side of the doctor roller from the amount of movement of the right side of the doctor roller, and store it into the memory M77. Then, in Step P188, a normal rotation pulse outputting command corresponding to the absolute value of the amount of movement of the right side of the doctor roller is outputted to the driver 70a for the stepping motor for adjusting the right side. Then, the program proceeds to Step P189.

If the answer is N in Step P186, Step P190 is executed to compute the absolute value of the amount of movement of the right side of the doctor roller from the amount of movement of the right side of the doctor roller, and store it into the memory M77. Then, in Step P191, a reverse rotation pulse outputting command corresponding to the absolute value of the amount of movement of the right side of the doctor roller is outputted to the driver 70a for the stepping motor for adjusting the right side. Then, the program shifts to the aforementioned Step P189.

Subsequently, in the above Step P189, the value of the memory M60a for storing the presence or absence of rotation of the stepping motor for adjusting the left side is loaded. Then, in Step P192, it is determined whether the value of the memory for storing the presence or absence of rotation of the stepping motor for adjusting the left side is equal to 0. If the answer is Y in Step P192, the value of the memory M61a for storing the presence or absence of rotation of the stepping motor for adjusting the right side is loaded in Step P193. If the answer is N, the program shifts to Step P196 to be described later.

Subsequently, in Step P194, it is determined whether the value of the memory for storing the presence or absence of rotation of the stepping motor for adjusting the right side is equal to 0. If the answer is Y, Step P195 is executed to output an enabling signal to the counter 76a for counting the total number of revolutions during doctor roller throw-on, and the program shifts to Step P204 to be described later. If the answer is N, the aforementioned Step P196 is executed to load the count value from the counter 68a for detecting the current position of the left side of the doctor roller, and store it into the memory M62a.

Then, in Step P197, the retreat position (count value of the counter) of the doctor roller is loaded from the memory M67a. Then, in Step P198, it is determined whether the count value of the counter for detecting the current position of the left side of the doctor roller is equal to the retreat position (count value of the counter) of the doctor roller. If the answer is Y, the memory M60a for storing the presence or absence of rotation of the stepping motor for adjusting the left side is overwritten with 0 in Step P199, and the program proceeds to Step P200. If the answer is N, the program directly shifts to Step P200.

Then, in the aforementioned Step P200, the count value is loaded from the counter 72a for detecting the current position of the right side of the doctor roller, and stored into the memory M63a. Then, in Step P201, the retreat position (count value of the counter) of the doctor roller is loaded from the memory M67a.

Then, in Step P202, it is determined whether the count value of the counter 72a for detecting the current position of the right side of the doctor roller is equal to the retreat position (count value of the counter) of the doctor roller. If the answer is Y, the memory M61a for storing the presence or absence of rotation of the stepping motor for adjusting the right side is overwritten with 0 in Step P203, and the program returns to Step P189. If the answer is N, the program directly returns to Step P189.

In accordance with the above-described motion flow, when the doctor roller throw-on and throw-off automatic control switch 52a is ON and the cylinder engagement signal for the rotary screen cylinder 11 is ON, the doctor roller 90 is moved to the predetermined retreat position when it opposes the notch 13b of the impression cylinder 13.

Then, in Step P204 shifted from the aforementioned Step P195, the table of conversion from the total number of revolutions during doctor roller throw-on to the correction amount (count value of the counter) of the doctor roller position is loaded from the memory M64a. Then, in Step P205, the count value is loaded from the counter 76a for counting the total number of revolutions during doctor roller throw-on, and stored into the memory M65a.

Then, in Step P206, the correction amount (count value of the counter) of the doctor roller position is obtained from the count value of the counter 76a for counting the total number of revolutions during doctor roller throw-on, with the use of the table of conversion from the total number of revolutions during doctor roller throw-on to the correction amount (count value of the counter) of the doctor roller position, and this correction amount is stored into the memory M66a. Then, in Step P207, the reference throw-on position (count value of the counter) of the doctor roller is loaded from the memory M34a.

Then, in Step P208, the correction amount (count value of the counter) of the doctor roller position is loaded from the memory M66a. Then, in Step P209, the correction amount (count value of the counter) of the doctor roller position is added to the reference throw-on position (count value of the counter) of the doctor roller to compute the printing position (count value of the counter) of the doctor roller, which is stored into the memory M70a.

Then, in Step P210, the count value is loaded from the counter 68a for detecting the current position of the left side of the doctor roller, and stored into the memory M62a. Then, in Step P211, the count value of the counter for detecting the current position of the left side of the doctor roller is subtracted from the printing position (count value of the counter) of the doctor roller to compute the amount of movement of the left side of the doctor roller, which is stored into the memory M74.

Then, in Step P212, the count value is loaded from the counter 72a for detecting the current position of the right side of the doctor roller, and stored into the memory M63a. Then, in Step P213, the count value of the counter for detecting the current position of the right side of the doctor roller is subtracted from the printing position (count value of the counter) of the doctor roller to compute the amount of movement of the right side of the doctor roller, which is stored into the memory M75.

Then, in Step P214, the count value is loaded from the counter 74 for detecting the rotation phase of the rotary screen cylinder, and stored into the memory M68. Then, in Step P215, the rotation phase of the rotary screen cylinder at the position of the rear end of the notch of the impression cylinder is loaded from the memory M78.

Then, in Step P216, it is determined whether the count value of the counter for detecting the rotation phase of the rotary screen cylinder is equal to the rotation phase of the rotary screen cylinder at the position of the rear end of the notch of the impression cylinder. If the answer is N, the program returns to Step P214 mentioned above. If the answer is Y, the memory M60a for storing the presence or absence of rotation of the stepping motor for adjusting the left side is overwritten with 0 in Step P217. Subsequently, in Step P218, the memory M61a for storing the presence or absence of rotation of the stepping motor for adjusting the right side is overwritten with 0.

Then, in Step P219, the amount of movement of the left side of the doctor roller is loaded from the memory M74. Then, in Step P220, it is determined whether the amount of movement of the left side of the doctor roller is equal to 0. If the answer is Y in Step P220, the program shifts to Step P225 to be described later. If the answer is N in Step P220, the memory M60a for storing the presence or absence of rotation of the stepping motor for adjusting the left side is overwritten with 1 in Step P221.

Then, in Step P222, it is determined whether the amount of movement of the left side of the doctor roller is larger than 0. If the answer is Y in Step P222, Step P223 is executed to compute the absolute value of the amount of movement of the left side of the doctor roller from the amount of movement of the left side of the doctor roller, and store it into the memory M76. Then, in Step P224, a normal rotation pulse outputting command corresponding to the absolute value of the amount of movement of the left side of the doctor roller is outputted to the driver 66a for the stepping motor for adjusting the left side. Then, the program proceeds to the aforementioned Step P225.

If the answer is N in Step P222, Step P226 is executed to compute the absolute value of the amount of movement of the left side of the doctor roller from the amount of movement of the left side of the doctor roller, and store it into the memory M76. Then, in Step P227, a reverse rotation pulse outputting command corresponding to the absolute value of the amount of movement of the left side of the doctor roller is outputted to the driver 66a for the stepping motor for adjusting the left side. Then, the program shifts to the aforementioned Step P225.

Then, in the above Step P225, the amount of movement of the right side of the doctor roller is loaded from the memory M75. Then, in Step P228, it is determined whether the amount of movement of the right side of the doctor roller is equal to 0. If the answer is Y in Step P228, the program shifts to Step P233 to be described later. If the answer is N in Step P228, the memory M61a for storing the presence or absence of rotation of the stepping motor for adjusting the right side is overwritten with 1 in Step P229.

Then, in Step P230, it is determined whether the amount of movement of the right side of the doctor roller is larger than 0. If the answer is Y in Step P230, Step P231 is executed to compute the absolute value of the amount of movement of the right side of the doctor roller from the amount of movement of the right side of the doctor roller, and store it into the memory M77. Then, in Step P232, a normal rotation pulse outputting command corresponding to the absolute value of the amount of movement of the right side of the doctor roller is outputted to the driver 70a for the stepping motor for adjusting the right side. Then, the program proceeds to the aforementioned Step P233.

If the answer is N in the above Step P230, Step P234 is executed to compute the absolute value of the amount of movement of the right side of the doctor roller from the amount of movement of the right side of the doctor roller, and store it into the memory M77. Then, in Step P235, a reverse rotation pulse outputting command corresponding to the absolute value of the amount of movement of the right side of the doctor roller is outputted to the driver 70a for the stepping motor for adjusting the right side. Then, the program shifts to the aforementioned Step P233.

Subsequently, in the above Step P233, the value of the memory M60a for storing the presence or absence of rotation of the stepping motor for adjusting the left side is loaded. Then, in Step P236, it is determined whether the value of the memory for storing the presence or absence of rotation of the stepping motor for adjusting the left side is equal to 0. If the answer is Y in Step P236, the value of the memory M61a for storing the presence or absence of rotation of the stepping motor for adjusting the right side is loaded in Step P237. If the answer is N, the program shifts to Step P239 to be described later.

Then, in Step P238, it is determined whether the value of the memory for storing the presence or absence of rotation of the stepping motor for adjusting the right side is equal to 0. If the answer is Y in Step P238, the program shifts to Step P247 to be described later. If the answer is N in Step P238, the aforementioned Step P239 is executed to load the count value from the counter 68a for detecting the current position of the left side of the doctor roller, and store it into the memory M62a.

Then, in Step P240, the printing position (count value of the counter) of the doctor roller is loaded from the memory M70a. Then, in Step P241, it is determined whether the count value of the counter for detecting the current position of the left side of the doctor roller is equal to the printing position (count value of the counter) of the doctor roller. If the answer is Y, the memory M60a for storing the presence or absence of rotation of the stepping motor for adjusting the left side is overwritten with 0 in Step P242, and the program proceeds to Step P243. If the answer is N in Step P241, the program directly shifts to Step P243.

Then, in the aforementioned Step P243, the count value is loaded from the counter 72a for detecting the current position of the right side of the doctor roller, and stored into the memory M63a. Then, in Step P244, the printing position (count value of the counter) of the doctor roller is loaded from the memory M70a.

Then, in Step P245, it is determined whether the count value of the counter 72a for detecting the current position of the right side of the doctor roller is equal to the printing position (count value of the counter) of the doctor roller. If the answer is Y, the memory M61a for storing the presence or absence of rotation of the stepping motor for adjusting the right side is overwritten with 0 in Step P246, and the program returns to Step P233. If the answer is N in Step P245, the program directly returns to Step P233.

In accordance with the above-described motion flow, when the doctor roller throw-on and throw-off automatic control switch 52a is ON and the cylinder engagement signal for the rotary screen cylinder 11 is ON, the doctor roller 90 is moved to the predetermined printing position when it enters the rotation phase of the rotary screen cylinder 11 corresponding to the position of the rear end of the notch of the impression cylinder 13.

Then, in Step P247 shifted from the aforementioned Step P238, the table of conversion from the total number of revolutions during doctor roller throw-on to the correction amount (count value of the counter) of the doctor roller position is loaded from the memory M64a. Then, in Step P248, the count value is loaded from the counter 76a for counting the total number of revolutions during doctor roller throw-on, and stored into the memory M65a.

Then, in Step P249, the correction amount (count value of the counter) of the doctor roller position is obtained from the count value of the counter 76a for counting the total number of revolutions during doctor roller throw-on, with the use of the table of conversion from the total number of revolutions during doctor roller throw-on to the correction amount (count value of the counter) of the doctor roller position, and this correction amount is stored into the memory M66a. Then, in Step P250, the reference retreat position (count value of the counter) of the doctor roller is loaded from the memory M53a.

Then, in Step P251, the correction amount (count value of the counter) of the doctor roller position is loaded from the memory M66a. Then, in Step P252, the correction amount (count value of the counter) of the doctor roller position is added to the reference retreat position (count value of the counter) of the doctor roller to compute the retreat position (count value of the counter) of the doctor roller, which is stored into the memory M67a.

Then, Step P253 is executed to load the count value from the counter 68a for detecting the current position of the left side of the doctor roller, and store it into the memory M62a. Then, in Step P254, the count value of the counter for detecting the current position of the left side of the doctor roller is subtracted from the retreat position (count value of the counter) of the doctor roller to compute the amount of movement of the left side of the doctor roller, which is stored into the memory M74.

Then, Step P255 is executed to load the count value from the counter 72a for detecting the current position of the right side of the doctor roller, and store it into the memory M63a. Then, in Step P256, the count value of the counter for detecting the current position of the right side of the doctor roller is subtracted from the retreat position (count value of the counter) of the doctor roller to compute the amount of movement of the right side of the doctor roller, which is stored into the memory M75.

Then, in Step P257, the count value is loaded from the counter 74 for detecting the rotation phase of the rotary screen cylinder, and stored into the memory M68. Then, in Step P258, the rotation phase of the rotary screen cylinder at the position of the leading end of the notch of the impression cylinder is loaded from the memory M71.

Then, in Step P259, it is determined whether the count value of the counter for detecting the rotation phase of the rotary screen cylinder is equal to the rotation phase of the rotary screen cylinder at the position of the leading end of the notch of the impression cylinder. If the answer is N, the program returns to Step P257 mentioned above. If the answer is Y, the memory M60a for storing the presence or absence of rotation of the stepping motor for adjusting the left side is overwritten with 0 in Step P260. Then, in Step P261, the memory M61a for storing the presence or absence of rotation of the stepping motor for adjusting the right side is overwritten with 0.

Then, in Step P262, the amount of movement of the left side of the doctor roller is loaded from the memory M74. Then, in Step P263, it is determined whether the amount of movement of the left side of the doctor roller is equal to 0. If the answer is Y in Step P263, the program shifts to Step P268 to be described later. If the answer is N in Step P263, the memory M60a for storing the presence or absence of rotation of the stepping motor for adjusting the left side is overwritten with 1 in Step P264.

Then, in Step P265, it is determined whether the amount of movement of the left side of the doctor roller is larger than 0. If the answer is Y in Step P265, Step P266 is executed to compute the absolute value of the amount of movement of the left side of the doctor roller from the amount of movement of the left side of the doctor roller, and store it into the memory M76. Then, in Step P267, a normal rotation pulse outputting command corresponding to the absolute value of the amount of movement of the left side of the doctor roller is outputted to the driver 66a for the stepping motor for adjusting the left side. Then, the program proceeds to the aforementioned Step P268.

If the answer is N in the above Step P265, Step P269 is executed to compute the absolute value of the amount of movement of the left side of the doctor roller from the amount of movement of the left side of the doctor roller, and store it into the memory M76. Then, in Step P270, a reverse rotation pulse outputting command corresponding to the absolute value of the amount of movement of the left side of the doctor roller is outputted to the driver 66a for the stepping motor for adjusting the left side. Then, the program shifts to the aforementioned Step P268.

Then, in the aforementioned Step P268, the amount of movement of the right side of the doctor roller is loaded from the memory M75. Then, in Step P271, it is determined whether the amount of movement of the right side of the doctor roller is equal to 0. If the answer is Y in Step P271, the program shifts to Step P276 to be described later. If the answer is N in Step P271, the memory M61a for storing the presence or absence of rotation of the stepping motor for adjusting the right side is overwritten with 1 in Step P272.

Then, in Step P273, it is determined whether the amount of movement of the right side of the doctor roller is larger than 0. If the answer is Y in Step P273, Step P274 is executed to compute the absolute value of the amount of movement of the right side of the doctor roller from the amount of movement of the right side of the doctor roller, and store it into the memory M77. Then, in Step P275, a normal rotation pulse outputting command corresponding to the absolute value of the amount of movement of the right side of the doctor roller is outputted to the driver 70a for the stepping motor for adjusting the right side. Then, the program proceeds to the aforementioned Step P276.

If the answer is N in the above Step P273, Step P277 is executed to compute the absolute value of the amount of movement of the right side of the doctor roller from the amount of movement of the right side of the doctor roller, and store it into the memory M77. Then, in Step P278, a reverse rotation pulse outputting command corresponding to the absolute value of the amount of movement of the right side of the doctor roller is outputted to the driver 70a for the stepping motor for adjusting the right side. Then, the program shifts to the aforementioned Step P276.

Subsequently, in the aforementioned Step P276, the value of the memory M60a for storing the presence or absence of rotation of the stepping motor for adjusting the left side is loaded. Then, in Step P279, it is determined whether the value of the memory for storing the presence or absence of rotation of the stepping motor for adjusting the left side is equal to 0. If the answer is Y in Step P279, the value of the memory M61a for storing the presence or absence of rotation of the stepping motor for adjusting the right side is loaded in Step P280. If the answer is N in Step P279, the program shifts to Step P283 to be described later.

Subsequently, in Step P281, it is determined whether the value of the memory for storing the presence or absence of rotation of the stepping motor for adjusting the right side is equal to 0. If the answer is Y in Step P281, Step P282 is executed to determine whether the cylinder engagement signal for the rotary screen cylinder is ON. If the answer is Y, the program returns to Step P204. If the answer is N, the program returns to Step P121.

If the answer is N in the aforementioned Step P281, the count value is loaded from the counter 68a for detecting the current position of the left side of the doctor roller, and stored into the memory M62a, in the aforementioned Step P283.

Then, in Step P284, the retreat position (count value of the counter) of the doctor roller is loaded from the memory M67a. Then, in Step P285, it is determined whether the count value of the counter for detecting the current position of the left side of the doctor roller is equal to the retreat position (count value of the counter) of the doctor roller. If the answer is Y, the memory M60a for storing the presence or absence of rotation of the stepping motor for adjusting the left side is overwritten with 0 in Step P286, and the program proceeds to Step P287. If the answer is N, the program directly shifts to Step P287.

Then, in the aforementioned Step P287, the count value is loaded from the counter 72a for detecting the current position of the right side of the doctor roller, and stored into the memory M63a. Then, in Step P288, the retreat position (count value of the counter) of the doctor roller is loaded from the memory M67a.

Then, in Step P289, it is determined whether the count value of the counter 72a for detecting the current position of the right side of the doctor roller is equal to the retreat position (count value of the counter) of the doctor roller. If the answer is Y, the memory M61a for storing the presence or absence of rotation of the stepping motor for adjusting the right side is overwritten with 0 in Step P290, and the program returns to Step P276. If the answer is N, the program directly returns to Step P276.

In accordance with the above-described motion flow, when the doctor roller throw-on and throw-off automatic control switch 52a is ON and the cylinder engagement signal for the rotary screen cylinder 11 is ON, the doctor roller 90 is moved to the predetermined retreat position when it enters the rotation phase of the rotary screen cylinder 11 corresponding to the position of the leading end of the notch of the impression cylinder 13.

Then, in Step P291 shifted from the aforementioned Step P119, the throw-off position (count value of the counter) of the doctor roller is loaded from the memory M54a.

Then, Step P292 is executed to load the count value from the counter 68a for detecting the current position of the left side of the doctor roller, and store it into the memory M62a. Then, in Step P293, the count value of the counter for detecting the current position of the left side of the doctor roller is subtracted from the throw-off position (count value of the counter) of the doctor roller to compute the amount of movement of the left side of the doctor roller, which is stored into the memory M74.

Then, Step P294 is executed to load the count value from the counter 72a for detecting the current position of the right side of the doctor roller, and store it into the memory M63a. Then, in Step P295, the count value of the counter for detecting the current position of the right side of the doctor roller is subtracted from the throw-off position (count value of the counter) of the doctor roller to compute the amount of movement of the right side of the doctor roller, which is stored into the memory M75.

Then, in Step P296, the count value is loaded from the counter 74 for detecting the rotation phase of the rotary screen cylinder, and stored into the memory M68. Then, in Step P297, the rotation phase of the rotary screen cylinder during doctor roller throw-off is loaded from the memory M58a.

Then, in Step P298, it is determined whether the count value of the counter for detecting the rotation phase of the rotary screen cylinder is equal to the rotation phase of the rotary screen cylinder during doctor roller throw-off. If the answer is N, the program returns to Step P296 mentioned above. If the answer is Y, the memory M60a for storing the presence or absence of rotation of the stepping motor for adjusting the left side is overwritten with 0 in Step P299. Then, in Step P300, the memory M61a for storing the presence or absence of rotation of the stepping motor for adjusting the right side is overwritten with 0.

Then, in Step P301, the amount of movement of the left side of the doctor roller is loaded from the memory M74. Then, in Step P302, it is determined whether the amount of movement of the left side of the doctor roller is equal to 0. If the answer is Y in Step P302, the program shifts to Step P307 to be described later. If the answer is N in Step P302, the memory M60a for storing the presence or absence of rotation of the stepping motor for adjusting the left side is overwritten with 1 in Step P303.

Then, in Step P304, it is determined whether the amount of movement of the left side of the doctor roller is larger than 0. If the answer is Y in Step P304, Step P305 is executed to compute the absolute value of the amount of movement of the left side of the doctor roller from the amount of movement of the left side of the doctor roller, and store it into the memory M76. Then, in Step P306, a normal rotation pulse outputting command corresponding to the absolute value of the amount of movement of the left side of the doctor roller is outputted to the driver 66a for the stepping motor for adjusting the left side. Then, the program proceeds to the aforementioned Step P307.

If the answer is N in the aforementioned Step P304, Step P308 is executed to compute the absolute value of the amount of movement of the left side of the doctor roller from the amount of movement of the left side of the doctor roller, and store it into the memory M76. Then, in Step P309, a reverse rotation pulse outputting command corresponding to the absolute value of the amount of movement of the left side of the doctor roller is outputted to the driver 66a for the stepping motor for adjusting the left side. Then, the program shifts to Step P307 mentioned above.

Then, in the above Step P307, the amount of movement of the right side of the doctor roller is loaded from the memory M75. Then, in Step P310, it is determined whether the amount of movement of the right side of the doctor roller is equal to 0. If the answer is Y in Step P310, the program shifts to Step P315 to be described later. If the answer is N in Step P310, the memory M61a for storing the presence or absence of rotation of the stepping motor for adjusting the right side is overwritten with 1 in Step P311.

Then, in Step P312, it is determined whether the amount of movement of the right side of the doctor roller is larger than 0. If the answer is Y in Step P312, Step P313 is executed to compute the absolute value of the amount of movement of the right side of the doctor roller from the amount of movement of the right side of the doctor roller, and store it into the memory M77. Then, in Step P314, a normal rotation pulse outputting command corresponding to the absolute value of the amount of movement of the right side of the doctor roller is outputted to the driver 70a for the stepping motor for adjusting the right side. Then, the program proceeds to the aforementioned Step P315.

If the answer is N in the aforementioned Step P312, Step P316 is executed to compute the absolute value of the amount of movement of the right side of the doctor roller from the amount of movement of the right side of the doctor roller, and store it into the memory M77. Then, in Step P317, a reverse rotation pulse outputting command corresponding to the absolute value of the amount of movement of the right side of the doctor roller is outputted to the driver 70a for the stepping motor for adjusting the right side. Then, the program shifts to the aforementioned Step P315.

Subsequently, in the above Step P315, the value of the memory M60a for storing the presence or absence of rotation of the stepping motor for adjusting the left side is loaded. Then, in Step P318, it is determined whether the value of the memory for storing the presence or absence of rotation of the stepping motor for adjusting the left side is equal to 0. If the answer is Y in Step P318, the value of the memory M61a for storing the presence or absence of rotation of the stepping motor for adjusting the right side is loaded in Step P319. If the answer is N in Step P318, the program shifts to Step P322 to be described later.

Subsequently, in Step P320, it is determined whether the value of the memory for storing the presence or absence of rotation of the stepping motor for adjusting the right side is equal to 0. If the answer is Y in Step P320, Step P321 is executed to stop the outputting of the enabling signal to the counter 76a for counting the total number of revolutions during doctor roller throw-on. Then, the program returns to Step P1. If the answer is N in Step P320, the aforementioned Step P322 is executed to load the count value from the counter 68a for detecting the current position of the left side of the doctor roller, and store it into the memory M62a.

Then, in Step P323, the throw-off position (count value of the counter) of the doctor roller is loaded from the memory M54a. Then, in Step P324, it is determined whether the count value of the counter for detecting the current position of the left side of the doctor roller is equal to the throw-off position (count value of the counter) of the doctor roller. If the answer is Y, the memory M60a for storing the presence or absence of rotation of the stepping motor for adjusting the left side is overwritten with 0 in Step P325, and the program proceeds to Step P326. If the answer is N in Step P324, the program directly shifts to Step P326.

Then, in the aforementioned Step P326, the count value is loaded from the counter 72a for detecting the current position of the right side of the doctor roller, and stored into the memory M63a. Then, in Step P327, the throw-off position (count value of the counter) of the doctor roller is loaded from the memory M54a.

Then, in Step P328, it is determined whether the count value of the counter 72a for detecting the current position of the right side of the doctor roller is equal to the throw-off position (count value of the counter) of the doctor roller. If the answer is Y, the memory M61a for storing the presence or absence of rotation of the stepping motor for adjusting the right side is overwritten with 0 in Step P329, and the program returns to Step P315. If the answer is N in Step P328, the program directly returns to Step P315.

In accordance with the above-described motion flow, when the doctor roller throw-on and throw-off automatic control switch 52a is brought to the OFF-state, the doctor roller 90 is moved to the throw-off position.

According to the present Embodiment 2, as described above, even when the doctor roller 90 is located at a position where it opposes the notch 13b of the impression cylinder 13 (i.e., the retreat position), the outer peripheral surface of the doctor roller 90 does not leave the inner peripheral surface of the screen printing forme 11c, and only its pressure exerted on this surface (i.e., pressing force) is rendered lower than the pressure during printing. Thus, the screen printing forme 11c is prevented from being pushed into the notch 13b of the impression cylinder 13 by the doctor roller 90 and damaged thereby, and there is no ink leaking out toward the downstream side in the rotating direction of the screen printing forme 11c, so that deterioration of printing quality is prevented.

That is, the following problems are avoided: Because of leaks of ink toward the downstream side in the rotating direction of the screen printing forme 11c, the amount of ink remaining in front of the doctor roller 90 becomes small to decrease the ink density at the start of printing. The ink leaking out toward the downstream side leaks out through the holes of the picture pattern portion under a centrifugal force during high speed rotation, adheres to outside portions of the holes, and sticks to the outside of the picture pattern portion during printing, thereby deteriorating printing quality.

In the present Embodiment 2, the above-mentioned pressing force (in other words, the retreat position of the doctor roller 90) is variably controlled in accordance with the type of the screen printing forme 11c (material, forme thickness, open area rate, mesh size, etc.), the type of ink used in printing (viscosity, yield value, type of pigment, etc.), and the type of the doctor roller 90 (material, surface hardness, etc.). Hence, damage to the screen printing forme 11c and deterioration of printing quality are prevented with even higher accuracy.

In the present Embodiment 2, moreover, the control pressure may be switched using a hydraulic or pneumatic actuator instead of the stepping motor 36Aa for adjusting the left side and the stepping motor 36Bb for adjusting the right side. Furthermore, the motors 36Aa and 36Bb are disposed on the right side and the left side. However, there may be adopted a configuration in which a one-sided motor moves the right and left sides, for example, by connecting the right and left sides by a lever mechanism.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A liquid transfer member pressing force adjusting method of a rotary stencil printing plate liquid coating machine including,
a stencil printing plate cylinder which supports a stencil printing plate and is supported rotatably,
an impression cylinder which is provided to oppose the stencil printing plate cylinder, has a concavity provided in an outer peripheral surface thereof, the concavity accommodating a device for holding a material to be liquid coated, and is supported rotatably, and
a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to the material to be liquid coated, which is held on the impression cylinder, via holes of the stencil printing plate,
wherein when the liquid transfer member opposes the concavity of the impression cylinder, the liquid transfer member is brought into contact with the inner peripheral surface of the stencil printing plate, and a pressing force of the liquid transfer member acting on the inner peripheral surface of the stencil printing plate is rendered lower than a pressing force of the liquid transfer member exerted during the liquid coating.

2. The liquid transfer member pressing force adjusting method of a rotary stencil printing plate liquid coating machine according to claim 1, wherein
adjustment of the pressing force of the liquid transfer member acting on the inner peripheral surface of the stencil printing plate is made by adjusting a position of the liquid transfer member.

3. The liquid transfer member pressing force adjusting method of a rotary stencil printing plate liquid coating machine according to claim 2, wherein
the adjustment of the position of the liquid transfer member is made by a motor.

4. The liquid transfer member pressing force adjusting method of a rotary stencil printing plate liquid coating machine according to claim 1, wherein
the pressing force of the liquid transfer member acting on the inner peripheral surface of the stencil printing plate when the liquid transfer member opposes the concavity of the impression cylinder is obtained from a type of the stencil printing plate.

5. The liquid transfer member pressing force adjusting method of a rotary stencil printing plate liquid coating machine according to claim 1, wherein
the pressing force of the liquid transfer member acting on the inner peripheral surface of the stencil printing plate when the liquid transfer member opposes the concavity of the impression cylinder is obtained from a picture pattern area rate of a picture pattern applied by liquid coating to the material to be liquid coated.

6. The liquid transfer member pressing force adjusting method of a rotary stencil printing plate liquid coating machine according to claim 1, wherein
the pressing force of the liquid transfer member acting on the inner peripheral surface of the stencil printing plate when the liquid transfer member opposes the concavity of the impression cylinder is obtained from a type of the liquid used in the liquid coating.

7. The liquid transfer member pressing force adjusting method of a rotary stencil printing plate liquid coating machine according to claim 1, wherein
the pressing force of the liquid transfer member acting on the inner peripheral surface of the stencil printing plate when the liquid transfer member opposes the concavity of the impression cylinder is obtained from a type of the liquid transfer member.

8. A liquid transfer member pressing force adjusting apparatus of a rotary stencil printing plate liquid coating machine including,
a stencil printing plate cylinder which supports a stencil printing plate and is supported rotatably,
an impression cylinder which is provided to oppose the stencil printing plate cylinder, has a concavity provided in an outer peripheral surface thereof, the concavity accommodating a device for holding a material to be liquid coated, and is supported rotatably, and
a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to the material to be liquid coated, which is held on the impression cylinder, via holes of the stencil printing plate,
the liquid transfer member pressing force adjusting apparatus comprising control means which, when the liquid transfer member opposes the concavity of the impression cylinder, brings the liquid transfer member into contact with the inner peripheral surface of the stencil printing plate, and controls a pressing force of the liquid transfer member acting on the inner peripheral surface of the stencil printing plate to be lower than a pressing force of the liquid transfer member exerted during the liquid coating.

9. The liquid transfer member pressing force adjusting apparatus of a rotary stencil printing plate liquid coating machine according to claim 8, wherein
the control means makes adjustment of the pressing force of the liquid transfer member acting on the inner peripheral surface of the stencil printing plate by adjusting a position of the liquid transfer member.

10. The liquid transfer member pressing force adjusting apparatus of a rotary stencil printing plate liquid coating machine according to claim 9, wherein
the control means makes the adjustment of the position of the liquid transfer member by a motor.

11. The liquid transfer member pressing force adjusting apparatus of a rotary stencil printing plate liquid coating machine according to claim 8, wherein
the control means obtains the pressing force of the liquid transfer member, which acts on the inner peripheral surface of the stencil printing plate when the liquid transfer member opposes the concavity of the impression cylinder, from a type of the stencil printing plate.

12. The liquid transfer member pressing force adjusting apparatus of a rotary stencil printing plate liquid coating machine according to claim 8, wherein
the control means obtains the pressing force of the liquid transfer member, which acts on the inner peripheral surface of the stencil printing plate when the liquid transfer member opposes the concavity of the impression cylinder, from a picture pattern area rate of a picture pattern applied by liquid coating to the material to be liquid coated.

13. The liquid transfer member pressing force adjusting apparatus of a rotary stencil printing plate liquid coating machine according to claim 8, wherein
the control means obtains the pressing force of the liquid transfer member, which acts on the inner peripheral surface of the stencil printing plate when the liquid transfer member opposes the concavity of the impression cylinder, from a type of the liquid used in the liquid coating.

14. The liquid transfer member pressing force adjusting apparatus of a rotary stencil printing plate liquid coating machine according to claim 8, wherein
the control means obtains the pressing force of the liquid transfer member, which acts on the inner peripheral surface of the stencil printing plate when the liquid transfer member opposes the concavity of the impression cylinder, from a type of the liquid transfer member.

15. A liquid transfer member pressing force adjusting method of a rotary stencil printing plate liquid coating machine including,
a stencil printing plate cylinder which supports a stencil printing plate and is supported rotatably,
an impression cylinder which is provided to oppose the stencil printing plate cylinder, has a concavity provided in an outer peripheral surface thereof, the concavity accommodating a device for holding a material to be liquid coated, and is supported rotatably, and
a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to the material to be liquid coated, which is held on the impression cylinder, via holes of the stencil printing plate,
the method comprising:
when the liquid transfer member opposes the concavity of the impression cylinder,
bringing the liquid transfer member into contact with the inner peripheral surface of the stencil printing plate; and
rendering a pressing force of the liquid transfer member acting on the inner peripheral surface of the stencil printing plate to be lower than a pressing force of the liquid transfer member exerted during the liquid coating.

16. A rotary stencil printing plate liquid coating machine, comprising:
a stencil printing plate cylinder which supports a stencil printing plate and is supported rotatably,
an impression cylinder which is provided to oppose the stencil printing plate cylinder, has a concavity provided in an outer peripheral surface thereof, the concavity accommodating a device for holding a material to be liquid coated, and is supported rotatably,
a liquid transfer member which is located within the stencil printing plate cylinder and, during liquid coating, contacts an inner peripheral surface of the stencil printing plate, while being pressed against the inner peripheral surface of the stencil printing plate, to transfer a liquid stored within the stencil printing plate cylinder to the material to be liquid coated, which is held on the impression cylinder, via holes of the stencil printing plate; and a liquid transfer member pressing force adjusting apparatus including,
control means which, when the liquid transfer member opposes the concavity of the impression cylinder, brings the liquid transfer member into contact with the inner peripheral surface of the stencil printing plate, and controls a pressing force of the liquid transfer member acting on the inner peripheral surface of the stencil printing plate to be lower than a pressing force of the liquid transfer member exerted during the liquid coating.
